(19) United States
(12) Patent Application Publication
(10) Pub. No.: US 2025/0142292 A1
(43) Pub. Date: May 1, 2025

(54) TRANSMISSION OF SL-PRS ON CONDITION THAT ASSOCIATED PARAMETERS ARE WITHIN A PREDETERMINED RANGE

(71) Applicant: InterDigital Patent Holdings, Inc., Wilmington, DE (US)

(72) Inventors: Tuong Hoang, Montreal (CA); Fumihiro Hasegawa, Westmount (CA); Tao Deng, New York, NY (US); Jaya Rao, Montreal (CA); Moon IL Lee, Melville, NY (US); Paul Marinier, Brossard (CA); Kunjan Shah, London (GB); Aata El Hamss, Laval (CA)

(73) Assignee: InterDigital Patent Holdings, Inc., Wilmington, DE (US)

(21) Appl. No.: 18/836,437

(22) PCT Filed: Feb. 9, 2023
(86) PCT No.: PCT/US2023/062263

§ 371 Date: Aug. 7, 2024

Related U.S. Application Data
(60) Provisional application No. 63/308,307, filed on Feb. 9, 2022.
(60) Provisional application No. 63/334,815, filed on Apr. 26, 2022.
(60) Provisional application No. 63/395,945, filed on Aug. 8, 2022.
(60) Provisional application No. 63/410,849, filed on Sep. 28, 2022.

(51) Int. Cl. H04W 4/029; H04L 5/00; H04W 72/25; H04W 76/40

(52) U.S. Cl. CPC H04W 4/029; H04L 5/0005; H04W 72/25; H04W 76/40

(57) ABSTRACT

A wireless transmit/receive unit, WTRU, receives a positioning request message from another WTRU (1402). The positioning request message indicates a request associated with one or more of a sidelink positioning reference signals, SL-PRS, transmission or a SL-PRS reception and indicates a range of one or more parameters associated with the SL-PRS transmission or reception; these parameters comprise one or more of SL-RSRP, angle of departure AoD, angle of arrival AoA, and a line of sight LOS/NLOS metric. The WTRU measures the one or more parameters indicated in the positioning request message (1404) and performs the SL-PRS transmission (1410) or the SL-PRS reception (1410) on the condition that the measured parameters are within the range indicated in the positioning request message (1408).

### CROSS-REFERENCE TO RELATED APPLICATIONS

This application claims the benefit of U.S. Provisional Patent Application No. 63/308,307, filed on Feb. 9, 2022, U.S. Provisional Patent Application No. 63/334,815, filed on Apr. 26, 2022, U.S. Provisional Patent Application No. 63/395,945, filed on Aug. 8, 2022, and U.S. Provisional Patent Application No. 63/410,849, filed on Sep. 28, 2022, the entire contents of which are incorporated herein by reference.

### BACKGROUND

In vehicular communications (V2X), the resource(s) for sidelink transmission/reception may be structured as resource pools. A resource pool may comprise a set of continuous frequency resources repeating in time following a bitmap pattern. A wireless transmit/receive unit (WTRU) may be configured with one resource pool or multiple resource pools. For in-coverage WTRUs, the resource pool can be configured via system information block (SIB) and/or radio resource control (RRC). For out of coverage WTRUs, the resource pool can be configured (e.g., preconfigured).

Sidelink transmission may span within one slot and may include a physical sidelink shared channel (PSSCH) and/or a physical sidelink control channel (PSCCH). PSSCH and PSCCH are frequency-division multiplexed (FDM) and time-division multiplexed (TDM). Sidelink control information (SCI) is typically divided into two parts: the first stage SCI and the second stage SCI. The first stage SCIs may indicate the resource used for sidelink transmission, the quality of service (QOS) of the transmission (e.g., priority), demodulation reference signal (DMRS), phase tracking reference signal (PTRS) used for the sidelink transmission, and the second SCI format. The second stage SCI may indicate the remaining control information. SCI can be used to reserve the resource for future transmission within a resource pool.

The sidelink resource can be scheduled by the network or selected by the WTRU. If the sidelink resource is selected by the WTRU, the WTRU may perform sensing by decoding SCI from other WTRUs before selecting the sidelink resources to avoid selecting the resources reserved by other WTRUs.

### SUMMARY

Methods and apparatuses are provided for sidelink positioning (e.g., autonomous sidelink positioning) discovery. Methods and apparatuses are provided for dynamic sidelink positioning (e.g., autonomous sidelink positioning). Methods and apparatuses are provided for semi-static sidelink positioning (e.g., autonomous sidelink positioning). Methods and apparatuses are provided for sidelink positioning (e.g., autonomous sidelink positioning) reference signal (SL-PRS) measurement. Methods and apparatuses are provided for WTRU determination of receiver of the sidelink measurement report. Methods and apparatuses are provided for round trip time (RTT) based (e.g., one-sided or two-sided) positioning for out-of-coverage.

A wireless transmit/receive unit (WTRU) may receive a positioning request message from another WTRU. The positioning request message may indicate one or more parameters and one or more ranges associated with the one or more parameters. The one or more parameters may comprise one or more of distance, sidelink reference signal received power, angle of departure, line-of-sight/non-line-of-sight, and/or a set of zone identifiers. The positioning request message from the other WTRU may comprise a resource allocation request that indicates that the WTRU should perform the resource allocation. The positioning request message may indicate a type of request, the type of request comprising one or more of perform sidelink reception, perform sidelink transmission, perform sidelink transmission and reception, or perform position measurement reporting. The positioning request message may indicate a priority, a latency, and/or a periodicity associated with one or more of the sidelink transmission, the sidelink reception, and/or sidelink measurement reporting. The WTRU may calculate a value for a first parameter of the one or more parameters indicated in the positioning request message. The WTRU may determine that the value is within a first range of the one or more ranges associated with the first parameter. The WTRU may perform resource allocation for one or more of sidelink transmission/reception or measurement reporting using the one or more parameters indicated in the positioning request message. For example, the WTRU may perform the resource allocation is performed in response to the positioning request message comprising the resource allocation request.

When the positioning request message from the other WTRU requests the WTRU to perform sidelink reception, the WTRU may perform sidelink reception using the resources indicated in the position request message. When the positioning request message from the other WTRU requests the WTRU to perform sidelink transmission, the WTRU may perform sidelink transmission using the allocated resources. The positioning request message may indicate a type of request, the type of request comprising one or more of perform sidelink reception, perform sidelink transmission, perform sidelink transmission and reception, and/or perform position measurement reporting. The WTRU may perform sidelink reception and prioritization using the priority indicated in the positioning request message. The WTRU may perform sidelink reception using a measurement gap indicated in the positioning request message.

A WTRU may determine the cast type associated with sidelink positioning. A WTRU may be configured (e.g., preconfigured) with a set of SL-PRS configurations. A WTRU may indicate which SL-PRS configuration to use. A WTRU may determine whether to feedback the sidelink positioning request message. A WTRU may determine whether to feedback a SL-PRS transmission. A WTRU may determine the priority associated with the transmission of the feedback. A WTRU may determine the priority associated with the reception of a feedback message.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 depicts an example process for a WTRU to determine one or more sidelink positioning reference signal (SL-PRS) parameters.

FIG. 3 depicts example parameters included in a positioning request message.

FIG. 4 depicts an example process for a WTRU to reserve periodic SL-PRS resources and determine whether to perform SL-PRS transmission.

FIG. 5 depicts an example process for a WTRU to adjust a range requirement for acknowledgment (ACK) feedback.

FIG. 6 depicts an example SL-PRS for a group of WTRUs.

FIG. 7 is a chart illustrating an example measurement gap (MG) pattern and parameters.

FIG. 8 illustrates an example associated with sidelink positioning using HARQ-enables transmissions.

FIG. 9 illustrates an example associated with sidelink positioning using groupcast Option 2 HARQ-enabled transmission.

FIG. 10 illustrates an example signal flow for an out-of-coverage round trip time (RTT) method.

FIG. 11 illustrates an example RTT positioning method for out-of-coverage where the target WTRU performs Mode 2 resource allocation.

FIG. 12 illustrates an example one-sided positioning method for out-of-coverage.

FIG. 13 illustrates an example two-sided RTT positioning method for out-of-coverage.

FIG. 14 depicts a flowchart that describes WTRU behavior upon receiving a SL-PRS request.

### DETAILED DESCRIPTION

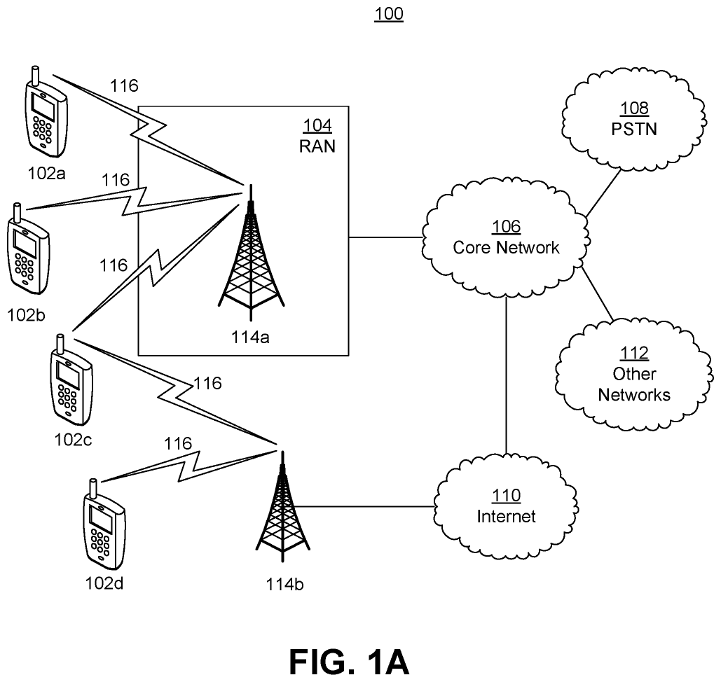

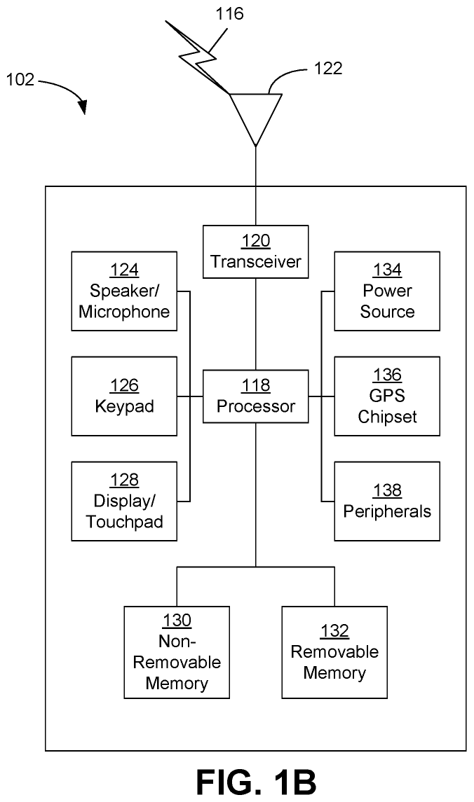

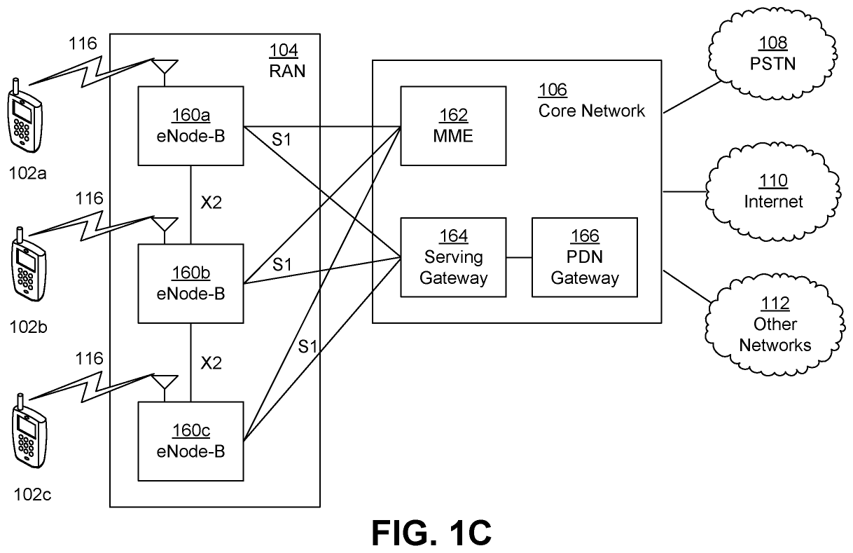

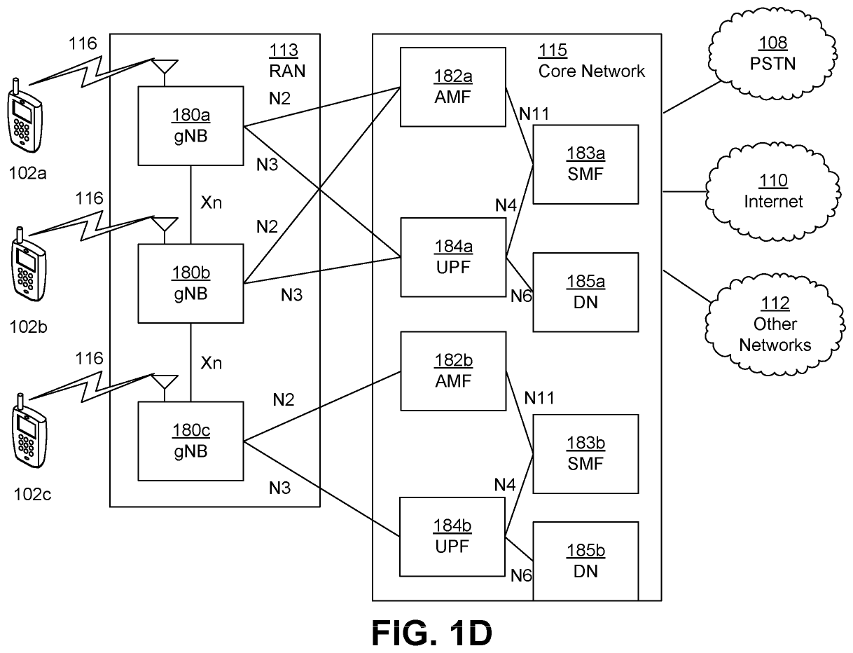

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with one or more of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, e.g., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (e.g., Wireless Fidelity (WiFi), IEEE 802.16 (e.g., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHZ, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHZ. In Japan, the available frequency bands are from 916.5 MHz to 927.5 MHz. The total bandwidth available for 802.11ah is 6 MHz to 26 MHZ depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include one or more of AMF 182a, 182b, one or more of UPF 184a, 184b, one or more Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Vehicular communications (V2X) may support sidelink communication between different vehicles.

In V2X, the resource(s) for sidelink transmission/reception may be structured as resource pools. A resource pool may comprise a set of continuous frequency resources repeating in time following a bitmap pattern.

A WTRU may be configured for one resource pool and/or multiple resource pools. For in-coverage WTRUs, the resource pool can be configured via system information block (SIB) and/or radio resource control (RRC). For out of coverage WTRUs, the resource pool can be configured (e.g., preconfigured).

Each sidelink transmission may span within one slot and may include a physical sidelink shared channel (PSSCH) and a physical sidelink control channel (PSCCH). PSSCH and PSCCH are frequency-division multiplexing (FDM) and time-division multiplexing (TDM). Sidelink control information (SCI) may be divided into two parts: the first stage SCI and the second stage SCI. The first stage SCI may indicate the resource used for sidelink transmission, the quality of service (QOS) of the transmission (e.g., priority), demodulation reference signal (DMRS), phase tracking reference signal (PTRS) used for the sidelink transmission, and the second SCI format. The second stage SCI may indicate the remaining control information. SCI can be used to reserve the resource for future transmission within a resource pool.

From the sidelink scheduling perspective, the sidelink resource can be scheduled by the network (e.g., Mode 1) and autonomously selected by the WTRU (e.g., Mode 2). If the WTRU performs Mode 2, the WTRU may perform sensing by decoding SCI from other WTRUs before selecting the sidelink resources to avoid selecting the resources reserved by other WTRUs.

Sidelink channel state information reference signal (SL-CSI-RS) may be supported for unicast to support the transmit (Tx) WTRU in determination of Tx parameters (e.g., power and rank). The Tx WTRU may indicate the presence of SL-CSI-RS by using SCI. A CSI-RS transmission may trigger CSI reporting. CSI reporting latency may be configured via PC5-RRC. Each reporting may be associated with one SL-CSI-RS transmission.

The present invention further considers new radio (NR) Uu positioning specified downlink (DL)-based, uplink (UL)-based, and/or DL and UL-based positioning methods.

In examples, in the DL-based positioning methods, downlink positioning reference signals (DL-PRSs) are sent from multiple transmission/reception points (TRPs) to the WTRU. The WTRU may observe and measure downlink signals from the TRPs. For the WTRU-B method, the WTRU may calculate its position and for WTRU-A method, the WTRU may return the downlink measurement to the network. For the angle-based method, the WTRU may report the angle of arrival (AoA) and/or reference signal received power (RSRP) of the downlink signals from the TRPs. For the timing-based method, the WTRU may report reference signal time difference (RSTD). The above methods may require the transmission timing synchronization among the TRPs. The positioning calculation errors mostly come from synchronization error and/or multipath.

In examples, in the UL-based positioning methods, the WTRU sends uplink positioning reference signals (UL-PRSs) configured by the RRC to the TRP for positioning. The network may then calculate the position of the WTRU based on the coordination of multiple (e.g., all) the TRPs receiving UL-PRS from the WTRU.

In the UL and DL-based methods, the WTRU may measure Rx-Tx time difference between the received DL-PRS and the transmitted UL-PRS. The Rx-Tx time difference and RSRP may be reported to the network. The network may then coordinate the TRPs to calculate the position of the WTRU.

A timing/angle positioning method may refer to a positioning method that uses reference signals such as sidelink positioning reference signal (SL-PRS). The WTRU may receive multiple reference signals from WTRU(s) and may measure RSTD, RSRP, and/or AoA. Examples of angle/timing positioning methods may include sidelink angle of departure (SL-AoD) or sidelink time difference of arrival (SL-TDOA) positioning. In examples, the WTRU may transmit SL-PRS to WTRU(s) and a receiver may perform measurements (e.g., RSTD, AoA, RSRP) for determination of the locations of the WTRU which transmitted the SL-PRS.

A round trip time (RTT) positioning method may refer to a positioning method that requires two WTRUs to transmit SL-PRS to each other. In examples, an anchor WTRU may transmit an SL-PRS to the target WTRU. Once the target WTRU receives the SL-PRS from the anchor WTRU, the target WTRU may transmit the SL-PRS to the anchor WTRU. The target WTRU may measure a WTRU Tx-Rx time difference. The time difference may be calculated as the difference between transmission time of SL-PRS from the target WTRU and reception time of SL-PRS transmitted from the anchor WTRU. The target WTRU may report the WTRU Tx-Rx time difference to the anchor WTRU.

Absolute position of the WTRU may be expressed in terms of Geographical Coordinate System (GCS) or Local Coordinate System (LCS). Relative position of the target WTRU may be expressed in terms of distance and/or angle from another WTRU(s) (e.g., anchor WTRU(s) and/or reference point with known location.

For sidelink positioning (e.g., autonomous sidelink positioning), we assume that assistant WTRUs (e.g., A-WTRUs) can also be used to help determining the position of a target WTRU (e.g., T-WTRU) subject to determine its position. The terms assistant WTRU (e.g., A-WTRU) and anchor WTRU may be used interchangeably herein. The terms positioning WTRU (e.g., P-WTRU) and target WTRU (e.g., T-WTRU) may be used interchangeably herein. The relative position between the A-WTRU and the T-WTRU can be calculated based on the SL-PRS measurement. Then the absolute position of the target WTRU can be derived based on the relative position with multiple A-WTRUs and the absolute position of the A-WTRUs.

In NR Uu positioning, the location management function (LMF) may play the role as a central entity to coordinate multiple TRPs to schedule PRS resources, measurement reporting, and/or implement algorithms to derive the position of T-WTRUs. As LMF may be placed in the core network, semi-static PRS transmission/reception and measurement reporting is desirable. For out of coverage sidelink positioning (e.g., autonomous sidelink positioning), it may not be desirable to have a central entity as LMF may control the positioning procedure. Moreover, in examples NR V2X scenarios, a vehicle may move with high speed. A vehicle moving at high speed may result in a dynamic sidelink environment. Therefore, in these examples, a dynamic approach to SL-PRS transmission, reception, and/or measurement reporting may be more desirable.

For out of coverage sidelink positioning (e.g., autonomous sidelink positioning), it may be necessary to address the problem of how one WTRU (e.g., T-WTRU) can initialize the sidelink positioning (e.g., autonomous sidelink positioning) procedure, dynamically control the set of A-WTRUs to support locating its position, dynamically select resources for SL-PRS transmission/reception, and/or perform positioning measurement reporting.

Examples described herein for positioning may be used for ranging without any limitation. Specifically, one or more of the positioning solutions described herein may be applicable to ranging problems. In examples, positioning may be referred to as a method and/or scheme to estimate the geographical location of a WTRU. In examples, ranging may be referred to as a method and/or scheme to estimate distance between WTRUs. The terms “positioning of a WTRU” and/or “location information of a WTRU” may be interchangeably used with “a distance between WTRUs” when an example refers to ranging. Positioning of the WTRU may include absolute position (e.g., the coordinates, the zone ID) or the relative position, which may include the range, distance, propagation time, and/or RTT to another node (e.g., another WTRU, road side unit (RSU), positioning reference unit (PRU), gNB).

A WTRU may use one or any of the following reference signals as an SL-PRS: DMRS of PSSCH, DMRS of PSCCH, sidelink synchronization signals (SLSS) (e.g., sidelink primary synchronization signal (S-PSS) and/or sidelink secondary synchronization signal (S-SSS)), PTRS, physical sidelink feedback channel (PSFCH), SL-CSI-RS, and/or another RS designed for positioning purposes.

A WTRU may determine a SL-PRS configuration. Additionally or alternatively, the WTRU may receive the SL-PRS configuration from another node (e.g., another WTRU and/or gNB). The SL-PRS configuration may include one or more of a resource pool for SL-PRS transmission, reception, and/or sidelink measurement reporting, an SL-PRS resource ID, an SL-PRS sequence ID, and/or other IDs used to generate SL-PRS sequence, a time-frequency of SL-PRS resource, an SL-PRS resource element offset, an SL-PRS resource slot offset, an SL-PRS symbol offset, an SL-PRS QCL information, an SL-PRS resource set ID, a list of SL-PRS resources in the resource set, a number of SL-PRS symbols, a muting pattern for SL-PRS, (muting parameters may include repetition factor, muting options), an SL-PRS resource power, a periodicity of SL-PRS transmission, a spatial direction information of SL-PRS transmission (e.g., beam information, angles of transmission), a spatial direction information of SL-RS reception (e.g., beam ID used to receive SL-RS, angle of arrival), a frequency layer ID, a WTRU ID, and/or an SL-PRS ID.

A WTRU may be configured to perform a sidelink positioning discovery. The sidelink positioning discover may include determining a QoS of a positioning service, sending a positioning initialization message, and/or triggering a positioning initialization message.

A WTRU may determine a QoS associated with a positioning service. For example, a WTRU may be configured to determine one or more QoS parameters associated with a positioning service. In examples, the WTRU may initialize a positioning service, which may be used to determine the positioning of the WTRU itself or other WTRUs. The position may include the absolute position of the WTRU and/or relative position of the WTRU.

The initiated positioning service may have the associated QoS of the positioning service and may include one or more of the following parameters: the priority of the positioning service, the positioning accuracy requirement, the range requirement of the positioning service, the latency requirement of the positioning service, and/or the reliability requirement of the positioning service.

In examples, the positioning accuracy requirement may be associated with the maximum positioning error. The positioning range requirement may be the maximum range in which two WTRUs may support each other in determining their relative position. For example, an A-WTRU within the range requirement may need to support determining the position of the T-WTRU by performing SL-PRS transmission, reception, and/or positioning measurement reporting if the request is from the WTRU within the required range. The latency requirement of the positioning service may be associated with the latency and/or the periodicity of the positioning measurement report, location update, positioning reference signal transmission/reception, and/or positioning request message. The reliability requirement of the positioning service may be associated with the reliability of the positioning request message, the positioning measurement reporting message, and/or the SL-PRS transmission, which may be used to determine the number of (re) transmissions for each message (e.g., positioning measurement reporting, SL-PRS transmission and/or positioning request message).

In examples, a WTRU (e.g., the T-WTRU or the A-WTRU) may perform a positioning initialization transmission. The positioning initialization transmission may be a message and/or a sequence. For example, the WTRU (e.g., the T-WTRU or the A-WTRU) may send a positioning initialization message.

A positioning initialization transmission may implicitly and/or explicitly include one or any combination of the following information and/or parameters: the type of positioning initialization transmission, the rough location of the WTRU (e.g., zone ID) or the exact location of the WTRU (e.g. the coordinate), the supported positioning method, the supported positioning output (e.g., whether the WTRU support or request absolute and/or relative positioning), the supported positioning measurement parameters (e.g., RSTD, AoA, AoD, time of arrival (ToA), Tx-Rx, phase of arrival (PoA), phase of departure (POD), difference phase of arrival (DPoA), difference phase of departure (DPOD), line of sight/non-line of sight (LOS/NLOS)), cast type associated, positioning calculation capability, and/or sensing capability.

The type of positioning initialization transmission may indicate whether the WTRU transmits the message and/or signal to ask for positioning support (e.g., ask for the support of A-WTRU) or whether the WTRU transmit the message to offer positioning support (e.g., offer to support the T-WTRU). For example, a T-WTRU may send the positioning initialization message to request positioning support and an A-WTRU may send the positioning initialization message to offer positioning support.

In examples, the supported positioning methods may be associated with the WTRU. The WTRU may indicate whether the WTRU supports transmission of SL-PRS, reception of SL-PRS, and/or both transmission and reception of SL-PRS.

In examples, the WTRU may indicate which positioning measurement (e.g., DPoA, PoA, AoA, AoD, RSTD, ToA, Tx-Rx timing, LOS/NLOS, etc.) the WTRU is supporting. For example, the WTRU may indicate whether the WTRU supports SL-TDOA, RTT (e.g., single sided RTT, double sided RTT, AoA, and/or AoD methods).

In examples, cast type may be information and/or a parameter for positioning initialization transmission. The cast type may be associated with sidelink positioning request, feedback, SL-PRS transmission/reception, and/or sidelink positioning measurement reporting. For example, the WTRU may indicate in the message whether the positioning request, feedback, SL-PRS transmission/reception, and/or sidelink positioning measurement reporting uses unicast, groupcast and/or broadcast for each transmission.

In examples, positioning calculation capability may include information and/or a parameter associated with positioning initialization transmission. For example, a WTRU (e.g., T-WTRU) may indicate in the message whether the WTRU has capability of positioning calculation. For example, the WTRU may indicate in the message whether the WTRU needs another WTRU (e.g., an A-WTRU) to receive a measurement report and determine position of the WTRU. A WTRU may also indicate whether the WTRU needs any other WTRU.

In examples, sensing capabilities may include information and/or a parameter for positioning initialization transmission. The WTRU (e.g., T-WTRU and/or A-WTRU), for example, may indicate the sensing capability(ies) of the WTRU in the message. Specifically, the WTRU may indicate whether the WTRU is able to perform partial sensing, full sensing, and/or no sensing for SL-PRS transmission. Moreover, the WTRU may indicate whether the WTRU can support Inter WTRU Coordination (IUC). Specifically, the WTRU may indicate whether the WTRU can send the sensing information (e.g., conflict indication or the set of preferred/non-preferred resources) to another WTRU during the positioning procedure.

A WTRU (e.g., a T-WTRU or an A-WTRU) may trigger positioning initialization transmission based on one or any combination of the following: a coverage status of the WTRU, Uu RSRP, SL-RSRP, location of the WTRU, the number of supporting WTRUs, CR of the WTRU, channel busy ration (CBR) of a resource pool, and/or reception of an implicit and/or explicit request from another node (e.g., another WTRU, RSU, or gNB).

In examples, a WTRU may perform SL-PRS transmission(s). The WTRU may determine one or more SL-PRS transmission(s) parameters. The SL-PRS transmission(s) parameters may include one or more of the parameters of an SL-PRS resource, a type of SL-PRS multiplexing, a number of SL-PRS resource repetitions/retransmissions in one period, a type of SL-PRS transmission, a periodicity of a SL-PRS process, a number of periods for one SL-PRS process, sidelink positioning session, and/or the window, the intended receiver(s) of the SL-PRS transmission(s), a hybrid automatic repeat request (HARQ) type of the SL-PRS transmission and/or a cast type of the SL-PRS transmission.

The parameters of an SL-PRS resource may include a QoS associated with the SL-PRS resource, a transmission power, a number of subchannels used for each SL-PRS resource, a number of symbols and/or slots used for each SL-PRS transmission resource, a reference resource pattern (e.g., comb size and/or comb pattern), a sequence ID, a cyclic shift, and/or a time and/or frequency resource(s) of SL-PRS transmission(s).

The WTRU may be configured (e.g., preconfigured) for multiple types of SL-PRS multiplexing. In examples, SL-PRS may not be multiplexed with other sidelink transmission(s). In another type of SL-PRS multiplexing, SL-PRS may be multiplexed with sidelink control information (e.g., SCI, medium access control-control element (MAC CE), and/or PC5-RRC). In another type of SL-PRS multiplexing, SL-PRS may be multiplexed with both sidelink control and sidelink data.

The WTRU may be configured (e.g., preconfigured) for two types of SL-PRS transmission. In the first type, the SL-PRS is transmitted dynamically. In the second type, the SL-PRS is transmitted periodically. The WTRU may determine the number of periods the WTRU may use for SL-PRS transmissions. The WTRU may indicate the L2 ID(s) of a one or more receiver(s). For example, the WTRU may include the L2 ID of a group of WTRUs.

A WTRU (e.g., T-WTRU) may indicate in the SCI (e.g., second SCI) whether the HARQ feedback associated with SL-PRS transmission is enabled or disabled. When HARQ is disabled, the receiving WTRU (e.g., A-WTRU) may not transmit HARQ feedback. When HARQ is enabled, the receiving WTRU may transmit HARQ feedback. Specifically, the WTRU may transmit acknowledgment (ACK) if the WTRU measures a SL-PRS having measurement accuracy being greater than a threshold (e.g., the value of measurement value is within the indicated range).

Additionally or alternatively, the WTRU may transmit ACK if the WTRU performs a SL-PRS reception and/or measurement. For example, the WTRU may transmit ACK if the WTRU measures a certain number of SL-PRS resources. Otherwise, the WTRU may transmit a negative acknowledgement (NACK) if SL-PRS reception is deprioritized. The WTRU may feedback NACK if the number of measured SL-PRS resources is less than a threshold, and/or the accuracy of SL-PRS measurement is less than a threshold. The threshold (e.g., the number of measure SL-PRS resources threshold and/or the SL-PRS measurement accuracy threshold) may be configured (e.g., preconfigured), which may be based on the QoS of the positioning service, the parameters to measure, and/or the latency of the positioning service.

In examples, feedback for SL-PRS transmission may be information and/or a parameter for positioning initialization transmission. In examples, the WTRU (e.g., T-WTRU) may indicate and/or request the feedback for SL-PRS transmission after a certain number of SL-PRS resources (e.g., N SL-PRS resource, in which N can be one or more). The feedback indication and/or feedback request may be sent in a transmission associated with the SL-PRS resources (e.g., in the SCI associated with the SL-PRS resource). The WTRU may expect the Rx WTRU (e.g., anchor WTRU) to provide feedback on the information regarding SL-PRS reception. Such information may implicitly and/or explicitly include how many SL-PRS resources the Rx WTRU has received, whether the WTRU needs more SL-PRS resources for measurement reporting, how many SL-PRS resources the WTRU has not measured, whether a certain SL-PRS resources is received and/or deprioritized, and/or the measurement quality associated with each SL-PRS resources (e.g., whether the SL-PRS is LOS/NLOS, the RSRP associated with the resource, and/or whether the RSRP is greater/lower than a threshold).

The Tx WTRU (e.g., the target WTRU) may wait for feedback from N SL-PRS resources before performing resource allocation and/or sending a SL-PRS transmission of the future SL-PRS. The Tx WTRU may stop SL-PRS transmission if the Tx WTRU does not receive feedback from the Rx WTRU. Additionally or alternatively, the WTRU may retransmit a feedback request, for example, if the Tx WTRU does not receive feedback from the Rx WTRU.

In examples, the WTRU (e.g., T-WTRU) may indicate whether the WTRU needs to receive feedback per SL-PRS transmission. Such indication may be sent in the transmission associated with the SL-PRS resources (e.g., in the SCI associated with the SL-PRS resource). If the feedback is enabled, for example, the Tx WTRU may expect feedback from the Rx WTRU. The Tx WTRU may perform resource selection and/or transmission of a future SL-PRS, for example, after receiving feedback from the Rx WTRU. The feedback may be related to the reception of the SL-PRS. For example, the feedback may implicitly and/or explicitly include whether the WTRU needs more SL-PRS resources for measurement reporting, whether the SL-PRS resources are received and/or deprioritized, and/or the measurement quality associated with the SL-PRS resource (e.g., whether the SL-PRS is LOS/NLOS, the RSRP associated with the resource, and/or whether the RSRP is greater/lower than a threshold).

The WTRU may indicate the cast type of a SL-PRS transmission. Specifically, the WTRU may indicate whether the SL-PRS transmission is unicast, groupcast, and/or broadcast. The cast type may be indicated in the SCI (e.g., second SCI).

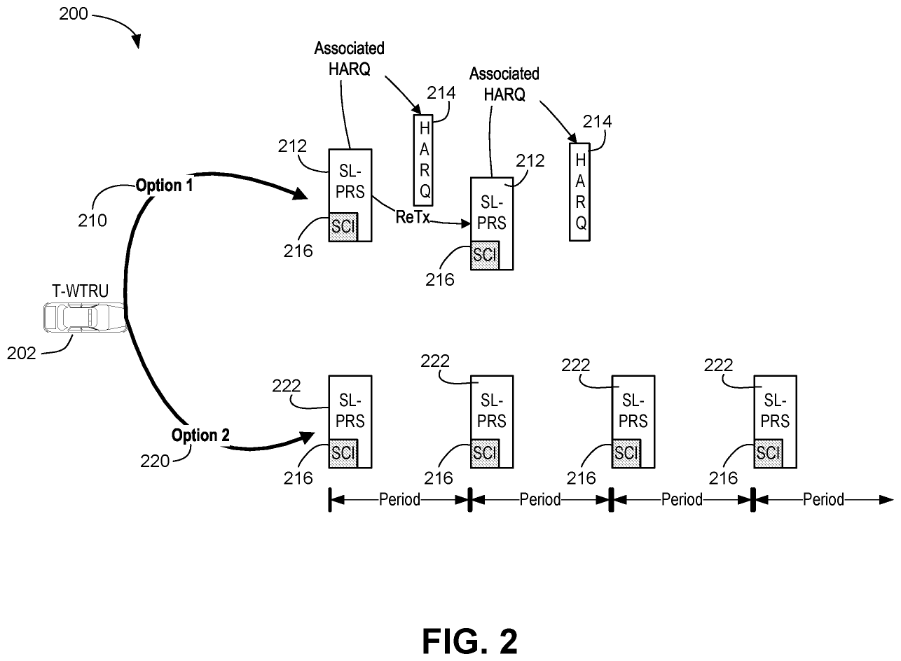

FIG. 2 depicts an example process 200 for a WTRU 202 (e.g., a target WTRU) to determine one or more SL-PRS parameters. For example, as shown in FIG. 2, the target WTRU 202 may determine one or more SL-PRS transmission(s) parameters. The target WTRU 202 may determine the SL-PRS transmission(s) parameters as shown in Option 1 at 210 or Option 2 at 220, respectively. In Option 1 at 210, the target WTRU 202 may perform aperiodic SL-PRS 212 with HARQ 214 enabled. For example, the target WTRU may send a SL-PRS transmission 212 aperiodically with HARQ 214 enabled. In Option 2 at 220, the target WTRU 202 may perform periodic SL-PRS 222 with HARQ disabled. For example, the target WTRU may send a SL-PRS transmission 222 periodically with HARQ disabled. The SL-PRS transmission 222 may include SCI 216.

In examples, the WTRU may indicate one or more of the SL-PRS transmission(s) parameters, for example, in the associated message. One or more of the SL-PRS transmission(s) may be indicated in SCI, a MAC CE, PC5-RRC, and/or a non-access stratum (NAS) message (e.g., long term evolution (LTE) positioning protocol (LPP) message). One or more of the SCI, MAC CE, PC5-RRC and/or NAS used to indicate one or more of the SL-PRS transmission(s) parameters may be transmitted in the same and/or different messages.

In examples, the WTRU may use SCI (e.g., such as the SCI 216) to indicate one or more SL-PRS transmission(s) parameters. The WTRU may use SCI to indicate the availability of SL-PRS. For example, the WTRU may use one bit field to indicate whether the SL-PRS is available or not available in the associated transmission. The WTRU also may use one codepoint of another bitfield (e.g., SL-PRS pattern bitfield) to indicate the availability of SL-PRS in the associated transmission. The WTRU may use SCI to indicate the parameters of one SL-PRS resource. The parameters may include one or more of the QoS associated with the SL-PRS resource, e.g., priority, latency, and/or accuracy requirement of the positioning service, the transmission power, and/or the number of symbols, subchannels, reference resource pattern, sequence ID, cyclic shift, and/or time/frequency resource(s).

The WTRU may use SCI (e.g., such as the SCI 216) to indicate the priority of the positioning service, which may be indicated in the first SCI. For example, one SCI may include the first SCI and the second SCI. The first SCI may be transmitted in a PSCCH transmission and the second SCI may be transmitted in a PSCCH transmission. The priority of the positioning service may be used to indicate the priority of SL-PRS transmission and/or reception. The WTRU may use SCI (e.g., such as the SCI 216) to indicate the accuracy requirement of the positioning service. For example, a positioning service accuracy requirement may be indicated in the first SCI.

In examples, the WTRU may indicate the transmission power of SL-PRS in the first SCI. In other examples, the WTRU may indicate the transmission power of SL-PRS in the second SCI. Additionally or alternatively, the WTRU may implicitly indicate the transmission power of SL-PRS based on another parameters. For example, the WTRU may be configured (e.g., preconfigured) for maximum and/or minimum transmission power based on the range requirement of the positioning service. The WTRU may then implicitly indicate the transmission power by the indicated range requirement. In examples, the WTRU may be configured (e.g., preconfigured) for multiple SL-PRS patterns. The WTRU may then indicate which pattern is used in the SCI. In other examples, the WTRU may indicate the time/frequency resource(s) used for SL-PRS transmission(s).

The WTRU may use SCI (e.g., such as the SCI 216) to indicate a number of SL-PRS resource repetitions and/or retransmissions in the period, a type of SL-PRS transmission, a periodicity of a SL-PRS process, a number of periods for one SL-PRS process, sidelink positioning session, window, and/or an intended receiver(s) of the SL-PRS transmission(s). The WTRU may implicitly indicate the type of SL-PRS transmission in the SCI. Specifically, the WTRU may reserve and/or indicate the periodical SL-PRS resources to indicate the periodic SL-PRS transmission; otherwise, the WTRU may perform aperiodic SL-PRS transmission.

The WTRU may implicitly indicate the type of SL-PRS transmission in the SCI. Specifically, the WTRU may reserve and/or indicate the periodical SL-PRS resources to indicate the periodic SL-PRS transmission; otherwise, the WTRU may perform aperiodic SL-PRS transmission.

The WTRU may indicate in the second SCI (e.g., the SCI in a second SL-PRS transmission) the number of periods used for SL-PRS transmission. Upon the expiry of the number of indicated periods, the WTRU may stop SL-PRS transmission or select another SL-PRS process. This approach may help reduce persistent collision among different SL-PRS processes. In examples, the WTRU may use SCI (e.g., such as the SCI 216) to indicate the intended set of receivers of the SL-PRS. Specifically, the WTRU may indicate the ID information (e.g., L2 ID, a part of L2 ID, and/or member ID, etc.) of the intended receiver(s).

In examples, the WTRU may use MAC CE to indicate one or more SL-PRS transmission(s) parameters, e.g., an availability of SL-PRS, a transmit power of SL-PRS, an intended receiver(s) of the SL-PRS transmission(s), and/or a reference resource pattern (e.g., comb size and/or comb pattern). In examples, the WTRU may use MAC CE to indicate the intended set of receivers of the SL-PRS. Specifically, the WTRU may indicate the ID information (e.g., L2 ID, a part of L2 ID, and/or member ID, etc.) of the intended receiver(s). In examples, the WTRU may use MAC CE to indicate the resource pattern used for SL-PRS transmission.

In examples, the WTRU may use PC5-RRC to indicate the configuration for SL-PRS transmissions, which may implicitly indicate the range or the value of one or more SL-PRS transmission(s) parameter(s). For example, the WTRU may use PC5-RRC to indicate the priority, latency, and/or the accuracy of the positioning service.

In examples, the WTRU may use a NAS message (e.g., LPP message) to indicate one or more SL-PRS transmission(s) parameters. Specifically, the WTRU may be configured (e.g., preconfigured) with one or more SL-PRS configurations. The WTRU may then use NAS message to indicate the SL-PRS configurations for SL-PRS transmissions.

In examples, the WTRU (e.g., A-WTRU or T-WTRU) may be preconfigured and/or receive configuration (e.g., from the gNB, LMF, or another WTRU) with one or more parameters for SL-PRS transmission/reception in a resource pool. The WTRU may then determine other parameters for SL-PRS transmission and/or reception. The WTRU may then use SCI, MAC CE, PC5-RRC and/or NAS (e.g., LPP for sidelink) to indicate one or more determined SL-PRS transmission and/or reception parameters. For example, the WTRU may be preconfigured in a resource pool which includes the range of bandwidths, comb values and/or patterns, number of retransmissions, and/or the SL-PRS periodicities. The WTRU may then determine the bandwidth, comb value and/or pattern, the number of retransmissions, and/or SL-PRS periodicities from the set of configured (e.g., preconfigured) values in the resource pool.

The WTRU may indicate the determined parameters of SL-PRS transmission and/or reception in the transmission (e.g., in the SCI) associated with the SL-PRS. For example, the WTRU may use the second SCI (e.g., a new second SCI format design for indication of SL-PRS transmission/reception) to indicate one or more parameters of SL-PRS transmission/reception.

A WTRU may determine one or more cast types associated with sidelink positioning. In examples, the WTRU may determine the cast type associated with sidelink positioning session. The WTRU may determine whether to use unicast, groupcast, and/or broadcast for the sidelink positioning session. Specifically, the WTRU may determine whether to use unicast, groupcast, and/or broadcast for sidelink positioning request, feedback, and/or SL-PRS transmission/reception.

The WTRU may indicate the cast type in the associated transmission. For example, the WTRU may implicitly and/or explicitly indicate in the SCI (e.g., second SCI) associated with the request, and/or SL-PRS transmission. Such determination may be based on one or any combination of the following: positioning method, the output of the positioning session, and/or type of SL-PRS transmission and/or type of measurement reporting (e.g. whether the SL-PRS transmission is periodic, semi-persistent, or aperiodic).

In examples, the positioning method may include that the WTRU may use groupcast for SL-TDOA method. Additionally or alternatively, the WTRU may use unicast for the RTT method. The output of the positioning session may include whether the output is absolute positioning, relative positioning, and/or range. For example, the WTRU may use groupcast for absolute positioning. The WTRU may use unicast and/or broadcast for relative positioning and/or ranging. For example, the type of SL-PRS transmission and/or type of measurement reporting may include that the WTRU may use groupcast for periodic and/or semi-persistent SL-PRS transmission. For example, the WTRU may use unicast and/or groupcast for aperiodic SL-PRS.

In examples, a WTRU (e.g., T-WTRU or A-WTRU) may determine whether to perform SL-PRS transmission. If the WTRU determines to perform SL-PRS transmission, the WTRU may determine one or any combination of the SL-PRS transmission(s) parameters. The determined SL-PRS transmission(s) parameters may be used by the WTRU (e.g., the T-WTRU) to perform SL-PRS transmission. Additionally or alternatively, the determined SL-PRS transmission(s) parameters may be indicated to other WTRU(s) (e.g., from T-WTRU to A-WTRU) to perform SL-PRS transmission.

The WTRU may determine whether to perform SL-PRS transmission and/or one or more SL-PRS transmission(s) parameter(s) based on one or more parameters. For example, the WTRU may determine whether to perform SL-PRS transmission and/or one or more SL-PRS transmission(s) parameter(s) based on one or more configured (e.g., preconfigured) parameters in the resource pool. Specifically, the WTRU may be configured (e.g., preconfigured) with one or more resource pools for SL-PRS transmission. In each resource pool, the WTRU may be configured (e.g., preconfigured) with one or more SL-PRS transmission(s) parameters, which may be one or any combination of the exact value, minimum, maximum, and/or the range of transmission power, number of subchannels for each SL-PRS resource, reference resource pattern (e.g., comb size and/or comb pattern), set of sequence IDs, cyclic shifts, type of SL-PRS multiplexing, number of SL-PRS resources in one period, periodicity of SL-PRS process, duration of SL-PRS transmission, HARQ type of SL-PRS transmission, and/or cast type of SL-PRS transmission. The WTRU may then determine which resource pool to select for SL-PRS transmission based on the QoS of the positioning service.

For example, for positioning service with a small range requirement, the WTRU may select the resource pool allowing small transmission power, small bandwidth, small number of symbols for SL-PRS transmission, and/or small number of SL-PRS (re) transmissions and/or repetitions. Additionally or alternatively, for positioning service with a large range requirement, the WTRU may select the resource pool allowing large transmission power, large bandwidth, large number of symbols for SL-PRS transmission, and/or large number of SL-PRS (re) transmissions and/or repetitions.

For example, the WTRU may be configured (e.g., preconfigured) with two types of resource pools for SL-PRS transmission, in which the first resource pool may allow multiplexing SL-PRS with another sidelink transmission (e.g., sidelink data) and the second resource pool may not allow multiplexing SL-PRS with the other sidelink transmission (e.g. sidelink data). The WTRU may select the first resource pool for low positioning accuracy requirement; otherwise, for the high accuracy requirement, the WTRU may then select the second resource pool.

For example, for each resource pool, the WTRU may be configured (e.g., preconfigured) with the minimum and/or maximum number of subchannels/bandwidth for SL-PRS transmission. The WTRU may then determine which resource pool to perform SL-PRS transmission based on the configured (e.g., preconfigured) with minimum and/or maximum number of subchannels/bandwidth for SL-PRS transmission. Specifically, the WTRU may select the resource pool having the maximum configured (e.g., preconfigured) number of subchannels and/or bandwidth being greater than a threshold, which may be determined based on the QoS requirement of the positioning service (e.g., accuracy requirement).

The WTRU may determine whether to perform SL-PRS transmission and/or one or more SL-PRS transmission(s) parameter(s) based on an indication from another node. Specifically, a WTRU (e.g., A-WTRU) may determine one or more SL-PRS transmission(s) parameters, which may be one or any combination of the exact value, minimum, maximum, and/or the range of resource selection window for SL-PRS transmission, transmission power, number of subchannels for each SL-PRS resource, reference resource pattern (e.g., comb size and/or comb pattern), set of sequence IDs, cyclic shifts, type of SL-PRS multiplexing, number of SL-PRS resources in one period, periodicity of SL-PRS process, duration of SL-PRS transmission, HARQ type of SL-PRS transmission, and/or cast type of SL-PRS transmission, based on the indication from another node (e.g., T-WTRU, gNB, and/or LMF).

For example, the minimum number of subchannels to use for SL-PRS transmission may indicate a WTRU (e.g., an A-WTRU). An A-WTRU may represent an anchor WTRU. The WTRU may then perform SL-PRS transmission using the number of subchannels and/or bandwidth being greater or equal than the minimum bandwidth indicated from the other WTRU (e.g., T-WTRU). A T-WTRU may represent a target, or target WTRU. For example, the WTRU may be indicated the priority of SL-PRS transmission from another WTRU (e.g., T-WTRU). The other WTRU (e.g., T-WTRU) may indicate a WTRU (e.g., an A-WTRU). The WTRU may then perform SL-PRS resource selection and/or transmission using the priority indicated from the T-WTRU. For example, when the resource selection window for SL-PRS transmission from another WTRU (e.g., T-WTRU) indicates a WTRU (e.g., an A-WTRU), the WTRU may then perform SL-PRS resource selection and/or transmission within the indicated window.

The WTRU may determine whether to perform SL-PRS transmission and/or one or more SL-PRS transmission(s) parameter(s) based on one or more QoS requirements of the positioning service. For example, the WTRU may determine the transmission power of SL-PRS based on the range requirement of the positioning service. Specifically, the WTRU may be configured (e.g., preconfigured) with one or more maximum transmission power levels. The one or more maximum transmission power levels may be the function of the range requirement of the positioning service. The WTRU may determine the transmission power of the SL-PRS based on the associated range requirement. For example, for positioning service with small accuracy requirement, the WTRU may select the SL-PRS transmission having small bandwidth, small number of, and/or small number of SL-PRS (re) transmission/repetitions. Additionally or alternatively, for positioning service with high accuracy requirement, the WTRU may select SL-PRS transmission large bandwidth, large number of symbols, and/or large number of SL-PRS (re) transmission/repetitions.

The WTRU may determine whether to perform SL-PRS transmission and/or one or more SL-PRS transmission(s) parameter(s) based on a distance to the receiving WTRU and/or requesting WTRU. For example, the WTRU may determine the number symbols and/or reference signal pattern to use for SL-PRS transmission based on the distance to the receiving WTRU. Specifically, the WTRU may use smaller number of symbols for SL-PRS transmission if the distance between two WTRUs is smaller; otherwise, the WTRU may use a larger number of symbols for SL-PRS transmission.

The WTRU may determine whether to perform SL-PRS transmission and/or one or more SL-PRS transmission(s) parameter(s) based on a sidelink channel to the receiving WTRU and/or requesting WTRU. For example, the WTRU may determine the transmission power based on the sidelink channel between the transmitting WTRU and the receiving WTRU. Specifically, the WTRU may use smaller number of symbols for SL-PRS transmission if the distance between two WTRUs is smaller; otherwise, the WTRU may use a larger number of symbols for SL-PRS transmission.

The WTRU may determine whether to perform SL-PRS transmission and/or one or more SL-PRS transmission(s) parameter(s) based on a CBR of the resource pool.

The WTRU may determine whether to perform SL-PRS transmission and/or one or more SL-PRS transmission(s) parameter(s) based on a positioning accuracy of the WTRU or the positioning accuracy of the associated WTRU. For example, a WTRU (e.g., A-WTRU or T-WTRU) may determine the SL-PRS transmission(s) parameter(s) based on its positioning accuracy and the positioning accuracy of the receiver WTRU.

The WTRU may determine whether to perform SL-PRS transmission and/or one or more SL-PRS transmission(s) parameter(s) based on a positioning method. For example, the WTRU may determine the bandwidth of a SL-PRS transmission based on the positioning method. For example, the WTRU may be configured (e.g., preconfigured) with minimum SL-PRS and/or maximum SL-PRS bandwidth for timing based, phase based and/or angle-based method. The WTRU may determine which bandwidth to use for the SL-PRS transmission based on the positioning method used for the associated SL-PRS transmission and/or reception.

The WTRU may determine whether to perform SL-PRS transmission and/or one or more SL-PRS transmission(s) parameter(s) based on one or more measurement parameters to be measured. For example, the WTRU may determine the bandwidth of a SL-PRS transmission based on the positioning measurement parameter(s) for the SL-PRS transmission. Specifically, the WTRU may be configured (e.g., preconfigured) and/or indicated on a range of number of subchannels and/or symbols for SL-PRS transmission based on the whether the associated measurement is timing-related measurement (e.g., ToA and/or RSTD), angle measurement (e.g., AoA and/or AoD), or phase measurement (e.g., DPoA and/or PoA). The WTRU may then determine the bandwidth and/or the number of symbols used for SL-PRS transmission based on the associated measurement parameters so that the bandwidth and/or the number of symbols used for SL-PRS transmission is within the configured (e.g., preconfigured) and/or indicated range.

The WTRU may determine whether to perform SL-PRS transmission and/or one or more SL-PRS transmission(s) parameter(s) based on an output of the positioning procedure. The output of the positioning procedure may be absolute positioning or relative positioning. For example, the WTRU may be configured (e.g., preconfigured) and/or indicated two set of ranges of SL-PRS transmission(s) parameters, in which one or more set(s) of range(s) may be used for absolute positioning and another set(s) of range(s) may be used for relative positioning. The WTRU may then determine which set(s) of range(s) to use for its SL-PRS transmission. The WTRU may base which set(s) of range(s) to use on whether the WTRU uses SL-PRS transmission for determining the absolute positioning or relative positioning.

The WTRU may determine whether to perform SL-PRS transmission and/or one or more SL-PRS transmission(s) parameter(s) based on an amount of SL-PRS transmissions within a period. For example, the WTRU may determine whether to perform a SL-PRS transmission based on the number of SL-PRS transmissions and/or resources the WTRU has performed during a period. Specifically, if the number of SL-PRS transmissions and/or resources is greater than a threshold then the WTRU may not perform SL-PRS transmission; otherwise, the WTRU may perform SL-PRS transmission.

The WTRU may determine whether to perform SL-PRS transmission and/or one or more SL-PRS transmission(s) parameter(s) based on a prohibit time associated with a SL-PRS transmission and/or a SL-PRS request. For example, the WTRU may determine whether to perform a SL-PRS transmission based on a time gap (e.g., time period) between a current SL-PRS transmission and a last SL-PRS transmission and/or the last SL-PRS transmission request. Specifically, the WTRU may be configured (e.g., preconfigured) with the minimum time gap between two SL-PRS transmissions or time gap between the last SL-PRS request and the current SL-PRS transmission. The WTRU may perform the current SL-PRS transmission if the time gap between two SL-PRS transmissions or the time gap between the current SL-PRS transmission and the last SL-PRS transmission request is greater than a configured (e.g., preconfigured) value. If the time gap between two SL-PRS transmission or the time gap between the current SL-PRS transmission and the last SL-PRS transmission request is less than or equal to the configured value, the WTRU may not perform SL-PRS transmission.

The WTRU may determine whether to perform SL-PRS transmission and/or one or more SL-PRS transmission(s) parameter(s) based on one or more parameters used for SL-PRS transmission from the requesting WTRU. For example, the WTRU may determine one or more SL-PRS transmission(s) parameters for its SL-PRS transmission based on one or more SL-PRS transmission(s) parameters from the requesting WTRU. For example, the WTRU may use the similar priority, periodicity, bandwidth, reference signal pattern, and/or transmission power of the SL-PRS transmission from the requesting WTRU for its SL-PRS transmission. For example, the offset of the SL-PRS may be determined based on the SL-PRS offset of a peer WTRU plus delta. The value of delta may be a function of the WTRU processing capability.

A WTRU may be configured (e.g., preconfigured) with a set of SL-PRS configurations. In examples, the WTRU may be configured (e.g., preconfigured) with multiple SL-PRS configurations (e.g. each configuration may be associated with one or more sets of SL-PRS transmission/reception parameters). The SL-PRS transmission/reception parameters may include, for example, the bandwidth, comb pattern, the resource offset, the periodicity, the number of retransmissions, transmission power, and/or muting pattern. The WTRU may be configured (e.g. preconfigured) with one or more SL-PRS configurations in the resource pool and/or receive the configuration from another node (e.g., another WTRU and/or gNB). The WTRU may receive configurations (e.g., preconfigurations related to SL-PRS, transmission and/or reception procedure, priorities of SL-PRS) described in the disclosure from the network (e.g., LMF and/or gNB).

A WTRU may indicate which SL-PRS configuration to use. The WTRU may indicate the SL-PRS configuration in one or more transmission(s) associated with the SL-PRS transmission. For example, the WTRU may use SCI (e.g., the first stage SCI or the second stage SCI) to indicate which SL-PRS configuration the WTRU is using. Specifically, the WTRU may be configured (e.g., preconfigured) with multiple SL-PRS configurations. The WTRU may indicate the index of the SL-PRS configuration (e.g., in the SCI) in the set of SL-PRS configurations. The WTRU (e.g., anchor WTRU) may indicate the index to the target WTRU. In examples, the WTRU may be configured (e.g., preconfigured) by the network (e.g., LMF and/or gNB) or peer WTRU with a plurality of priority levels (e.g., a subset of priority levels). Based on the criteria (e.g, QoS) described herein, the WTRU may determine to associate one of the preconfigured priority levels with a SL-PRS, feedback, and/or measurement report. For example, the WTRU may be preconfigured with a subset of priority levels 2, 3, 4 where the highest priority level is 1. The WTRU may determine to associate priority level 2, 3 or 4 to a SL-PRS. The priority level associated with the SL-PRS may be indicated in the associated SCI, MAC-CE, RRC, or LPP message.

In examples, the target WTRU may indicate the index to the anchor WTRU. Whether the anchor and/or the target WTRU indicate(s) the index to target and/or anchor WTRU, respectively, may depend on the positioning method (e.g., SL-TDOA, RTT) implemented between the target WTRU and anchor WTRU(s).

In examples, a WTRU (e.g., T-WTRU) may request one or more A-WTRU(s) to perform SL-PRS reception, SL-PRS transmission, transmission to feedback the request (e.g. ACK/NACK transmission), and/or positioning measurement reporting.

In examples, for SL-PRS reception-based positioning method, which is similar to DL-based positioning, the WTRU (e.g., T-WTRU) may request one or more A-WTRUs to perform SL-PRS transmission. For WTRU based (WTRU-B) positioning method, the WTRU may then perform SL-PRs reception and determine its position. Additionally or alternatively, for the WTRU assisted (WTRU-A) positioning method, the WTRU may perform SL-PRS reception, SL-PRS reception, and measurement reporting to another node.

In examples, for SL-PRS transmission-based positioning method, which is similar to UL-based positioning, the WTRU (e.g., T-WTRU) may request one or more A-WTRUs to perform SL-PRS reception and positioning measurement report. The WTRU may then perform SL-PRS transmission for the A-WTRU(s) to perform measurement and report.

In examples, SL-PRS transmission and reception-based method (e.g., multiple RTT based method), the WTRU may request one or multiple A-WTRUs to perform SL-PRS transmission, reception, and measurement reporting.

A WTRU (e.g., T-WTRU) may indicate the range, the maximum, and/or the minimum of one or more of the first set of positioning request parameters to the A-WTRUs. The A-WTRU may then determine whether to perform the associated request based on whether the measured and/or calculated value(s) of one or more parameters in the first set of parameters is within a range. The range may be configured (e.g., preconfigured) or may be indicated by the T-WTRU.

The first set of parameters may include a distance to another node (e.g., the requesting WTRU, gNB). For example, a WTRU (e.g., T-WTRU) may indicate the range of distance to itself or to the gNB (e.g., minimum and/or maximum distance). The T-WTRU may further indicate its location or the gNB's location (e.g., the coordinate or the zone ID). The A-WTRU, after receiving the indication from the T-WTRU, may determine whether to perform the associated request based on the distance between the WTRU and the other node (e.g., the requesting WTRU, the T-WTRU, or the gNB). The associated request may include transmitting feedback (e.g., ACK/NACK) to the request, transmitting SL-PRS, receiving SL-PRS, and/or performing sidelink measurement report. Specifically, if the distance between the A-WTRU and the other node is within the range, the A-WTRU may perform the associated request. If the distance between the A-WTRU and the other node is outside of the range the A-WTRU may not perform the associated request. For example, the A-WTRU may perform an associated request (e.g., SL-PRS transmission, reception, and/or measurement reporting) if the distance between the A-WTRU and the T-WTRU is smaller than an indicated threshold. If the distance between the A-WTRU and the T-WTRU is larger than the indicated threshold, the WTRU may not perform the associated request (e.g., perform SL-PRS transmission, reception, and/or measurement reporting).

The first set of parameters may include a positioning accuracy of the A-WTRU. For example, a WTRU (e.g., T-WTRU) may indicate the range of positioning accuracy (e.g., the maximum positioning error) for the A-WTRU to determine whether to perform the associated request. Specifically, a A-WTRU, after receiving the indication from the T-WTRU, may determine whether to perform the associated request (based on the maximum positioning error of the WTRU. The associated request may feedback (e.g. ACK/NACK) to the request, transmitting SL-PRS, receiving SL-PRS, and/or performing sidelink measurement report). Specifically, if the maximum positioning error of the A-WTRU is smaller than the indicated maximum positioning error from the T-WTRU, the A-WTRU may perform the associated request. If the maximum positioning error of the A-WTRU is larger than the indicated maximum positioning error, the A-WTRU may not perform the associated request.

The first set of parameters may include a Uu RSRP. For example, a WTRU (e.g., T-WTRU) may indicate the range of Uu RSRP (e.g., minimum Uu RSRP and/or maximum Uu RSRP) for the A-WTRU to determine whether to perform the associated request. The A-WTRU may determine whether to perform the associated request based on the A-WTRU's Uu RSRP. The associated request may include, for example, transmitting feedback (e.g., ACK/NACK) to the request, transmitting SL-PRS, receiving SL-PRS, and/or performing sidelink measurement report. Specifically, if the A-WTRU's Uu RSRP is within the indicated range, the A-WTRU may perform the associated request. If the A-WTRU's Uu RSRP is not within the indicated range, the A-WTRU may not perform the associated request.

The first set of parameters may include an SL-RSRP in the sidelink channel of with the requesting WTRU. For example, a WTRU (e.g., T-WTRU) may indicate the range of SL-RSRP (e.g., minimum SL-RSRP and/or maximum SL-RSRP) for the A-WTRU to determine whether to perform the associated request. The A-WTRU may determine whether to perform the associated request based on the SL-RSRP of the sidelink channel between the T-WTRU and the A-WTRU. The associated request may include, for example, transmitting feedback (e.g. ACK/NACK) to the request, transmitting SL-PRS, receiving SL-PRS, and/or performing sidelink measurement report. Specifically, if the SL-RSRP in the sidelink channel between the T-WTRU and the A-WTRU is within the indicated range, the A-WTRU may perform the associated request. If the SL-RSRP in the sidelink channel between the T-WTRU and the A-WTRU is not within the indicated range, the A-WTRU may not perform the associated request.

The first set of parameters may include an AoA and/or an AoD of the transmission from and/or to the requesting WTRU. For example, a WTRU (e.g., T-WTRU) may indicate the range of AoA for the A-WTRU to determine whether to perform the associated request. The A-WTRU may determine whether to perform the associated request based on the AoA of the transmission(s) from the requesting WTRU (e.g., the transmission of the requesting message). The associated request may include, for example, transmitting feedback (e.g., ACK/NACK) to the request, transmitting SL-PRS, receiving SL-PRS, and/or performing sidelink measurement report. Specifically, if the AoA of the transmission from the requesting WTRU is within the range of SL-RSRP in the sidelink channel between the T-WTRU and the A-WTRU is within the indicated range, the A-WTRU may perform the associated request. If the AoA of the transmission from the requesting WTRU is not within the range of SL-RSRP in the sidelink channel between the T-WTRU and the A-WTRU, the A-WTRU may not perform the associated request.

The first set of parameters may include a LOS/NLOS parameter. LOS/NLOS is a parameter which may indicate a probability that a link is LOS or NLOS. The LOS/NLOS parameter may be represented by a value from 0 to 1. A LOS/NLOS value of 0 may indicate that the respective link is NLOS. A LOS/NLOS value of 1 may indicate that the link is LOS. The closer the LOS/NLOS value is to 0, the higher the probability that the respective link may be NLOS. Whereas the closer the LOS/NLOS parameter is to 1, the higher the probability the respective link may be LOS. Stated alternatively, the LOS/NLOS parameter may be used to indicate the likelihood of LOS channel between two nodes, in which the higher value of LOS/NLOS parameter, the more likelihood the channel between two nodes is LOS. For example, a WTRU (e.g., T-WTRU) may indicate the range of LOS/NLOS for the A-WTRU to determine whether to perform the associated request. The A-WTRU may determine whether to perform the associated request based on the LOS/NLOS parameter of the channel between the requesting WTRU and the A-WTRU. The associated request may include, for example, transmitting feedback (e.g., ACK/NACK) to the request, transmitting SL-PRS, receiving SL-PRS, and/or performing sidelink measurement report. Specifically, if the LOS/NLOS parameter between the requesting WTRU and the A-WTRU is within the indicated range, the A-WTRU may perform the associated request. If the LOS/NLOS parameter between the requesting WTRU and the A-WTRU is outside the indicated range, the A-WTRU may not perform the associated request.

The first set of parameters may include a synchronization offset and/or error. The synchronization offset and/or error may be determined based on the offset and/or error between slot boundary of two WTRUs. The synchronization offset and/or error may be determined based on the offset and/or error between the reception timing of the signal from one WTRU and the reference timing of the WTRU (e.g., the slot boundary). For example, a WTRU (e.g., T-WTRU) may indicate the maximum synchronization offset and/or error to an A-WTRU to determine whether to perform the associated request. The A-WTRU may determine whether to perform the associated request based on whether the synchronization offset and/or error is smaller than the indicated maximum value. The associated request may include, for example, transmitting feedback (e.g., ACK/NACK) to the request, transmitting SL-PRS, receiving SL-PRS, and/or performing sidelink measurement report. Specifically, if the synchronization offset and/or error is greater than a threshold, the WTRU may not perform the associated request. If the synchronization offset and/or error is less than or equal to the threshold, the WTRU may perform the associated request.

The first set of parameters may include a type of synchronization source for another WTRU (e.g., A-WTRU). Specifically, the WTRU (e.g., T-WTRU) may indicate whether another WTRU (e.g., A-WTRU) should be synchronized to a gNB (e.g., a specific cell ID, TRP ID), a reference WTRU synchronized to the gNB, GNSS, and/or a reference WTRU synchronized to GNSS to perform the associated request. For example, a WTRU (e.g., T-WTRU) may indicate the type of synchronization source for another WTRU (e.g., A-WTRU) to determine whether to perform the associated request. The A-WTRU may determine whether to perform the associated request based on whether the synchronization source belongs to the set of synchronization source(s) indicated in the positioning request message. The associated request may include, for example, transmitting feedback (e.g. ACK/NACK) to the request, transmitting SL-PRS, receiving SL-PRS, and/or performing sidelink measurement report. Specifically, the WTRU may perform the associated request if the synchronization source belongs to the set of sources indicated in the positioning request message. If the synchronization source does not belong to the set of sources indicated in the positioning request message, the WTRU may not perform the associated request.

The first set of parameters may include a type of synchronization source of the requesting WTRU. Specifically, the WTRU may indicate its synchronization source, which may include one or any of a gNB (e.g., a specific cell ID and/or TRP ID), a reference WTRU synchronized to gNB, GNSS, and/or a reference WTRU synchronized to GNSS. For example, a WTRU (e.g., T-WTRU) may indicate its synchronization source. The A-WTRU may then determine whether to perform the associated request based on its synchronization source and the synchronization source of the T-WTRU. The associated request may include, for example, transmitting feedback (e.g. ACK/NACK) to the request, transmitting SL-PRS, receiving SL-PRS, and/or performing sidelink measurement report. Specifically, the A-WTRU may perform the associated request if the WTRU is synchronized to the T-WTRU. The A-WTRU may perform SL-PRS transmission using the timing of the positioning request message. Additionally or alternatively, the A-WTRU may determine to perform the associated request if the WTRU is synchronized to the same synchronization source with the T-WTRU.

The first set of parameters may include a coverage status of another WTRU (e.g., A-WTRU). For example, a WTRU (e.g., T-WTRU) may indicate the desired coverage status of an A-WTRU, which may include the cell ID and/or TRP ID. The A-WTRU, after receiving the positioning request message from the T-WTRU, may determine whether to perform the associated request based on the A-WTRU's coverage status. Specifically, if the WTRU is under the coverage of the cell and/or TRP indicated in the requesting message, the WTRU may perform the associated request. If the WTRU is not under the coverage of the cell and/or TRP indicated in the requesting message otherwise, the A-WTRU may not perform the associated request.

The first set of parameters may include a coverage status of the requesting WTRU (e.g., T-WTRU). For example, a WTRU (e.g., T-WTRU) may indicate its coverage status (e.g., whether the WTRU is out of coverage or in coverage of a cell/TRP). The A-WTRU, after receiving the positioning request message from the T-WTRU, may determine whether to perform the associated request based on its coverage status and the coverage status of the T-WTRU. For example, if the T-WTRU is out of coverage, the WTRU may perform associated request regardless of its coverage status. However, if the T-WTRU is in coverage of a gNB and/or TRP, the WTRU may perform the associated request if the WTRU is in coverage of the same gNB and/or TRP. If the T-WTRU is in coverage of a gNB and/or TRP, the WTRU may perform the associated request if the WTRU is in coverage of gNB and/or TRP having the same PLMN ID with the gNB and/or TRP of the requesting T-WTRU.

The first set of parameters may include a set of zone IDs to respond. For example, a WTRU (e.g., T-WTRU) may indicate a set of zone IDs for A-WTRU to determine whether to perform the associated request. The associated request may include, for example, transmitting feedback (e.g. ACK/NACK) to the request, transmitting SL-PRS, receiving SL-PRS, and/or performing sidelink measurement report. Specifically, if the A-WTRU's zone ID is within the set of zone IDs indicated in the positioning request message, the WTRU may perform the associated request. If the A-WTRU's zone ID is not within the set of zone IDs, the A-WTRU may not respond to the associated request.

The first set of parameters may include a positioning method. For example, the WTRU (e.g., T-WTRU) may indicate the positioning method (e.g., carrier phase-based positioning, timing-based positioning (e.g., TDOA), angle-based positioning) the WTRU may use. The A-WTRU may then determine whether to perform the associated request based on whether the WTRU supports the positioning method. Specifically, the WTRU may perform the associated request if the WTRU supports the positioning method. If the WTRU does not support the positioning method, the WTRU may not perform the associated request.

The first set of parameters may include one or more positioning measurement parameters. For example, the WTRU may indicate one or more positioning measurement parameters (e.g., DPoA, PoA, AoA, AoD, RSTD, ToA, Tx-Rx timing, and/or LOS/NLOS, etc.). The A-WTRU may determine whether to perform the associated request based on whether the WTRU supports the measurement parameter. Specifically, the WTRU may perform the associated request if the WTRU supports the measurement/calculation parameter(s). If the WTRU does not support the measurement and/or calculation parameter(s), the WTRU may not perform the associated request.

The first set of parameters may include one or more reported positioning measurement parameters. For example, a WTRU (e.g., T-WTRU) may indicate an expected range of one positioning measurement parameter. In one approach, the WTRU may perform the associated request (e.g., performing measurement reporting) if the measurement value is within the expected range. If the measurement value is outside the expected range, the WTRU may not perform the associated request. In examples, if the measurement value is outside of the expected range, the WTRU may still perform the associated request and the A-WTRU may inform the T-WTRU of the error.

A WTRU (e.g., T-WTRU) may indicate the one or more parameters in the second set of positioning request parameters for an A-WTRU to perform the associated request.

The second set of positioning request parameters may include one or more of the following. The second set of positioning request parameters may include a type of positioning request. Specifically, the WTRU (e.g., T-WTRU) may indicate another WTRU (e.g., A-WTRU) to perform one or any combination of SL-PRS transmission, SL-PRS reception, feedback (e.g. ACK/NACK) to request, and positioning measurement reporting.

The second set of positioning request parameters may include a QoS of the positioning request message, the associated SL-PRS transmission and/or reception, positioning measurement reporting, and/or the associated positioning service.

The second set of positioning request parameters may include a time window of SL-PRS transmission and/or reception. Specifically, the T-WTRU may request the A-WTRU to perform SL-PRS transmission(s) and/or reception(s). The T-WTRU may indicate the time window(s) for the requested SL-PRS transmissions and/or reception(s). The WTRU (e.g., T-WTRU) may determine the time window for SL-PRS transmission and/or reception to indicate to other WTRUs (e.g., A-WTRUs) based on the QoS of the positioning service (e.g., latency requirement). Specifically, for low latency requirement positioning service, the WTRU may indicate a short SL-PRS transmission and/or reception window; otherwise, the WTRU may indicate a long SL-PRS transmission and/or reception window.

In examples, the T-WTRU may request an A-WTRU to perform SL-PRS transmission. The WTRU may indicate the expected time window of the SL-PRS transmission. The expected time window may include the minimum and/or maximum timing of the SL-PRS transmission. In examples, the T-WTRU may request an A-WTRU to perform SL-PRS reception. The WTRU may then indicate the expected time window of the SL-PRS reception. The expected time window may include the minimum and/or maximum timing of the SL-PRS reception.

The second set of positioning request parameters may include a time window of sidelink measurement reporting. For example, the T-WTRU may request an A-WTRU to perform sidelink measurement reporting. The WTRU may indicate the expected time window of the reporting, which may include the minimum and/or maximum timing of the report.

The second set of positioning request parameters may include one or any combination of the SL-PRS transmission(s) parameters for A-WTRU to perform SL-PRS transmission(s). In the first example, the T-WTRU may request an A-WTRU to perform SL-PRS transmission(s). The WTRU may indicate one or any combination of the SL-PRS transmission(s) parameters for the A-WTRU to perform SL-PRS transmission(s). In examples, the WTRU may indicate one or any combination of the parameters for one SL-PRS transmission. Specifically, the T-WTRU may indicate the minimum and/or maximum number of subchannels, number of symbols and/or slots, and/or comb values used for each SL-PRS resource. In examples, the WTRU may indicate one or any combination of the parameters for multiple SL-PRS transmissions. For example, the WTRU may indicate the type of SL-PRS transmission. Specifically, the WTRU may request and/or indicate whether the A-WTRU to perform aperiodic SL-PRS transmission or periodic SL-PRS transmission. For the SL-PRS transmission within one period, the T-WTRU may indicate and/or request the minimum and/or maximum number of SL-PRS transmissions. The WTRU may also indicate/request the periodicity, the number of periods, and/or the duration of SL-PRS transmissions.

In examples, the T-WTRU may be configured (e.g., preconfigured) with one or more combinations of SL-PRS transmission(s) parameters. The one or more combinations of SL-PRS transmission(s) parameters may include range(s) of one or more SL-PRS transmission(s) parameters. The T-WTRU may then indicate one combination of SL-PRS transmission(s) parameters for an A-WTRU to perform SL-PRS transmissions.

The second set of positioning request parameters may include one or any combination of the information to support A-WTRU in performing SL-PRS reception(s). For example, the T-WTRU may request an A-WTRU to perform SL-PRS reception(s). The request may be transmitted from the T-WTRU or other A-WTRU(s). The T-WTRU may then indicate one or any combination of the SL-PRS transmission(s) parameters for the A-WTRU to perform SL-PRS reception and/or measurement.

The second set of positioning request parameters may include one or any combination of the SL-PRS measurement reporting parameters. For example, the T-WTRU may request an A-WTRU to perform SL-PRS measurement reporting. The T-WTRU may indicate one or any combination of the SL-PRS measurement reporting parameters. The T-WTRU may indicate the type of positioning measurement reporting (e.g., whether the A-WTRU needs to perform periodic or aperiodic positioning measurement reporting). The T-WTRU may indicate the priority, latency, the measurement parameters to report, and/or the value range of each reported parameters.

The second set of positioning request parameters may include one or more resource(s) used for SL-PRS transmission/reception and/or sidelink measurement reporting. For example, the WTRU may request an A-WTRU to perform SL-PRS transmission and/or reception and/or sidelink measurement reporting. The WTRU may indicate the possible resource(s) used for each request. In examples, the WTRU may request one or more A-WTRU(s) to perform SL-PRS transmission(s). The WTRU may determine the set of available resource(s) for A-WTRU(s) to select and perform SL-PRS transmission. In other examples, the WTRU may request the resource(s) (e.g., from the network) for the A-WTRU(s) to perform SL-PRS transmission(s). The WTRU may then indicate the selected/requested resource(s) to A-WTRU(s) to perform SL-PRS transmission(s).

The WTRU may determine the set of resources for A-WTRU(s) to perform SL-PRS transmission. This approach may allow the A-WTRU to use (e.g. directly use) the SL-PRS resources indicated from the T-WTRU without sensing. In examples, the WTRU may request one or more A-WTRU(s) to perform SL-PRS reception. The WTRU may then request the network (e.g., gNB) the SL-PRS transmission resource. Additionally or alternatively, the WTRU may perform resource selection for SL-PRS transmission. The WTRU may then indicate the requested and/or selected resource(s) for A-WTRU(s) to perform SL-PRS reception and measurement.

The second set of positioning request parameters may include one or any combination of the SL-PRS transmission(s) parameters used by the requesting WTRU (e.g., T-WTRU) to support A-WTRU in performing SL-PRS reception. For example, the WTRU (e.g., T-WTRU) may indicate in the positioning request message, whether SL-PRS is embedded in the request message.

A WTRU (e.g., T-WTRU) may indicate the range, the maximum, and/or the minimum of one or more parameters in the first and second set of positioning request parameters using SCI, MAC CE, and/or NAS message (e.g., LPP message and/or Sidelink Positioning Protocol (SLPP) message).

In examples, the WTRU may use SCI to indicate one or more parameters in the set of positioning request parameters (e.g., the first set of positioning request parameters and the second set of positioning request parameters).

The WTRU may use SCI to indicate a type of positioning request. For example, the WTRU may be configured (e.g., preconfigured) with multiple types of positioning requests. The WTRU may indicate the type of positioning request in the SCI. In one approach, the WTRU may indicate the type of positioning request in the first SCI. Additionally or alternatively, the WTRU may indicate the type of positioning request in the second SCI. The WTRU may indicate the first type of positioning request in both the first and second SCI. For example, the WTRU may indicate whether the A-WTRU should perform one set of requests in the first SCI (e.g., whether the WTRU should perform SL-PRS transmission and/or reception), the WTRU may indicate whether the A-WTRU should perform another set of requests in the second SCI (e.g., whether the WTRU should transmit ACK/NACK for the positioning request message).

The WTRU may use SCI to indicate a QoS of the positioning request message, the associated SL-PRS transmission/reception, positioning measurement reporting, and/or the associated positioning service. For example, the WTRU may indicate the priority of the positioning request in the SCI. Other WTRUs (e.g., A-WTRU) may determine the priority of the associated SL-PRS transmission/reception, positioning measurement reporting, and/or the associated positioning service based on the priority indicated in the positioning request in the SCI (e.g., the priority of the associated SL-PRS transmission and/or reception, positioning measurement reporting, and/or the associated positioning service may be equal to the priority indicated in the positioning request message).

The WTRU may use SCI to indicate a time window of SL-PRS transmission and/or reception and/or sidelink measurement reporting. For example, the WTRU may indicate the window of SL-PRS transmission/reception and/or sidelink measurement reporting in the SCI (e.g., second SCI).

The WTRU may use SCI to indicate one or more of the SL-PRS transmission(s) parameters (e.g., for A-WTRU and/or T-WTRU), and/or SL-PRs measurement parameters. For example, the WTRU may indicate the possible resource(s) for A-WTRU to perform SL-PRS transmission and/or measurement reporting.

The WTRU may use SCI to indicate a range of distance to another node (e.g., the requesting WTRU and/or gNB), positioning accuracy of the A-WTRU, Uu RSRP, SL-RSRP, AoA/AOD, LOS/NLOS, synchronization offset and/or error, type of synchronization source, coverage status of A-WTRU and/or T-WTRU, positioning measurement parameters, and/or the set of zone IDs. For example, the WTRU may be configured (e.g., preconfigured) to indicate multiple parameters in the second SCI, the WTRU may use second SCI to indicate which parameters and its associated range to indicate in the positioning request message. For example, the WTRU may indicate the range of distance to the requesting WTRU in the second SCI.

The WTRU may use SCI to indicate a positioning method. For example, the WTRU may indicate the positioning method in the first SCI of the positioning request message. The WTRU may be configured (e.g., preconfigured) with multiple positioning methods (e.g., angle-based, timing-based, and/or carrier-phase-based methods). The WTRU may then indicate which positioning method is used in the positioning request message.

In examples, the WTRU may use MAC CE to indicate one or more parameters in the set of positioning request parameters. The WTRU may use MAC CE to indicate one or more of the SL-PRS transmission(s) parameters (e.g., for A-WTRU and/or T-WTRU), and/or SL-PRs measurement parameters. For example, the WTRU may use MAC CE to indicate the possible resource(s) for A-WTRU to perform SL-PRS transmission and/or measurement reporting.

In examples, the WTRU may use group PC5-RRC, which may be established for a group of WTRUs, to indicate one or more parameters in the set of positioning request parameters. The WTRU may use group PC5-RRC to indicate a QoS of the positioning request message, the associated SL-PRS transmission and/or reception, positioning measurement reporting, and/or the associated positioning service. The WTRU may use group PC5-RRC to indicate a time window of SL-PRS transmission/reception and/or sidelink measurement reporting. The WTRU may use group PC5-RRC to indicate one or any combination of the SL-PRS transmission(s) parameters (e.g., for A-WTRU and/or T-WTRU), and/or SL-PRs measurement parameters. The WTRU may use group PC5-RRC to indicate the positioning method used in the group of WTRUs. The WTRU may use group PC5-RRC to indicate one or more measurement parameter(s).

In examples, the WTRU may use group PC5-RRC to indicate and/or negotiate the configuration for SL-PRS transmission/reception, and/or measurement reporting. A WTRU (e.g., T-WTRU). The group PC5-RRC message may be used to indicate and/or negotiate the configuration of SL-PRS transmission/reception and/or measurement reporting of each WTRU in the group. After the group PC5-RRC is established, the WTRUs in the group may perform the associated SL-PRS transmission/reception and/or measurement reporting.

In examples, the WTRU may use group NAS message (e.g., LPP message) to indicate and/or negotiate the configuration for SL-PRS transmission/reception, and/or measurement reporting. The group NAS message may be used to indicate and/or negotiate the configuration of SL-PRS transmission/reception and/or measurement reporting of each WTRU in the group. After the NAS message is exchanged among WTRUs in the group, the WTRUs in the group may perform the associated SL-PRS transmission/reception and/or measurement reporting.

The WTRU may use one or any combination of timing parameters as a reference point for the timing of the indicated parameters. For example, the WTRU may use a Direct Frame Number (DFN) timing as the reference point. Specifically, the T-WTRU may request the A-WTRU to perform SL-PRS transmission and/or reception. The T-WTRU may indicate the time window of SL-PRS transmission/reception, which may include the first and the last possible sidelink slot for the A-WTRU to perform SL-PRS transmission and/or reception. The first possible slot for SL-PRS transmission/reception may be indicated as the minimum DFN offset and the last possible slot for SL-PRS transmission/reception may be indicated as the maximum DFN offset.

The WTRU may use a timing of the request as the reference point. For example, the T-WTRU may request the A-WTRU to perform SL-PRS transmission/reception. The T-WTRU may indicate the time window of SL-PRS transmission and/or reception, which may include the minimum time gap between the timing of the request and the timing of SL-PRS transmission/reception and/or the maximum time gap between the timing of the request and the timing of SL-PRS transmission/reception.

The WTRU may use timing of one of the timings indicated in the request as the reference point. For example, the T-WTRU may request the A-WTRU to perform SL-PRS measurement reporting. In the request message, the WTRU may include the timing of SL-PRS transmission. The WTRU may indicate the time window of SL-PRS measurement reporting, which may include the minimum and/or the maximum time gap between the SL-PRS transmission and the SL-PRS measurement reporting. The SL-PRS measurement reporting may be used to report the measurement of the indicated SL-PRS transmission.

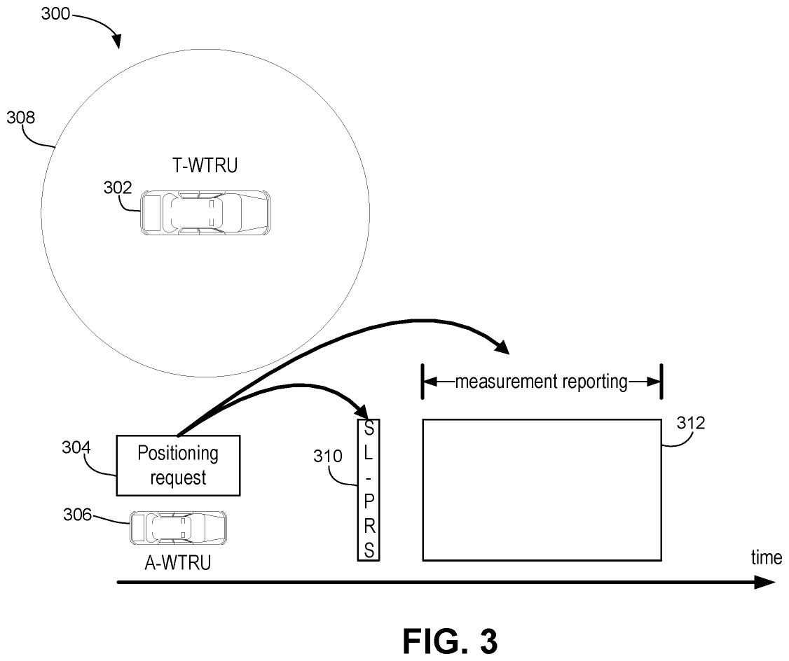

FIG. 3 depicts an example process 300 for determining parameters to include in a positioning request message 304. In the example process 300 shown in FIG. 3, the T-WTRU 302 may transmit a positioning request message 304, in which the T-WTRU 302 may use SCI (e.g., first SCI) to indicate the type of positioning request. Specifically, the T-WTRU 302 may request the A-WTRU 306 to perform SL-PRS measurement and reporting. The T-WTRU 302 may use the SCI (e.g., second SCI) to indicate the range requirement 308 of the positioning service (e.g., WTRUs within the circle around the T-WTRU can be considered within the range requirement 308 of the T-WTRU). In the positioning request message 304, the T-WTRU 302 may indicate the SL-PRS transmission(s) parameters of its SL-PRS transmission (e.g., the time and frequency resource of its SL-PRS transmission is shown). The WTRU also may indicate (e.g., in SCI, MAC CE, and/or RRC) the expected measurement reporting window 312, depicted in FIG. 3 after the SL-PRS transmission resource 310.

In examples, a WTRU (e.g., T-WTRU 302) may determine whether to transmit a positioning request message 304 to request an A-WTRU 306 to perform an associated positioning request (e.g., a request to transmit feedback (e.g. ACK/NACK) to the request, transmit SL-PRS, receive SL-PRS, and/or transmit sidelink measurement report) based on one or any combination of the following.

A T-WTRU 302 may determine whether to transmit a positioning request message 304 to request an A-WTRU 306 to perform to an associated positioning request based on a prohibit time of the request. For example, the T-WTRU 302 may be configured (e.g., preconfigured) with a prohibit period for positioning request. In examples, the T-WTRU 302 may be allowed to perform another positioning request if the T-WTRU 302 receives response(s) from one or more A-WTRUs (e.g., such as the A-WTRU 306). The T-WTRU 302 may not be allowed to perform another positioning request if the T-WTRU 302 has not received one or more positioning responses from the peer WTRU (e.g., such as the A-WTRU 306). The T-WTRU 302 may be allowed to transmit another positioning request after a prohibit period following the first positioning request. For example, the T-WTRU 302 may be allowed to transmit another positioning request after expiration of the prohibit period. The prohibit period may be configured (e.g., preconfigured) per one or any combination the QoS parameters of the positioning service and/or per resource pool.

A T-WTRU 302 may determine whether to transmit a positioning request message 304 to request that an A-WTRU 306 to perform to an associated positioning request based on a number of positioning request message and/or the number of positioning request transmission within a period. In examples, the T-WTRU 302 may be configured (e.g., preconfigured) with a maximum number of positioning request transport blocks (TBs) within a period. The T-WTRU 302 may determine to transmit a TB if the number of positioning request TBs is less than the threshold. If the number of positioning request TBs is greater than or equal to the threshold, the WTRU may not transmit the positioning request TBs.

In examples, the WTRU may be configured (e.g., preconfigured) with a maximum number of positioning request (re) transmissions and/or resources within a period. The WTRU may then determine to transmit a positioning request message if the number of positioning request transmissions is less than the maximum configured (e.g., preconfigured) value. If the number of positioning request transmissions is greater than or equal to the maximum configured (e.g., preconfigured) value, the WTRU may not perform the positioning request transmission.

In examples, a WTRU (e.g., T-WTRU) may determine the type of positioning request, in which each type of the positioning request message may request A-WTRUs to perform one or any combination of SL-PRS transmission, SL-PRS reception, feedback to the request (e.g., ACK/NACK), and/or positioning measurement reporting. The WTRU may determine the type of positioning request based on one or any combination of the following.

The WTRU may determine the type of positioning request based on a positioning accuracy of the WTRU (e.g., T-WTRU). For example, the WTRU may determine to perform one type of positioning request if the positioning accuracy of the WTRU is smaller than a threshold, the WTRU may then switch to another type of positioning request if the positioning accuracy of the WTRU is greater than the threshold. For example, the WTRU may request the A-WTRU to perform SL-PRS transmission, reception, and/or measurement reporting if the positioning accuracy of the WTRU is smaller than a threshold. The WTRU may then request the A-WTRU to perform SL-PRS transmission if (e.g., only if) the positioning accuracy of the WTRU is larger than the threshold.

The WTRU may determine the type of positioning request based on a synchronization error between two WTRUs. For example, if the synchronization error between two WTRUs (e.g., requesting WTRU and A-WTRU) is greater than a threshold, the WTRU may request the A-WTRU to perform SL-PRS transmission, reception, and measurement reporting. Otherwise, if the synchronization error between two WTRUs is smaller than the threshold and/or the WTRU has the information of the synchronization error between two WTRUs, the WTRU may request the A-WTRU to perform either SL-PRS transmission, and/or SL-PRS reception and/or measurement reporting.

A WTRU (e.g., an A-WTRU) may monitor positioning request from another WTRU (e.g., T-WTRU). The WTRU may be indicated an ID (e.g., L2 ID) to determine whether to respond to a request. Specifically, the WTRU may respond to the request if the ID included in the request message is associated with the indicated ID; otherwise, the WTRU may not respond to the message.

The WTRU may determine whether to feedback the sidelink positioning request. In examples, the WTRU may receive a positioning request message to ask the WTRU participating in the sidelink positioning. The WTRU may be required to transmit/receive SL-PRS and/or sidelink measurement reporting if the WTRU participates in the sidelink positioning group. In examples, the WTRU may feedback ACK/NACK based on whether the WTRU participates in the sidelink positioning. In examples, the WTRU may feedback ACK if the WTRU participates in the sidelink positioning but the WTRU may not feedback the request if the WTRU does not participate the sidelink positioning.

The WTRU may determine whether to feedback a SL-PRS transmission. In examples, the WTRU (e.g., A-WTRU) may receive a transmission (e.g., PSCCH/PSSCH containing SCI, MAC CE, PC5-RRC) associated with SL-PRS transmission, which may require the WTRU to feedback the information associated with SL-PRS transmission (e.g., in the SCI of the associated transmission).

The WTRU may determine the priority associated with the transmission of the feedback. The WTRU may determine the priority associated with the feedback (e.g., feedback a positioning request message and/or feedback a SL-PRS transmission). The priority of the feedback may be used by the WTRU to perform prioritization between the transmission of the message and the transmission/reception of another message.

The priority associated with the feedback may be determined based on one or any combination of the following factors: fixed, configured (e.g., preconfigured), content of the feedback, the QoS of the positioning service, and/or QoS associated with the positioning request message. The priority determined from configured (e.g., preconfigured) may include, for example, that the WTRU may be configured (e.g., preconfigured) a priority value associated with the feedback of the sidelink positioning request.

The content of the feedback may include, for example, that the WTRU may be configured (e.g., preconfigured) with two priorities. A first priority may be associated with ACK feedback (e.g., the ACK feedback may be used to indicate the WTRU may participate in the positioning and/or to indicate the WTRU has received SL-PRS). A second priority may be associated with NACK feedback (e.g., the NACK feedback may be used to indicate the WTRU may not participate in the positioning and/or to indicate the WTRU has not received SL-PRS and/or the RSRP of the received SL-PRS is smaller than a threshold). The WTRU may determine priority of associated with the feedback based on the content of the feedback. The QoS associated with the positioning request message may include, for example, that the priority of the feedback may be associated with the priority of the positioning request. The priority of the positioning request may be indicated in the SCI of the request message.

The WTRU may determine the priority associated with the reception of a feedback message. The WTRU may perform SL-PRS transmission. The WTRU may then expect to receive a feedback (e.g., measurement report which may include RSRP of SL-PRS, and/or LOS/NLOS indicator) from the receiving WTRU (Rx WTRU). The WTRU may determine the priority associated with the reception of the feedback. The WTRU may use the priority associated with the receiving feedback to perform prioritization between the transmission of a message and the reception of the feedback if the transmission and reception occur at the same time.

The priority of the expected feedback may be determined based on one or any combination of the following factors: a predefined value (e.g., 1), configured (e.g., preconfigured) the QoS of the positioning service, and/or QoS associated with the positioning request message. Priority of the expected feedback determined by fixed may include, for example, that the expected feedback may have the highest priority. The WTRU may prioritize reception of the expected feedback.

Upon reception of a positioning request message, the WTRU (e.g., A-WTRU) may determine the type of the positioning request, which may be included in the positioning request message. The WTRU may then perform the associated request if the WTRU determines to participate in the positioning procedure.

A WTRU (e.g., an A-WTRU) may receive a request from a T-WTRU (e.g., a request to transmit ACK/NACK to feedback the request, transmit SL-PRS, receive SL-PRS, and/or transmit sidelink measurement report). In examples, the WTRU may determine whether to perform the associated request (e.g., the WTRU may determine whether to transmit feedback (e.g., ACK/NACK) to the request, transmit SL-PRS, receive SL-PRS, and/or transmit sidelink measurement report) if the ID associated with the request message (e.g., L2 ID) belongs to the positioning service to which the WTRU subscribed. This approach may ensure that the WTRU responds (e.g., only responds) to authorized WTRUs. The WTRU may then determine whether to perform the associated request based on one or any combination of the following.

The WTRU may determine whether to perform the associated request based on a type of positioning request. For example, based on the capacity of the WTRU and/or type of positioning request, the WTRU may determine whether to perform the associated request. For example, the WTRU may perform the SL-PRS transmission request. However, the WTRU may not perform the SL-PRS reception and measurement reporting request.

The WTRU may determine whether to perform the associated request based on a distance to another node (e.g., the requesting WTRU and/or gNB). For example, the WTRU may determine to perform the associated request if the distance to the requesting WTRU is smaller than a threshold, and/or the distance to the gNB is larger than a threshold. The threshold may be configured (e.g., preconfigured). The threshold may be based on the QoS of the positioning service (e.g., the range requirement of the positioning service).

The WTRU may determine whether to perform the associated request based on a positioning accuracy of the A-WTRU. For example, the WTRU may perform the associated request if the positioning accuracy of the WTRU is within a threshold; otherwise, the WTRU may not perform the associated request. The threshold may be configured (e.g., preconfigured), which may be based on the QoS of the positioning service (e.g., accuracy requirement of the positioning service).

The WTRU may determine whether to perform the associated request based on a Uu RSRP. For example, the WTRU may determine to whether to perform SL-PRS transmission based on Uu RSRP. Specifically, the WTRU may not perform SL-PRS transmission if Uu RSRP is greater than a threshold; otherwise, the WTRU may perform SL-PRS transmission. The Uu RSRP threshold may be configured (e.g., preconfigured). The Uu RSRP threshold may be indicated in SIB of the cell. This approach may be motivated to restrict the WTRU being close to gNB to perform SL-PRS transmission.

The WTRU may determine whether to perform the associated request based on a SL-RSRP in the sidelink channel with the requesting WTRU. For example, the WTRU may determine to perform the associated request if the SL-RSRP is larger than a threshold. If the SL-RSRP is less than or equal to the threshold, the WTRU may not perform the associated request. The threshold may be configured (e.g., preconfigured) per resource pool, positioning request type, and/or QoS of the positioning service.

The WTRU may determine whether to perform the associated request based on an AoA and/or an AoD of the transmission from and/or to the requesting WTRU. For example, the WTRU may determine to perform the associated request if the AoA of the positioning request is within a range. If the AOA of the positioning request is outside of the range, the WTRU may not perform the associated request. The range may be configured (e.g., preconfigured) per resource pool, positioning request type, and/or QoS of the positioning service.

The WTRU may determine whether to perform the associated request based on a LOS/NLOS parameter. For example, the WTRU may determine to perform the associated request if the LOS/NLOS value of the channel between the requesting WTRU and the A-WTRU is larger than a threshold. If the LOS/NLOS value of the channel between the requesting WTRU and the A-WTRU is less than or equal to the threshold, the WTRU may not perform the associated request. The threshold may be configured (e.g., preconfigured) based on the resource pool, positioning request type, and/or QoS of the positioning service.

The WTRU may determine whether to perform the associated request based on a synchronization offset and/or error, the type of synchronization source, and/or the priority of the synchronization source. For example, the WTRU may determine to perform the associated request if the synchronization offset and/or error of the WTRU is smaller than a threshold; otherwise, the WTRU may not perform the associated request. The threshold may be configured (e.g., preconfigured), and based on the resource pool, positioning request type, and/or QoS requirement of the positioning service. For example, the WTRU may perform the associated request if the WTRU is synchronized to the requesting WTRU; otherwise, the WTRU may not perform the associated request.

The WTRU may determine whether to perform the associated request based on a coverage status of the A-WTRU and/or the requesting WTRU. In examples, the A-WTRU may perform the associated request if the A-WTRU is in the network coverage. In examples, the A-WTRU may perform the associated request if the T-WTRU is in the network coverage. In examples, the A-WTRU may perform the associated request if both the A-WTRU and the T-WTRU are in the network coverage.

The WTRU may determine whether to perform the associated request based on a cell ID of the WTRU and/or the requesting WTRU. For example, the WTRU may perform the associated request if the WTRU is in coverage of the same cell ID with the requesting WTRU; otherwise, the WTRU may not perform the associated request.

The WTRU may determine whether to perform the associated request based on a zone ID of the WTRU. For example, the WTRU may perform the associated request if its zone ID is within a set of zones. The WTRU may determine whether the zone ID is within the set of zones. For example, the network may configure (e.g., preconfigured) a set of zone IDs to feedback the positioning request. The set of zone IDs may be determined based on the zone ID of the requesting WTRU. Requesting WTRUs in certain set of zone IDs to perform the associated request may help to limit the number of responding WTRUs. The WTRU may o perform the associated request if its zone ID is within a set of zones. If the WTRU's zone ID is not within the set of zone IDs, the WTRU may not perform the associated request. The use of a set of zone IDs may reduce the number of responding WTRU for a positioning service.

The WTRU may determine whether to perform the associated request based on a positioning method. For example, based on the WTRU's capability, the WTRU may perform the associated request for timing-based positioning. Additionally or alternatively, the WTRU may not perform the associated request for carrier-phase based positioning, and/or angle-based positioning.

The WTRU may determine whether to perform the associated request based on one or more positioning measurement parameters. For example, based on the WTRU's capability, the WTRU may perform the associated request if the measurement parameters are related to timing measurement (e.g., RSTD and/or ToA). If the measurement parameters are related to phase and/or angle (e.g., DPoA, PoA and/or AoA), the WTRU may not perform the associated request.

The WTRU may determine whether to perform the associated request based on a QoS of the positioning request message and/or service. For example, the WTRU may perform the associated request if the QoS requirement of the positioning service (e.g., accuracy requirement) is smaller than a threshold; otherwise, the WTRU may not perform the associated request.

The WTRU may determine whether to perform the associated request based on an output of the positioning procedure. For example, the WTRU may perform the associated request if the output of the positioning procedure is relative positioning. In this example, if the output of the positioning procedure is absolute positioning, the WTRU may not perform the associated request.

In examples, a WTRU (e.g., T-WTRU) may determine one or multiple transmission parameters for a positioning request message (e.g., the message to request A-WTRU to perform SL-PRS transmission, SL-PRS reception, and/or sidelink measurement reporting). The transmission parameters of a positioning request message may include one or any combination of the following factors as described below.

The transmission parameters of a positioning request message may include the resource pool used for the positioning request message. For example, the WTRU may be configured (e.g., preconfigured) with a dedicated resource pool to transmit positioning request message. The T-WTRU may then perform resource selection or request transmission resource for a positioning request message in the dedicated resource pool. The A-WTRU may then monitor in the dedicated resource pool to determine whether to perform associated request in a positioning message.

The transmission parameters of a positioning request message may include a priority of the positioning request message. For example, the WTRU may be configured (e.g., preconfigured) with a fixed priority (e.g., highest priority) for positioning request message. For example, the WTRU may determine the priority of the positioning request message based on the QoS of the positioning service (e.g., accuracy and latency requirement). For example, the WTRU may assign a higher priority for the positioning request message for low latency requirement positioning service; otherwise, the WTRU may assign a lower priority for positioning request message.

The transmission parameters of a positioning request message may include a transmission power. The WTRU may determine the transmission power of the request message based on one or more of a type of positioning request and/or a QoS of the positioning service. For example, the WTRU may determine the transmission power of the positioning request message based on the range requirement of the positioning service. Specifically, the WTRU may be configured (e.g., preconfigured) with one or more maximum transmission power levels, which may be the function of the range requirement of the positioning service. The WTRU may then determine the transmission power of the positioning request message based on the associated range requirement.

The transmission parameters of a positioning request message may include a number of retransmissions for each request. The WTRU may be configured (e.g., preconfigured) with the maximum number of retransmissions for a request message, which may be a function of QoS of the positioning service. The WTRU may then determine the number of retransmissions for each request message which is smaller than the configured value.

The transmission parameters of a positioning request message may include time and frequency resource(s) used for the request transmission(s). In examples, the WTRU may be configured (e.g., preconfigured) with a dedicated resource pool to perform positioning request transmission. The WTRU may then trigger resource selection to perform positioning request transmission.

The transmission parameters of a positioning request message may include a number of positioning request transmissions/messages within a period. In examples, the WTRU may be configured (e.g., preconfigured) with the maximum number of positioning request transmissions and/or messages in a period. If the number of positioning request transmissions within a period is smaller than a threshold, the WTRU may perform the positioning request transmission. If the number of positioning request transmission is larger than the threshold, the WTRU may drop the transmission. In examples, the WTRU may be configured (e.g., preconfigured) with a validity time of a request message. After sending the request message, the WTRU may be not allowed to transmit another position request message within the validity time. The WTRU may then perform transmission of another positioning request message after the validity time of the previous request message.

In examples, a WTRU (e.g., T-WTRU) may determine whether to perform a retransmission of a positioning request TB, potentially in a reserved resource from the previous transmission, based on the number ACK feedbacks from A-WTRUs. Specifically, the WTRU may be configured (e.g., preconfigured) with the minimum number of ACK responding A-WTRUs. The WTRU may monitor the feedback from A-WTRUs by monitoring the PSFCH resource(s) associated with the PSCCH and/or PSSCH channel used positioning request transmission. The WTRU may perform further retransmission of a positioning request message if the number of ACK feedbacks from A-WTRUs is smaller than the configured (e.g., preconfigured) threshold. If the number of ACK feedbacks from A-WTRUs is not smaller than the configured (e.g., preconfigured) threshold, then the WTRU may stop perform positioning request retransmission. The WTRU may then discard the reserved retransmission resource for sidelink positioning (e.g., autonomous sidelink positioning) request transmissions.

In examples, a WTRU (e.g., T-WTRU) may perform positioning request message. The WTRU may then reserve and/or indicate SL-PRS resource(s) (e.g., in SCI) for potential SL-PRS transmission(s). The WTRU may perform SL-PRS transmission in the reserved resource if the WTRU receives ACK feedback from one or multiple A-WTRUs within a period (e.g., before the reserved SL-PRS resource). If the WTRU does not receive ACK feedback from one or multiple A-WTRUs within a period (e.g., before the reserved SL-PRS resource) then the WTRU may discard the reserved SL-PRS resource(s). This approach may be motivated to reduce the resource wastage due to not having an A-WTRU to support determining the position of the WTRU.

In examples, the WTRU may then reserve/indicate SL-PRS resource(s) (e.g., in SCI) for potential SL-PRS transmission(s) from A-WTRU(s). The WTRU may perform SL-PRS reception in the reserved resource if the WTRU receives ACK feedback from one or multiple A-WTRUs within a period (e.g., before the reserved SL-PRS resource). If the WTRU does not receive ACK feedback from one or multiple A-WTRUs within a period (e.g., before the reserved SL-PRS resource), the WTRU may discard the reserved SL-PRS resource(s). The WTRU may broadcast a message, which may indicate the release of the reserved resource(s).

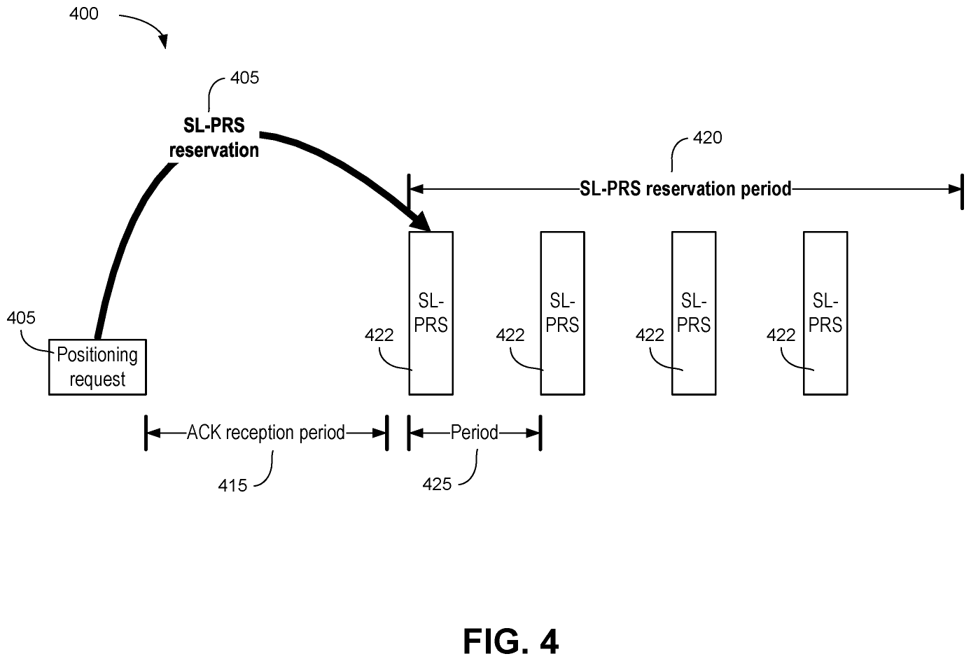

FIG. 4 depicts an example process 400 for a WTRU to reserve periodic SL-PRS resources 410 and determine whether to perform SL-PRS transmission 420. For example, as shown in FIG. 4, the WTRU may perform SL-PRS reservation in the same positioning request message 405. The process 400 may be a positioning process that comprises an ACK reception period 415 followed by an SL-PRS reservation period 420. The WTRU may determine whether to perform SL-PRS transmission 420 in the reserved resources 410 in the SL-PRS reservation period 420 based on the availability of ACK feedback in the ACK reception period 415. Specifically, if the WTRU does not receive any ACK feedback in the ACK reception period 415, the WTRU may discard the reserved SL-PRS resources 410; otherwise, if the WTRU receive one or more ACK feedback in the ACK reception period 415, the WTRU may perform one or more SL-PRS transmissions 420 in one or more of the reserved SL-PRS resources 410. Each of the one or more SL-PRS transmissions 420 may be associated with a period 425. For example, the SL-PRS transmissions 420 may be periodic.

A WTRU (e.g., T-WTRU) may indicate the value(s), range, the maximum, and/or the minimum of one or more parameters to the A-WTRUs. The A-WTRU may then determine to perform the associated request if the measured and/or calculated value(s) and/or range(s) of one or more parameters is within a range.

The indicated parameters may include one or more of a distance to another node (e.g., the requesting WTRU, gNB), a positioning accuracy of the A-WTRU, a Uu RSRP, a SL-RSRP, and/or an AoA or AoD of the transmission from/to the requesting WTRU, a LOS/NLOS, a synchronization offset, a set of zone IDs to respond, a range of one or more reported positioning measurement parameters, a priority of the positioning request, a time window of SL-PRS transmission and/or reception, a time window of sidelink measurement reporting, one or any combination of the SL-PRS transmission(s) parameters, one or any combination of the information to support A-WTRU in performing SL-PRS reception(s), and/or one or any combination of the SL-PRS measurement reporting parameters.

The values and/or ranges of the one or more of the indicated parameters may be determined based on one or more of QoS of the positioning service, a positioning method, a type of positioning request, a number of responding A-WTRUs from the last positioning request message, a zone ID of the WTRU, and/or a CBR of the resource pool.

In examples, a WTRU (e.g., T-WTRU) may perform transmissions of one or multiple positioning request message (e.g., the message to request A-WTRU to perform SL-PRS transmission, SL-PRS reception, and/or sidelink measurement reporting). The WTRU may then monitor the feedback from the potential A-WTRUs. Based on the feedback(s) from zero or more potential A-WTRU(s), the WTRU (e.g., T-WTRU) may adjust the range of one or more parameters associated with the request message and/or adjust one or more transmission parameters of the positioning request message.

For example, if the number of responding A-WTRUs (e.g., the one A-WTRU sending ACK feedback) is smaller than a threshold (e.g., three A-WTRUs), the T-WTRU may adjust one or more range of parameters indicated in the positioning request message. Specifically, the T-WTRU may perform one or any combination of the following.

If the number of responding A-WTRUs is smaller than a threshold, the WTRU may extend the range of distance. The WTRU (e.g., T-WTRU) may increase the maximum distance and/or decrease the minimum distance. The A-WTRU within the indicated range of distance may respond to the associated request. By extending the range of distance, the T-WTRU may then receive more responses from the A-WTRUs to support the T-WTRU in determining its location.

If the number of responding A-WTRUs is smaller than a threshold, the WTRU may extend the range of positioning error. The WTRU may increase the maximum positioning error of the A-WTRU. The A-WTRU having the position error being smaller than the indicated maximum value may respond to the associated request. By increasing the maximum positioning error, the T-WTRU may then receive more responses from the A-WTRUs to support the T-WTRU in determining its location.

If the number of responding A-WTRUs is smaller than a threshold, the WTRU may extend the range of Uu RSRP. The T-WTRU may decrease the minimum Uu RSRP and/or increase the maximum Uu RSRP to indicate to the A-WTRU. The A-WTRUs having Uu RSRP being within the indicated range may respond to the associated request.

If the number of responding A-WTRUs is smaller than a threshold, the WTRU may extend the range of SL-RSRP in the sidelink channel of with the requesting WTRU. The T-WTRU may decrease the minimum SL-RSRP and/or increase the maximum SL-RSRP to indicate to the A-WTRU. The A-WTRUs having SL-RSRP between itself and the requesting WTRU (e.g., T-WTRU) being within the indicated range may respond to the associated request.

If the number of responding A-WTRUs is smaller than a threshold, the WTRU may extend the range of AoA or AoD with the requesting WTRU. The T-WTRU may decrease the minimum AoA and/or AoD and/or increase the maximum AoA and/or AoD to indicate to the A-WTRU. The A-WTRUs having AoA and/or AoD to the requesting WTRU (e.g., T-WTRU) being within the indicated range may respond to the associated request.

If the number of responding A-WTRUs is smaller than a threshold, the WTRU may extend the range of LOS/NLOS. The T-WTRU may decrease the minimum LOS/NLOS parameter to indicate to the A-WTRU. The A-WTRUs having LOS/NLOS parameter in the channel between itself and the requesting WTRU (e.g., T-WTRU) being greater than the indicated value may respond to the associated request.

For example, if the number of responding A-WTRUs (e.g., the one A-WTRU sending ACK feedback) is smaller than a threshold (e.g., three A-WTRUs), the T-WTRU may adjust one or more range of parameters indicated in the positioning request message. Specifically, the WTRU may perform one or any combination of the following actions as described below.

If the number of responding A-WTRUs is smaller than a threshold, the WTRU may reduce the range of distance. The WTRU (e.g., T-WTRU) may reduce the maximum distance and/or increase the minimum distance. The A-WTRU within the indicated range of distance may respond to the associated request. By reducing the range of distance, the T-WTRU may then receive less responses from the A-WTRUs to support the T-WTRU in determining its location.

If the number of responding A-WTRUs is smaller than a threshold, the WTRU may reduce the range of positioning error. The WTRU (e.g., T-WTRU) may decrease the maximum positioning error of the A-WTRU. The A-WTRU having the position error being smaller than the indicated maximum value may respond to the associated request. By reducing the maximum positioning error, the T-WTRU may then receive fewer responses from the A-WTRUs to support the T-WTRU in determining its location.

If the number of responding A-WTRUs is smaller than a threshold, the WTRU (e.g., T-WTRU) may reduce the range of Uu RSRP. The T-WTRU may increase the minimum Uu RSRP and/or decrease the maximum Uu RSRP to indicate to the A-WTRU. The A-WTRUs having Uu RSRP being within the indicated range may respond to the associated request.

If the number of responding A-WTRUs is smaller than a threshold, the WTRU (e.g., T-WTRU) may reduce the range of SL-RSRP in the sidelink channel of with the requesting WTRU. The T-WTRU may increase the minimum SL-RSRP and/or decrease the maximum SL-RSRP to indicate to the A-WTRU. The A-WTRUs having SL-RSRP between itself and the requesting WTRU (e.g., T-WTRU) being within the indicated range may respond to the associated request.

If the number of responding A-WTRUs is smaller than a threshold, the WTRU (e.g., T-WTRU) may reduce the range of AoA and/or AoD with the requesting WTRU. The T-WTRU may increase the minimum AoA and/or AoD and/or decrease the maximum AoA and/or AoD to indicate to the A-WTRU. The A-WTRUs having AoA and/or AoD to the requesting WTRU (e.g., T-WTRU) being within the indicated range may respond to the associated request.

If the number of responding A-WTRUs is smaller than a threshold, the WTRU (e.g., T-WTRU) may reduce the range of LOS/NLOS. The T-WTRU may increase the minimum LOS/NLOS parameter to indicate to the A-WTRU. The A-WTRUs, having LOS/NLOS parameter in the channel between itself and the requesting WTRU (e.g., T-WTRU) being greater than the indicated value, may respond to the associated request.

The T-WTRU may request the potential A-WTRU to feedback its positioning request message if the A-WTRU participates in the sidelink positioning (e.g., autonomous sidelink positioning) to support the T-WTRU in determining its position. The WTRU (e.g., T-WTRU) may then determine whether to adjust the transmission parameters of the positioning request message based on the number of A-WTRUs responding to the request. Specifically, if the number of responding A-WTRUs is smaller than a threshold (e.g., three A-WTRUs), the T-WTRU may increase its transmission power and/or the number of retransmissions for a positioning request message. Additionally or alternatively, if the number of responding WTRU is greater than another threshold (e.g., five A-WTRUs), the (e.g., T-WTRU) may reduce its transmission power and/or reduce the number of retransmissions for a positioning request message.

For example, the WTRU (e.g., T-WTRU) may transmit the positioning request messages, in which the T-WTRU may request potential A-WTRUs to perform ACK/NACK feedback. The T-WTRU may adjust the transmission parameters of the positioning request message(s) if the number of ACKs is outside of a range of thresholds. If the number of ACKs feedback is within the range of thresholds, the WTRU may not adjust the transmission parameters of the positioning request message.

For example, the WTRU (e.g., T-WTRU) may increase the transmission power and/or the number of retransmissions for a positioning request message if the number of the received ACK is smaller than a threshold. The T-WTRU may decrease the transmission power and/or decrease the number of retransmissions for the positioning request message if the number of the received ACK is larger than another threshold.

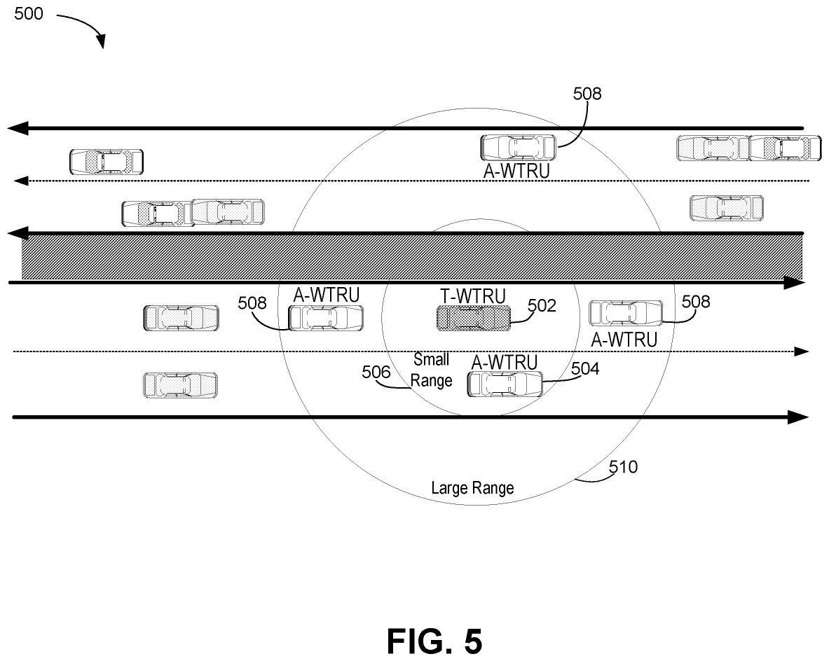

FIG. 5 depicts an example process 500 for a WTRU 502 to adjust a range requirement for acknowledgment (ACK) feedback. As shown in FIG. 5, the WTRU 502 (e.g., the T-WTRU) may at first perform positioning request with a small range requirement 506. The WTRU 502 may receive the ACK feedback from one of the A-WTRUs (e.g., the closest A-WTRU 504 shown in FIG. 5). However, the positioning procedure (e.g., autonomous positioning procedure) requires the feedback from more A-WTRUs (e.g., the A-WTRUs 508 outside the small range requirement 506 but within the large range requirement 510). The T-WTRU 502 may adjust the range requirement (e.g., from the small range requirement 506 to the large range requirement 510). The T-WTRU 502 may receive the feedback from two or more A-WTRUs 504, 508 to perform the positioning procedure.

A WTRU (e.g., A-WTRU) may trigger resource allocation (e.g. for Mode 2 resource allocation) or request resource (e.g. for Mode 1 resource allocation) for SL-PRS transmission(s) (e.g. the WTRU may trigger resource selection for its SL-PRS transmission or for other WTRU to perform SL-PRS transmission) positioning based on one or any combination of the following.

The WTRU may trigger resource allocation for SL-PRS transmission(s) positioning based on an SL-PRS transmission from other WTRU (e.g., T-WTRU). For example, the WTRU may be requested to perform both SL-PRS transmission and reception. The WTRU may perform resource selection for its SL-PRS transmission based on its reception of SL-PRS (e.g., successful reception and successful measurement) from T-WTRU.

The WTRU may trigger resource allocation for SL-PRS transmission(s) positioning based on a NACK feedback from another WTRU. For example, the WTRU may perform feedback (e.g. ACK/NACK) enabled SL-PRS transmission. The WTRU may perform resource selection for SL-PRS if the WTRU receives feedback (e.g. NACK feedback) from the receiving WTRU, which may implicitly and/or explicitly request more SL-PRS resources for transmission.

The WTRU may trigger resource allocation for SL-PRS transmission(s) positioning based on detection of a collision with one or more other transmissions. For example, the WTRU may perform periodic SL-PRS transmission. The WTRU may detect collision of its SL-PRS transmission with other sidelink transmission. The collision may be indicated from another WTRU (e.g., T-WTRU) via inter WTRU coordination message (e.g., IUC message) or the collision may be detected by the WTRU.

The WTRU may trigger resource allocation for SL-PRS transmission(s) positioning based on a duration of periodic SL-PRS reservation expires. For example, the WTRU may trigger resource selection for SL-PRS transmission if the duration of periodic SL-PRS reservation expires.

The WTRU may trigger resource allocation for SL-PRS transmission(s) positioning based on a number of NACK feedbacks from the receiving WTRUs being greater than a threshold. For example, the WTRU may trigger resource reselection for SL-PRS transmission if the number of NACK feedbacks from the receiving WTRUs being greater than a threshold. The threshold may be configured (e.g., preconfigured), which may be based on the QoS of the positioning service.

The WTRU may trigger resource allocation for SL-PRS transmission(s) positioning based on whether a received SL-PRS resources may not be enough to derive an accurate SL-PRS measurement. For example, the WTRU may be configured (e.g., preconfigured) to measure one or more N SL-PRS resources (e.g., which have RSRP being greater than a threshold). The WTRU may trigger resource allocation for SL-PRS transmission if the received SL-PRS resource are not enough for SL-PRS measurement. For SL-PRS transmission of another WTRU, the WTRU may determine whether to trigger further resource selection for another WTRU by itself based on the number of successfully received SL-PRS resources within a period. For SL-PRS transmission by itself, the WTRU may receive indication from another WTRU to determine whether to trigger resource allocation.

The WTRU may trigger resource allocation for SL-PRS transmission(s) positioning based whether on one or more SL-PRS resources are deprioritized. For example, the WTRU may be scheduled a periodic SL-PRS transmission/reception. The WTRU may determine whether to trigger resource selection or trigger requesting SL-PRS resource(s) for the WTRU or another WTRU based on whether one or more SL-PRS resources (e.g., in the periodic SL-PRS resources) are deprioritized. Specifically, the WTRU may trigger resource allocation and/or requesting SL-PRS resource if the number of deprioritized SL-PRS resources (e.g., within a window) is greater than a threshold. The threshold may be configured by the network, which may be associated with the periodic SL-PRS transmission/reception and/or the QoS of the sidelink positioning service.

The WTRU may use one or any combination of the following parameters in the resource allocation procedure: a resource allocation resource pool, a priority of the SL-PRS transmission(s), a latency of the SL-PRS transmission(s), a remaining packet delay budget (PDB) of the SL-PRS transmission(s), a number of subchannels to be used for the SL-PRS transmission(s), a periodicity of SL-PRS transmission(s), a window of resource allocation (e.g., [n+T1, n+T2]). One or any combination of these parameters for resource allocation may be determined based on one or any combination of the following.

One or more parameters for resource allocation may be determined based on a fixed priority. For example, the WTRU may use a fixed priority for SL-PRS transmission (e.g., the highest priority). One or more parameters for resource allocation may be determined based on a configured (e.g., preconfigured) resource pool. For example, the WTRU may be configured (e.g., preconfigured) with one resource pool for SL-PRS transmission. The WTRU may then perform resource allocation for SL-PRS transmission in the configured (e.g., preconfigured) resource pool. For example, the WTRU may be configured (e.g., preconfigured) with a priority for SL-PRS transmission. The WTRU may indicate the priority of SL-PRS in an associated transmission (e.g. an associated SCI).

One or more parameters for resource allocation may be determined based on a QoS of the positioning service. For example, the WTRU may determine the priority, latency, and/or the remaining PDB for resource allocation for SL-PRS transmission based on the QoS of the positioning service (e.g., accuracy and/or latency). Specifically, the WTRU may use the priority for resource allocation for SL-PRS transmission based on the accuracy requirement of the positioning service. The WTRU may then determine the remaining PDB for resource allocation for SL-PRS transmission based on latency requirement of the positioning service.

One or more parameters for resource allocation may be determined based on an indication from another WTRU. For example, the WTRU (e.g., A-WTRU) may be indicated from another WTRU (e.g., T-WTRU) the priority, latency, resource selection window, and/or the periodicity of the positioning measurement reporting for the WTRU. The WTRU may then perform resource selection and reservation using one or any combination of these parameters.

In examples, a WTRU (e.g., T-WTRU) may determine to perform multiple (e.g., two) stage positioning. Specifically, the WTRU may perform the first positioning method when the positioning accuracy of the WTRU (e.g., T-WTRU) is within the first range (e.g., larger than a threshold). The WTRU may then perform the second positioning method, when the accuracy of the positioning of the WTRU is within the second range (e.g., smaller than the threshold in the first stage).

In examples, the WTRU (e.g., T-WTRU) may determine to perform timing-based positioning (e.g., TDOA), in the first period, when the WTRU has rough positioning information or no positioning information. After obtaining its positioning information, which may have accuracy being greater than a threshold (e.g., higher accuracy), the WTRU may trigger the carrier-phase based positioning method in the second period to obtain greater positioning accuracy. In each positioning method and associated period, the WTRU may determine the SL-PRS transmission(s) parameter(s) based on the positioning method and the required time to obtain a certain positioning accuracy.

In examples, a WTRU (e.g., T-WTRU) may determine to perform multiple positioning methods simultaneously. The WTRU may determine whether to perform multiple positioning methods simultaneously based on the QoS of the positioning service. In examples, the WTRU may perform both angle-based positioning method and timing-based positioning method. In examples, the WTRU may perform both timing-based positioning method and carrier-phase based positioning method. This approach may be motivated to help the WTRU to obtain more accurate location and reduce the latency. The WTRU may then request the WTRU to perform SL-PRS transmission, reception and/or measurement reporting to both positioning method. In examples, for the timing-based and carrier phase-based positioning methods, the WTRU may request the A-WTRU to perform SL-PRS transmission for both carrier phase measurement and timing-related measurement. The A-WTRU may report both types of parameters in one period (e.g., within a window or in the same message).

In examples, a WTRU may initialize group PC5-RRC to establish PC5 connection among WTRUs in the group to exchange the configuration of SL-PRS transmission, SL-PRS reception, and/or measurement report. The group of WTRU may include two (e.g. one T-WTRU and one A-WTRU) or more WTRUs (e.g. one T-WTRU and multiple A-WTRU). The group of A-WTRU may include one or more A-WTRUs.

Upon establishment of a group PC5-RRC, a WTRU (e.g., T-WTRU) may perform one or any combination of the following to determine and/or obtain the SL-PRS resources for a group: request the SL-PRS transmission resources for the group of WTRUs and/or perform resource selection for the group of WTRU. The SL-PRS transmission resources for the group of WTRUs may include one or any combination of the following parameters.

The SL-PRS resource for one WTRU, which may include one or any combination of the following. The SL-PRS resource for one WTRU may include one or more parameters of one SL-PRS resource for one WTRU. The one or more parameters of one SL-PRS resource for one WTRU, which may include one or more of a QoS associated with the SL-PRS resource, a transmission power, a number of subchannels used for each SL-PRS resource, a number of symbols and/or slots used for each SL-PRS transmission resource, a reference resource pattern (e.g., comb size and/or comb pattern), a sequence ID, a cyclic shift, and/or a time/frequency resource(s) of SL-PRS transmission(s).

The SL-PRS resource for one WTRU may include a number of SL-PRS resource repetitions and/or retransmissions in one period. The SL-PRS resource for one WTRU may include a type of SL-PRS transmission. For example, the type of SL-PRS transmission may include whether the SL-PRS transmission resource for the group is periodic or aperiodic. For example, the WTRU may be configured (e.g., preconfigured) with two types of SL-PRS transmission. In the first type, SL-PRS may be transmitted dynamically. In the second type, SL-PRS may be transmitted periodically. The SL-PRS resource for one WTRU may include a periodicity of a SL-PRS process. The SL-PRS resource for one WTRU may include a number of periods for one SL-PRS process, sidelink positioning session, and/or the window. The SL-PRS resource for one WTRU may include a HARQ type of the SL-PRS transmission.

The SL-PRS transmission resources for the group of WTRUs may include a set of SL-PRS configurations to use for SL-PRS transmission/reception.

The SL-PRS transmission resources for the group of WTRUs may include a number of WTRUs sharing the group resource. The SL-PRS transmission resources for the group of WTRUs may include a multiplexing type or order, which may determine which resource in the group of resources may be used first. For example, the group SL-PRS resource may be multiplexed using CDM, FDM, and/or TDM.

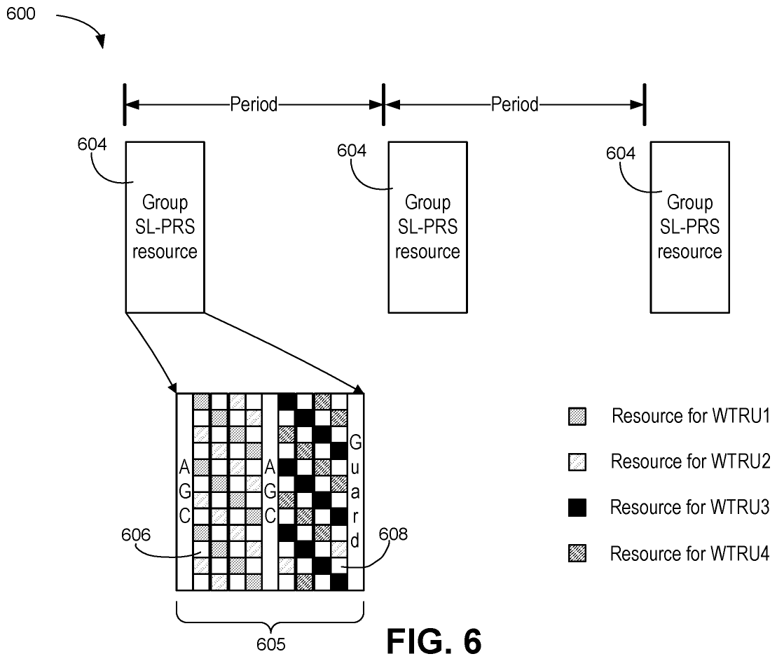

FIG. 6 depicts a SL-PRS 600 for a group of WTRUs. As shown in FIG. 6, in one group of SL-PRS resources 604, the group may use the comb pattern 605, in which the resource is FDM first. The comb pattern 605 may include the number of symbols for PRS (e.g., SL-PRS), the RE-offset, and the periodicity of RE comprising PRS in each symbol of PRS. For example, for WTRU1, the PRS spans over 4 symbols, the RE-offset is 0, 1, 2, 3 for symbol 0, 1, 2, and 3, respectively, and the periodicity of RE containing PRS is 4 (e.g., 1 RE containing PRS out of every 4 REs). The resource is TDM thereafter. The maximum FDM resources is two. Then WTRU1 and WTRU2 may use the first in time resource 606, and WTRU3 and WTRU4 may use the second in time resource 608.

The WTRU may then select and/or request one of the group SL-PRS resources 604 for a group of WTRUs. The WTRU may then determine one or more parameters for the group SL-PRS resources based on one or more of configured (e.g., preconfigured) parameter(s) in the resource pool, an indication from another node, a QoS requirement of the positioning service, a distance to the receiving WTRU and/or requesting WTRU, a sidelink channel to the receiving WTRU and/or requesting WTRU, a CBR of the resource pool, a positioning accuracy of the WTRU or the positioning accuracy of the associated WTRU, a positioning method, measurement parameter(s) to be measured, an output of the positioning procedure (e.g., an absolute positioning or relative positioning), an amount of SL-PRS transmission within a period, a prohibit time associated with SL-PRS transmission and/or SL-PRS request, parameter(s) used for SL-PRS transmission from the requesting WTRU, a number of WTRUs in the group, and/or a maximum CDM and FDM multiplexing capability. For example, the WTRU may request more SL-PRS resources if the group is larger than a threshold size. If the group is less than or equal to the threshold size, the WTRU may request less SL-PRS resources.

In examples, the WTRU may apply resource randomization to determine its SL-PRS resource. A WTRU (e.g., A-WTRU) upon reception of SL-PRS resource for its group. The WTRU may then determine its SL-PRS resource to use based on one or more of a member WTRU ID in the group, a number of WTRUs in the group, a timing of the group SL-PRS resource, and/or a maximum number of SL-PRS resources in the code, frequency, and/or time domain of the group of SL-PRS resource.

In examples, a WTRU (e.g., T-WTRU) may determine to change the SL-PRS group of resource based on a change in the group size and/or member. For example, the WTRU may reselect/request another group of SL-PRS resource if one or more WTRU join or leave the group.

A WTRU may determine the resources (e.g., the number of resources) for a group of WTRUs. In examples, a WTRU may perform resource allocation for a group of WTRUs. For example, the WTRU may perform resource allocation for SL-PRS transmission resources, SL-PRS reception resources, and/or SL-PRS measurement reporting resources.

A WTRU (e.g., T-WTRU) may perform resource allocation for a group of WTRUs. In examples, the WTRU may use a frequency resource (e.g., a one time-frequency resource) for a group of WTRUs. Each WTRU in the group may perform multiplexing (e.g., in the time-frequency resource) using any suitable multiplexing technique (e.g., CDM). In certain implementations, the WTRU may determine the time-frequency resources (e.g., the number of time-frequency resources) for each type of transmission and/or reception (e.g., resource for SL-PRS transmission, reception, and/or measurement reporting) based on one or more of the number of WTRUs in the group, the multiplexing rules, and/or the number (e.g., the maximum number) of frequency multiplexing resources for a (e.g., one) slot.

A WTRU may determine the multiplexing rules associated with the different WTRUs in the group. In certain implementations, the WTRU may select a resource for a group of WTRUs. The WTRU may determine the multiplexing rules for each WTRU's resource. For example, the WTRU may determine the comb size based on the number of WTRUs multiplexing in a resource (e.g., the same time resource). For example, the WTRU may use comb-2 if the WTRU allows multiple (e.g., two) WTRUs to transmit in a (e.g., one) time resource. Additionally or alternatively, the WTRU may use comb-4 if the WTRU allows four WTRUs transmitting in one timing resource. The WTRU may determine the cyclic shift for each WTRU if, for example, the WTRU allows multiple WTRUs to share a resource (e.g., the timing resource).

A WTRU may determine whether to perform resource allocation for a group of WTRU, for example, based on an output (e.g., a positioning output). One or more of the following may apply: a WTRU (e.g., T-WTRU) may determine whether to perform resource allocation for a group of WTRUs based on the positioning output. In certain implementations, a WTRU may determine to perform resource allocation for a group of WTRUs if the output of positioning is the absolute position of the WTRU. If, for example, the output of the positioning is the relative positioning (e.g., among different WTRUs), the WTRU may not perform resource allocation for a group of WTRUs.

A WTRU may determine the structure of an SL-PRS resource for a WTRU. One or more of the following may apply: a WTRU (e.g., A-WTRU) may determine the structure of the WTRU's SL-PRS resource from a resource for a group of WTRUs, for example, based on the number of WTRUs in the group. For example, the WTRU may determine to use comb-2 for a (e.g., one) SL-PRS resource if there are two A-WTRUs in the group. In examples, the WTRU may use comb-4 for a (e.g., one) SL-PRS resource if there are four A-WTRUs in the group. In examples, the WTRU may use multiple (e.g., 10) symbols for each SL-PRS resource if there are two A-WTRUs in the group. In examples, the WTRU may use multiple (e.g., four) symbols for each SL-PRS resource if there are four A-WTRUs in the group.

A WTRU may be configured to determine a measurement gap for use in the sidelink. In examples, a WTRU (e.g., T-WTRU) may determine to request another WTRU (e.g., A-WTRUs) to pause/terminate transmission of data or control channel/signals to the WTRU while the WTRU measures and processes SL-PRS.

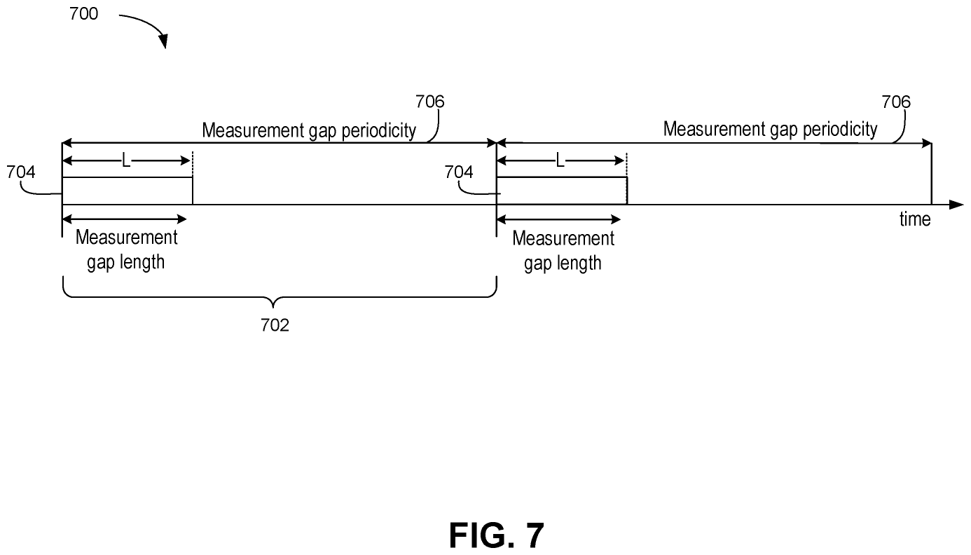

FIG. 7 is a chart 700 illustrating an example measurement gap (MG) 702 pattern and parameters. The WTRU (e.g., T-WTRU) may be configured (e.g., preconfigured) with a list of MGs 704 with an ID associated with each MG configuration and/or pattern (e.g., MG length L and/or MG periodicity 706 indicated in FIG. 7). In these examples, T-WTRU and A-WTRU can be used interchangeably. For example, A-WTRU may send a request to T-WTRU to pause and/or terminate transmission of data. A-WTRU may send a request to T-WTRU to configure a MG 704. During the MG 704, the WTRU may determine to perform measurement of SL-PRS and processing of measurements.

In examples, the T-WTRU may indicate the ID in the list to A-WTRUs or network (e.g., gNB and/or LMF) such that the A-WTRUs do not send data or control signals and/or channels during the measurement gap (e.g., interval indicated by the measurement gap length L in FIG. 7). In examples, the T-WTRU may send a request to the A-WTRUs or network (e.g., LMF and/or gNB) to activate the MG 704. The request may be sent in SCI or MAC-CE. The T-WTRU may receive a MG configuration from the A-WTRU(s) or the network which may be different from the MG the T-WTRU requested. The T-WTRU may determine the MG configuration based on the parameters of SL-PRS (e.g., number of symbols, periodicity and/or repetition factor) configured by A-WTRUs. The T-WTRU may send the request to the A-WTRUs to activate the MG via PC5-RRC, SCI, MAC-CE or LPP (LTE Positioning Protocol) message. The T-WTRU may send the request in PC5-RRC, SCI, MAC-CE and/or LPP message prior to transmission of PRS. The T-WTRU may send a request to A-WTRUs or network (e.g., LMF, gNB) to deactivate the measurement gap. The T-WTRU may include an ID to indicate which measurement gap should be deactivated. The T-WTRU may receive an indication from A-WTRUs or the network that the MG with associated ID is deactivated.

The T-WTRU may send a request for MG in a unicast, groupcast or broadcast. The request may depend on the cast type used for PRS transmission. The MG may be associated with zone ID. For example, once the MG is activated, the WTRUs in the zone may not transmit data and/or control information during the measurement gap to other WTRUs. The WTRU may determine to transmit and/or receive PRS (e.g., only PRS) to and/or from other WTRUs during the measurement gap in the zone that is associated with the MG. The WTRU may be configured (e.g., preconfigured) with measurement gap patterns associated with zone IDs. The WTRU may receive PC5-RRC, SCI, MAC-CE and/or LPP message which indicates activation of one of the MG patterns associated with the zone.

The WTRU may be configured (e.g., preconfigured) with a measurement gap associated with configured (e.g., preconfigured) resource pool(s). The WTRU may receive PC5-RRC, SCI, MAC-CE and/or LPP message which enables MG for configured (e.g., preconfigured) resource pool(s). The WTRU may determine that the MG is activated for one of the configured (e.g., preconfigured) resource pools. In such a case, the WTRU may determine that the MG is activated for one or more (e.g., all) resources that belong to the resource pool.

If the WTRU receives the message from T-WTRU, A-WTRU, and/or or the network which activates the MG, the WTRU may determine to transmit and/or receive PRS in one of the configured (e.g., preconfigured) resources (e.g., subchannels, bandwidth) in the resource pool.

The T-WTRU may determine the MG to request based on the SL PRS resource. The T-WTRU may be configured (e.g., preconfigured) with a list of measurement gap parameters where each set of parameters (e.g., gap length, periodicity) is associated with a SL-PRS resource in the SL-PRS resource pool. Depending on which SL-PRS resource is configured, for example, the T-WTRU may determine which measurement gap to request according to the configured (e.g., preconfigured) list.

The T-WTRU may determine to use the configured (e.g., preconfigured) list depending on the coverage status. For example, if the T-WTRU is in out-of-coverage, the T-WTRU may determine to use the configured (e.g., preconfigured) list. If the T-WTRU is in-coverage status, the T-WTRU may request for the list of MGs and/or request a MG from the network (e.g., LMF and/or gNB).

In examples, the WTRU (e.g., A-WTRU) may indicate activation and/or deactivation of MG using SCI. For example, in the first SCI, the WTRU may send a type of positioning request. The type of positioning request may include a list of MG configurations. The WTRU may use the second SCI to indicate which MG in the list is activated and/or deactivated. In examples, the WTRU may determine to include a list of MGs in either the first or second SCI. The WTRU may include activation and/or deactivation messages in the SCI after the second SCI.

In examples, the T-WTRU may receive both data and SL-PRS if the T-WTRU determines there is no MG configured for the T-WTRU. In examples, the T-WTRU may receive both data and SL-PRS if the T-WTRU and/or the request for MG configuration is not granted by other WTRUs (e.g., A-WTRU) or network. Data and SL-PRS may be multiplexed in the frequency domain or time domain.

In examples, the T-WTRU may determine to prioritize reception of SL-PRS over other channels according to the configured (e.g., preconfigured) priority configuration. For example, if the configured (e.g., preconfigured) priority rule indicates that the SL-PRS has higher priority than data channels, the T-WTRU may determine to receive SL-PRS over data channels (e.g., drop data channels) if SL-PRS and data channels overlap partially or fully in the time domain.

The priority level may be determined by one or more of the following. The priority level may be determined based on a coverage status. For example, in out-of-coverage status, the SL-PRS may have lower priority compared to other channels (e.g., data and/or control channels). On the other hand, during in-coverage status, the SL-PRS may have higher priority compared to other channels.

The priority level may be determined based on a type of SL-PRS. For example, aperiodic, and/or semi-static SL-PRS may have higher priority compared to other channels (e.g., data and/or control channels). Periodic SL-PRS may have lower priority compared to other channels.

The priority level may be determined based on a positioning method. For example, if an RTT based positioning is implemented, the T-WTRU may determine that the SL-PRS have higher priority compared to other channels. If TDOA based positioning is implemented, the T-WTRU may determine that the SL-PRS have lower priority compared to other channels.

The priority level may be determined based on a configuration of SL-PRS. If the T-WTRU receives configuration of SL-PRS dynamically (e.g., via SCI), the T-WTRU may determine that SL-PRS has higher priority compared to other channels. If the T-WTRU receives configuration of SL-PRS semi-statically (e.g., via SL-RRC), the T-WTRU may determine that the SL-PRS has lower priority compared to other channels.

The priority level may be determined based on a configured (e.g., preconfigured) priority level. The T-WTRU may receive configured (e.g., preconfigured) priority level from the network (e.g., gNB and/or LMF), PRU, and/or A-WTRU(s). The T-WTRU may determine priority of SL-PRS compared to other channels according to the list.

The priority level may be determined based on a QoS for positioning service. For example, the accuracy and/or latency requirement of the positioning service may exist above a threshold (e.g., the threshold configured by the A-WTRUs and/or the network). Then the T-WTRU may associate the SL-PRS with a higher priority than data and/or control channels. For example, if the accuracy requirement is 30 cm and the threshold is 1 m, the WTRU may associate the SL-PRS with high priority. In the same example, if the threshold is 5 cm, the WTRU may associate the SL-PRS with low priority.

The priority level may be determined based on a zone ID. For example, the WTRU may determine priority level of SL-PRS according to the zone ID. The WTRU may receive a configuration, (e.g., preconfiguration), associating zone ID and/or priority level of SL-PRS. The WTRU may determine the priority level of SL-PRS based on the zone the WTRU is located. For example, the WTRU may determine that the WTRU is in zone 1 and SL-PRS has higher priority than data or control channels, if the high priority level of SL-PRS is associated with zone 1 in the (pre) configuration. The WTRU may receive (pre) configuration from A-WTRUs and/or the network.

The priority level may be determined based on a CBR. For example, the WTRU may determine the priority level of SL-PRS based on the CBR of the resource pool. If the CBR is above or equal to the configured (e.g., preconfigured) threshold, the WTRU may determine that the SL-PRS is associated with low priority. If the CBR is below the configured (e.g., preconfigured) threshold, the WTRU may determine that the SL-PRS is associated with higher priority compared to other SL-PRS data or control channels.

In examples, the WTRU (e.g., A-WTRU) may indicate prioritization rules (e.g., SL-PRS having higher priority than data) using SCI. For example, in the first SCI, the WTRU may send a type of positioning request which may include prioritization rules. The WTRU may use the second SCI to indicate which prioritization rules is activated. For example, there could be three rules, with SL-PRS having the highest priority, lowest priority, or higher priority compared to other channels (e.g., data that does not contain (ultra-reliable and low latency communications) URLLC data). The T-WTRU may determine the priority level associated with SL-PRS from the second SCI transmitted by A-WTRU.

In examples, the A-WTRU may determine to include a list of prioritization rules in either the first or second SCI. In examples, the A-WTRU may determine to include activation and/or deactivation messages for one of the prioritization rules in the SCI after the second SCI.

The T-WTRU may determine the prioritization rule associated with SL-PRS from PC5-RRC, SCI, MAC-CE, and/or LPP message. The T-WTRU may determine whether the prioritization rule and/or MG is configured from PC5-RRC, SCI, MAC-CE and/or LPP message.

In examples, if the T-WTRU is not configured with any prioritization rules, MG, does not receive any configuration (e.g., preconfiguration) that indicate the priority level of SL-PRS from other WTRUs (e.g., A-WTRUs) and/or network, then the T-WTRU may determine that the SL-PRS is associated with the lowest priority. If the SL-PRS is associated with the lowest priority, and the SL-PRS overlaps partially and/or fully in the time domain with other channels (e.g., data and/or control SL channels), the T-WTRU may determine to drop the overlapped SL-PRS.

In examples, the WTRU may determine the receiver of the sidelink measurement report. The WTRU may send its measurement reporting to one or more nodes. For example, the WTRU may send its measurement reporting to the network (e.g., gNB and/or LMF). For example, for WTRU assisted positioning method (WTRU-A), the WTRU may determine to report the positioning measurement information to the network (e.g., gNB and/or LMF). For example, the WTRU may determine whether to report positioning measurement information to the network based on whether the output of the positioning procedure is absolute or relative positioning. Specifically, the WTRU may report the positioning measurement to the network if the output of the positioning procedure is absolute positioning. If the output of the positioning procedure is relative positioning, the WTRU may not report the positioning measurement to the network.

The WTRU may send its measurement reporting to a RSU and/or a PRU.

The WTRU may send its measurement reporting to the WTRU performing positioning request transmission. For example, the A-WTRU may report the positioning measurement to requesting WTRU (e.g., T-WTRU).

The WTRU may send its measurement reporting to the WTRU within the group under network coverage. For example, a WTRU (e.g., A-WTRU and/or T-WTRU) may determine to report the positioning measurement to one WTRU within the network coverage. In one approach, the WTRU within the network coverage may be either A-WTRU or T-WTRU. Additionally or alternatively, the WTRU within the network coverage may be another WTRU which may not participate in the SL-PRS transmission/reception. The WTRU within the network coverage may then relay the positioning report to the network (e.g., gNB, and/or LMF). The WTRU within the network coverage may then relay the feedback from the network (e.g., positioning of the WTRU) to the WTRU (e.g., A-WTRU and/or T-WTRU).

The WTRU may send its measurement reporting to a WTRU to network (U2N) and/or a WTRU to WTRU (U2U) relay. For example, the WTRU (e.g., T-WTRU or A-WTRU) may determine to report positioning measurement to a relay WTRU (e.g., U2N relay or U2U relay). The WTRU may report positioning measurement to a relay if the WTRU already has a connection with the relay. The WTRU may trigger connection establishment to a relay (e.g., U2N relay) to perform positioning measurement report. The WTRU may prioritize an U2N relay when performing relay selection (e.g., (re) selection).

In examples, a WTRU (e.g., T-WTRU) may collect the positioning measurement report from other WTRU (e.g., A-WTRU). The WTRU may then forward the measurement report to a relay (e.g., U2N relay). The relay may then forward the report to the network. The relay may then forward the feedback (e.g., positioning of the WTRU) to the T-WTRU. The T-WTRU may combine the positioning measurement of multiple A-WTRUs to report to the relay.

In examples, a WTRU in the group may perform positioning calculation. For example, the WTRU may receive indication from one or more WTRUs in the group regarding the positioning calculation capability. Specifically, one or more WTRUs may indicate that the WTRU supports receiving measurement reporting and/or derive the position of other WTRU. The WTRU may receive these indications during the discovery procedure. The WTRU may then send the measurement reporting to one or more WTRUs in the group to support the WTRU in positioning calculation.

In examples, a WTRU (e.g., A-WTRU or T-WTRU) may perform SL-PRS measurement reporting. The SL-PRS measurement reporting parameters may include one or more of a priority of the SL-PRS measurement reporting, a latency of the SL-PRS measurement reporting, a type of positioning measurement reporting, a periodicity of positioning measurement reporting, a time window of positioning measurement reporting, a number of SL-PRS measurement resources per measurement report, measurement parameters to report, and/or a value range of each reported parameter. Specifically, the value range of the reported parameters may be associated with the maximum error, and/or deviation of the measured parameters.

The WTRU may determine one or any combination of the SL-PRS measurement reporting parameters to perform SL-PRS measurement reporting. One or any combination of these parameters may be determined based on one or more of the following: one or more of the SL-PRS measurement reporting parameters may be determined based on an indication from another node (e.g., T-WTRU, RSU, gNB, and/or PRU, etc.). For example, the WTRU (e.g., A-WTRU) may indicate the type of measurement reporting (e.g., whether the measurement reporting is periodic or aperiodic). The WTRU may perform the request according to the indication. For example, the WTRU may indicate (e.g., by T-WTRU) the periodicity to perform positioning measurement reporting and/or the minimum the number of SL-PRS resources to perform measurement. The WTRU then may determine the periodicity and/or the number of SL-PRS resources to perform measurement based on the indication (e.g., from the T-WTRU).

One or more of the SL-PRS measurement reporting parameters may be based on one or more of the SL-PRS transmission(s) parameters. For example, the WTRU may determine the periodicity of SL-PRS measurement reporting based on the periodicity of SL-PRS transmission. In examples, the WTRU may perform SL-PRS measurement reporting for each SL-PRS transmission and/or reception. The periodicity to SL-PRS measurement reporting may equal the periodicity of SL-PRS transmission/reception. The WTRU may determine the time gap between SL-PRS reception and/or transmission and SL-PRS measurement reporting based on the processing capability of the WTRU.

In examples, the WTRU may perform SL-PRS measurement reporting at one or more of the (e.g., every) N SL-PRS transmission and/or reception periods. The value of N may be configured (e.g., preconfigured), which may be determined based on QoS of the positioning service. For example, the WTRU may determine the priority of SL-PRS measurement reporting based on the priority of SL-PRS transmission and/or the associated positioning request. Specifically, the priority of SL-PRS measurement reporting may be equivalent to the priority of SL-PRS transmission and/or positioning request message. In examples, the WTRU may determine the priority of SL-PRS measurement reporting based on the priority indicated in SCI associated with the SL-PRS (e.g., the WTRU makes measurements on the received SL-PRS and includes the measurements in the measurement report) received by the WTRU. For example, the WTRU may perform SL-PRS measurement reporting after N measurements of SL-PRS transmission. The value of N may be configured (e.g., preconfigured). The configured (e.g., preconfigured) value of N may be based on the QoS of the positioning service (e.g., accuracy requirement). For example, the WTRU may perform SL-PRS positioning measurement reporting based on obtained accuracy level of the measurement parameter is greater than a threshold (e.g., the error bound of the measured parameter is smaller than a threshold, the deviation of the measured parameter is smaller than a threshold, and/or the measured parameter is within the indicated range).

One or more of the SL-PRS measurement reporting parameters may be determined based on a QoS requirement of the positioning service. For example, the WTRU may determine the periodicity of positioning measurement report and/or the number of SL-PRS resources to perform measurement based on QoS of the positioning service. Specifically, for high positioning accuracy requirement, the WTRU may measure more SL-PRS resources to perform measurement report. However, for low positioning accuracy requirement, the WTRU may measure fewer SL-PRS resources to perform measurement report. Specifically, for positioning service with stringent latency requirement, the WTRU may perform periodic measurement reporting with smaller periodicity. For positioning service with large latency delay, the WTRU may perform periodic measurement reporting with larger reporting periodicity.

One or more of the SL-PRS measurement reporting parameters may be determined based on the positioning method.

One or more of the SL-PRS measurement reporting parameters may be determined based on a CBR of the resource pool.

One or more of the SL-PRS measurement reporting parameters may be determined based on an output of the positioning procedure (e.g., whether the output of the positioning procedure is relative or absolute positioning).

In examples, the WTRU may perform measurement reporting to one WTRU, in which the measurement reporting may contain the measurement information to determine the position of one WTRU. In examples, the WTRU may include the measurement report to multiple WTRUs. The measurement report may be used to determine the position of multiple WTRUs.

A WTRU may include one or more of the following information in the positioning measurement report.

A WTRU may include a set of SL-PRS resources the WTRU performs measurement in the positioning measurement report.

A WTRU may include a set of source WTRU IDs, which may transmit the associated SL-PRS signals in the positioning measurement report.

A WTRU may include a positioning measurement value of one or more parameters in the positioning measurement report. The one or more parameters may include RSTD, the time gap between PRS transmission and reception, AoA, AoD, ToA, TOD, SL-RSRP, SL-RSSI, LOS/NLOS value, POA, and/or DPOA.

A WTRU may include an error information associated with the reported measurement value. For example, the WTRU may report one measurement parameter (e.g., RSTD). The WTRU may further indicate the error bound associated with the reported parameter (e.g., RSTD). The WTRU may indicate the confidence level associated with the reported parameter (e.g., RSTD).

A WTRU may include information about the positioning measurement request in the positioning measurement report. The information about the positioning measurement request may trigger the WTRU to perform the positioning measurement reporting. The information may include one or more of the ID(s) of the request, the ID(s) of the SL-PRS transmitting WTRU, reference WTRU, and the reporting WTRU (e.g., the L2 source and destination IDs, L2 ID of T-WTRU, and A-WTRUs), the resource(s) (time and frequency information) used for positioning measurement request, and/or one or more resources indicated in the positioning measurement request.

A WTRU may include the information about measurement resources in the positioning measurement report. The detected SL-PRS resource and/or pair of resource(s) which may include one or more of a reference resource pattern (e.g., comb value), a sequence ID, a cyclic shift, and/or a time/frequency resource.

The WTRU may use one or more of SCI, MAC CE, PC5-RRC, and/or NAS message (e.g., LPP) to perform positioning measurement reporting. The WTRU may determine which container to perform measurement reporting based on one or more of the following.

The WTRU may determine which container to perform measurement reporting based on the receiver of the reporting. For example, the WTRU may use NAS message if the receiver of the reporting is network (e.g., LMF and/or gNB). For example, the WTRU may use group PC5-RRC if the receiver of the reporting is a relay WTRU (e.g., U2N relay or U2U relay) or a T-WTRU.

The WTRU may determine which container to perform measurement reporting based on a connection status between the transmitter and receiver of the reporting. For example, the WTRU may use group PC5-RRC if the transmitter and receiver has established PC5-RRC connection.

The WTRU may determine which container to perform measurement reporting based on a type of reporting. For example, for aperiodic reporting, the WTRU may use access stratum (AS) layer message (e.g., second SCI, MAC CE, and/or PC5-RRC). For periodic reporting, the WTRU may use non-access stratum (NAS) layer message (e.g., LPP).

The WTRU may determine which container to perform measurement reporting based on a set of parameter(s) to report.

The WTRU may determine which container to perform measurement reporting based on whether the output is relative or absolute positioning. For example, the WTRU may determine to use for relative positioning. However, for absolute positioning, the WTRU may use NAS message.

The WTRU may determine which container to perform measurement reporting based on an amount of data to report. For example, the WTRU may use second SCI if to perform positioning measurement reporting if the number of report bits is smaller than a threshold. The WTRU may MAC CE to perform positioning measurement reporting if the number of bits is smaller than anther threshold. The WTRU may use PC5-RRC to perform measurement reporting if the number of bits is smaller than another threshold. Finally, the WTRU may use NAS message if the number of reporting bits is larger than another threshold.

The WTRU may determine which container to perform measurement reporting based on a cast type of the positioning measurement reporting. For example, the WTRU may use group PC5-RRC and/or group PC5-RRC if the measurement reporting is groupcast or unicast.

The WTRU may determine which container to perform measurement reporting based on a number of WTRUs involved in the positioning procedure. For example, if two WTRUs are involved in the positioning procedure (e.g., two WTRUs determining their relative positioning), the WTRU may use SCI, MAC CE, and/or PC5-RRC to convey the positioning measurement report message.

A WTRU (e.g., A-WTRU) may trigger resource allocation for positioning measurement reporting based on one or more of an SL-PRS transmission and/or reception, delta change(s) in a measurement parameter, and/or measurement reporting. When data is available, and the WTRU may not have sidelink resource to transmit the report within the PDB.

The WTRU may use one or any combination of the following parameters in the resource allocation procedure: the resource allocation resource pool, the priority of the reporting, the latency of the reporting, the remaining PDB of the reporting, the number of subchannels to be used for the reporting, the periodicity of the reporting, the window of resource allocation (e.g., [n+T1, n+T2]).

One or more of the parameters for resource allocation may be determined based on one or more of the following.

One or more of the parameters for resource allocation may be determined based on a fixed priority. For example, the WTRU may use a fix priority for positioning measurement reporting (e.g., the highest priority).

One or more of the parameters for resource allocation may be determined based on a configured (e.g., preconfigured) resource pool. For example, the WTRU may be configured (e.g., preconfigured) with one resource pool for positioning measurement reporting. The WTRU may then perform resource allocation for the report in the configured (e.g., preconfigured) resource pool.

One or more of the parameters for resource allocation may be determined based on a QoS of the positioning service. For example, the WTRU may determine the resource selection window [n+T1, n+T2] for the measurement reporting based on the latency requirement of the report. The WTRU may determine the resource selection window [n+T1, n+T2] for the reporting such that the window is within two or N periodic SL-PRS transmission/reception resource, in which N may be configured (e.g., preconfigured) based on QoS of the positioning service.

One or more of the parameters for resource allocation may be determined based on an indication from another WTRU. For example, the WTRU (e.g., A-WTRU) may be indicated from another WTRU (e.g., T-WTRU) the priority, latency, resource selection window, and/or the periodicity of the positioning measurement reporting for the WTRU. Such indication may be indicated/negotiated via group PC5-RRC. The WTRU may then perform resource selection and reservation using one or more of these parameters.

In examples, the WTRU may determine to transmit the sidelink positioning (e.g., autonomous sidelink positioning) assistant information to another node. The sidelink positioning (e.g., autonomous sidelink positioning) assistant information may include one or more of a synchronization offset and/or error between two WTRUs (e.g., A-WTRU and T-WTRU), panel information of the WTRU, a relative position between two panels (e.g., the panel on top and at bumper of the vehicle), and/or timing error group (TEG) and/or positioning error group (PEG) information associated with each SL-PRS transmission/reception.

Communication-based sidelink positioning may be performed. One or more of the following may apply. A WTRU may determine which RS to measure for sidelink positioning. For example, a WTRU (e.g., Tx WTRU) may determine to use the RS associated with data communications to determine the positioning of a WTRU. The WTRU may determine which RS in a data transmission of a TB for a Rx WTRU to perform positioning-based measurements (e.g., reception timing, transmission timing, angle of transmission, and/or reception, etc.). In examples, the WTRU may use one or more of the following RSs to perform sidelink positioning: DMRS of PSSCH and/or PSCCH, SLSS (S-PSS, S-SSS), PTRS, PSFCH, SL-CSI-RS, and/or a (e.g., new) RS embed in PSCCH/PSSCH. The WTRU may indicate which RS to use for sidelink positioning to the Rx WTRU. The WTRU may use one or more of the following to indicate the RS to use for sidelink positioning: SCI, MAC CE, and/or PC5-RRC, etc.

A WTRU may use certain transmission (e.g., HARQ-enabled transmissions) to perform relative sidelink positioning. In examples, a WTRU may determine a relative position between itself and a peer WTRU (e.g., in a unicast link). For example, the WTRU may use HARQ-enabled transmission(s) to perform relative positioning between two WTRUs. The WTRU may transmit a HARQ-enabled TB to the Rx WTRU. The Rx WTRU may then transmit PSFCH, for example, to provide the HARQ status of the transmission. The Tx WTRU may measure the Tx-Rx between a transmission of a TB and the associated PSFCH to derive the RTT between two WTRUs.

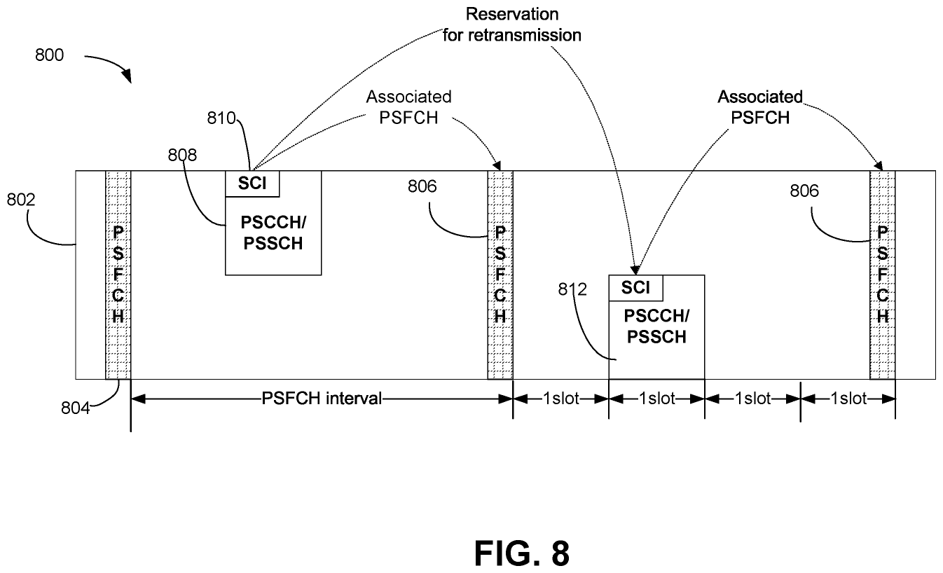

FIG. 8 illustrates an example associated with sidelink positioning 800 using HARQ-enables transmissions. As shown in FIG. 8, a WTRU may perform transmissions of a HARQ-enabled TB 802. A Rx WTRU may transmit PSFCH 804 in an associated PSFCH occasion. The time gap between PSCCH and/or PSSCH 808 and PSFCH 804 may be determined, for example, according to the certain rules (e.g., preconfigured mapping rules) between PSCCH and/or PSSCH 808 and PSFCH 804. The PSCCH and/or PSSCH 808 may comprise SCI 810. The SCI 810 may indicate an associated PSFCH transmission 806 and/or a subsequent PSCCH/PSSCH transmission 812.

A Tx WTRU may indicate the transmission of the HARQ-enabled TB 802 for sidelink positioning. In examples, the Tx WTRU may indicate to the Rx WRTU to use one or more transmissions of the HARQ-enabled TB 802 for sidelink positioning. The Tx WTRU may use SCI 810 to indicate the usage of the HARQ-enabled transmission for sidelink positioning. In examples, the WTRU may use one or more reserved bits in the first SCI 810 to indicate the usage of the HARQ-enables transmission for sidelink positioning, (e.g., in which the reserved bit is toggled (e.g., equal to 1) to indicate the usage for sidelink positioning.

A Rx WTRU may use the timing of the Tx WTRU as a reference to transmit PSFCH 804. For example, upon reception of a transmission that requests sidelink positioning, an Rx WTRU may determine the transmission timing of the PSFCH 804 based on the reception timing of the transmission requesting the HARQ feedback.

A WTRU may determine the number of transmissions of the TB 802. For example, a WTRU (e.g., a Tx WTRU) may determine the number of transmissions of one or more TBs 802 for sidelink positioning based on the QoS requirement (e.g., accuracy and/or latency requirement) of the sidelink positioning service. In certain implementations, the WTRU may be configured (e.g., preconfigured) with a range (e.g., a maximum number of transmissions and/or a minimum number of transmissions) of the number of transmissions of one or more TBs 802 for sidelink positioning service within an observation period. For example, based on the accuracy requirement of the sidelink positioning service. The WTRU may determine the number of transmissions of the TB 802 to be within the configured (e.g., preconfigured) range.

A WTRU may perform transmissions of multiple TBs 802 for sidelink positioning services. In examples, a WTRU (e.g., Tx WTRU) may perform transmissions of multiple TBs 802 within an observation period for sidelink positioning. The WTRU may be configured (e.g., preconfigured) with a (e.g., maximum) number of transmissions per TB 802, for example, based on the QoS of the TB 802.

A Tx WTRU may indicate the number of re-transmissions for a TB 802 to measure RTT between two WTRUs. The WTRU (e.g., Tx WTRU) may indicate the number of HARQ enabled transmissions of TBs 802 for sidelink positioning. The WTRU may perform the indicated number of transmissions of the TB 802 without consideration of HARQ feedback of the TB 802. The WTRU may determine whether to perform further transmissions of the TB 802 based on the HARQ feedback status of the TB 802. For example, if the WTRU receives ACK feedback the WTRU may not perform further transmission of the TB 802. If the WTRU does not receive ACK feedback, receives NACK, and/or detects discontinuous transmission (DTX), the WTRU may perform further transmissions of the TB 802.

A WTRU may determine whether to perform retransmission of the TB 802. One or more of the following may apply. For example, a WTRU (e.g., Tx WTRU) may determine whether to perform retransmission of a TB 802 based on the HARQ feedback status from the Rx WTRU and/or the number of transmissions the WTRU has performed for the TB 802. If the WTRU receives ACK feedback from a Rx WTRU and the number of transmissions of the TB 802 is not within a configured (e.g., preconfigured) range of the number of transmissions for sidelink positioning, the WTRU may perform retransmission. Additionally or alternatively, if the WTRU receives NACK feedback and if the number of transmissions of the TB 802 is within the configured (e.g., preconfigured) range of the number of transmissions for sidelink positioning, the WTRU may perform retransmission.

A WTRU may determine whether to perform a PSFCH 804 transmission to feedback HARQ status of a TB 802. A WTRU (e.g., Rx WTRU) may determine whether to perform PSFCH 804 transmission to feedback HARQ status of a TB 802, for example, based on the number of TBs 802 that the WTRU has received for sidelink positioning. In examples, if the number of transmissions of a TB 802 that the WTRU has received is less than a configured (e.g., preconfigured) number (e.g., minimum number) of transmissions, then the WTRU may perform HARQ feedback to the Tx WTRU. In examples, the WTRU may feedback an ACK if the WTRU has transmitted ACK to the Tx WTRU in a previous feedback of the TB 802.

A WTRU may determine whether to report ACK/NACK. One or more of the following may apply. A WTRU (e.g., Rx WTRU) may determine to report ACK/NACK, for example, based on whether the WTRU intends to perform additional transmissions for sidelink positioning. In examples, the WTRU may feedback an ACK to indicate that the WTRU does not need more resources for sidelink positioning.

Additionally or alternatively, the WTRU may feedback a NACK to indicate that the WTRU needs more resources for sidelink positioning. For example, the WTRU may determine whether the WTRU needs more transmissions for sidelink positioning based on one or more of a timing offset (e.g., the timing offset between the PSFCH 804 transmission timing and TB reception timing) and/or a Tx-Rx time difference (e.g., the WTRU determines the Tx-Rx difference within a bound error).

A WTRU may determine the RTT between the Tx and Rx. In examples, a WTRU (e.g., a Tx WTRU) may determine the RTT between the Tx and Rx based on the Tx-Rx difference timing. For example, the Tx-Rx difference timing may be determined/measured at the Tx WTRU (e.g., the Tx-Rx timing difference between the transmission timing of the TB 802 and the reception timing of the PSFCH). Additionally or alternatively, the WTRU may determine the RTT between the Tx and Rx based on the Tx-Rx difference determined and/or measured at the Rx WTRU (e.g., Tx-Rx timing difference between the reception timing of the TB 802 and the transmission timing of the PSFCH 804). For example, the Tx-Rx timing difference at the WTRU may be determined based on one or more of reporting from the Rx WTRU and/or a mapping (e.g., an implicit mapping between PSCCH/PSSCH resource 808 and PSFCH 804 feedback).

A WTRU may filter and/or average the RTTs from one or more transmissions for positioning. In examples, a WTRU (e.g., Tx WTRU and/or Rx WTRU) may perform measurements (e.g., RTT) for sidelink positioning. In examples, the WTRU may perform averaging/filtering of Tx-Rx difference of one or more pairs of transmission and corresponding HARQ feedback. The WTRU may report the filtered sidelink positioning measurement (e.g., filtered Tx-Rx difference).

A Rx WTRU may transmit assistant information to a Tx WTRU. In examples, a WRTU (e.g., Rx WTRU) may trigger transmission of assistant information to the Tx WTRU (e.g., for HARQ-enabled based positioning techniques). For example, the WTRU may trigger the transmission of assistant information based on several factors. For example, the WTRU may trigger the transmission of assistant information based on the reception of one or more HARQ-enabled transmissions (e.g., indicating that sidelink positioning enabled). In examples, the WTRU may trigger the transmission of assistant information based transmission of PSFCH 804 (e.g., to feedback the transmission for sidelink positioning.

A Rx WTRU may transmit one or more forms of assistant information to a Tx WTRU (e.g., to support the WTRU's position determination). Assistant information may include an offset (e.g., the offset between the slot boundary of the Rx WTRU and the reception time of the transmission from the Tx WTRU), a timing difference (e.g., the Tx-Rx timing difference between reception timing of the TB 802 and transmission timing of the PSFCH 804 to feedback for the TB 802 TEG and/or PEG information associated with the reception, and/or the absolute position of the Rx WTRU.

A WTRU (e.g., the Rx WTRU) may use SCI 810, a MAC CE, and/or a PC5-RRC to transmit assistant information to another WTRU (e.g., the Tx WTRU).

In examples, when a WTRU (e.g., the Rx WTRU) uses SCI 810 to transmit assistant information to another WTRU (e.g., the Tx WTRU), the WTRU may use a second SCI to transmit the assistant information.

In examples, when a WTRU (e.g., the Rx WTRU) uses a MC CE to transmit assistant information to another WTRU (e.g., the Tx WTRU), several factors may apply. For example, the WTRU may use the MAC CE to transmit the Tx-Rx timing difference between reception timing of the TB 802 and transmission timing of PSFCH 804 feedback. For example, the WTRU may use MAC CE to transmit an offset (e.g., between the slot boundary of the Rx WTRU and the reception timing of the transmission from the Tx WTRU).

In examples when a WTRU (e.g., the Rx WTRU) uses PC5-RRC to transmit assistant information to another WTRU (e.g., the Tx WTRU, several factors may apply. For example, the WTRU may use PC5-RRC to transmit one or more (e.g., semi-static) assistant information. In examples, the WTRU may use PC5-RRC to transmit the TEG and/or PEG information associated with the reception. For example, the WTRU may use PC5-RRC to transmit the position (e.g., the absolute position) of the Rx WTRU.

A WTRU may use ACK/NACK-based groupcast to determine the positioning of a group of WTRUs (e.g., the relative positioning with each WTRU in the group). In examples, a WTRU may determine a relative position between itself and a group of WTRUs (e.g., the relative positioning to each WTRU in the group of WTRUs). For example, the WTRU may use groupcast Option 2 HARQ-enabled transmissions (e.g., ACK/NACK based groupcast) to determine the relative positioning with a group of WTRUs. The Tx WTRU may transmit a groupcast Option 2 HARQ-enabled TB 802 to the group of WTRUs. The Rx WTRUs may transmit PSFCH 804 to feedback the HARQ status of the transmission. The Tx WTRU may measure the Tx-Rx between a transmission of a TB 802 and the associated PSFCH 804 for each WTRU, for example, to derive the RTT between the WTRU and each Rx WTRU.

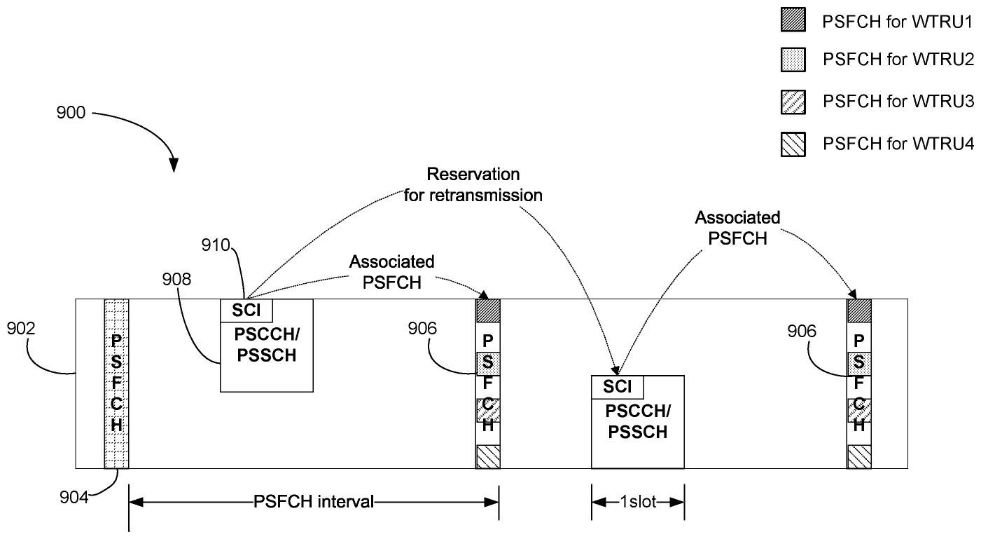

FIG. 9 illustrates an example associated with sidelink positioning using groupcast Option 2 HARQ-enabled transmission. As shown in in FIG. 9, a WTRU may perform transmission of a groupcast Option 2 HARQ-enabled TB 902. Each Rx WTRU may transmit PSFCH 904, for example, based on its member WTRU ID in an associated PSFCH occasion. The time gap between PSCCH/PSSCH transmission 908 and PSFCH 906 may be determined according to mapping rules (e.g., the preconfigured mapping rule between PSCCH/PSSCH transmission 908 and PSFCH 906). The PSCCH/PSSCH transmission 908 is a SCI 910.

A WTRU may determine whether to perform HARQ-based sidelink positioning. In examples, a WTRU may determine whether to use HARQ-based sidelink positioning (e.g., using HARQ enabled transmissions and associated PSFCH 904 to determine the WTRU's position) to determine the relative position between two or more WTRUs (e.g., for unicast and/or groupcast Option 2). The WTRU may determine the relative position between two or more WTRUs based on the QoS (e.g., latency and/or accuracy requirement) of a positioning service. In examples, a WTRU may use HARQ-based sidelink positioning for lower accuracy positioning requirement. If, for example, the positioning service uses higher accuracy positioning, the WTRU may use another suitable method, such as dedicated SL-PRS based methods for sidelink positioning.

A WTRU (e.g., an A-WTRU) may us one or more measurement parameters received from another WTRU (e.g., a T-WTRU) to determine whether to perform a request from the other WTRU. The request may be a transmission request, a reception request, and/or a measurement reporting request.

In examples, a WTRU (e.g., an A-WTRU) may determine whether to participate in a positioning procedure (e.g., autonomous positioning procedure). For example, the WTRU may determine whether to participate in the positioning procedure upon the reception of one or more positioning requests (e.g., one or more positioning request messages) from another WTRU (e.g., T-WTRU). Specifically, the A-WTRU, upon reception of the sidelink positioning (e.g., autonomous sidelink positioning) request(s) from another WTRU (e.g., T-WTRU), may determine the type of request (e.g., whether the request requires the WTRU to perform sending ACK/NACK feedback to the request, perform SL-PRS transmission/reception, and/or measurement reporting). The WTRU may then determine whether to participate in the positioning procedure based on the conditions indicated in the positioning request message. The WTRU may then determine whether the WTRU satisfies the indicated conditions. If the WTRU satisfies the indicated conditions, the WTRU may perform the request using the parameters indicated in the request.

The WTRU may receive the positioning request message(s), (e.g., the L2 ID of the positioning service), from another node (e.g., T-WTRU). The positioning request message(s) may indicate a type of positioning request (e.g., indicated in the SCI of the request). The type of positioning request may include one or more of performing SL-PRS reception, performing SL-PRS transmission, performing SL-PRS transmission and reception, and/or perform positioning measurement reporting.

The positioning request message(s) may indicate a range of one or more parameters (e.g., distance, SL-RSRP, AOD, LOS/NLOS, and/or set of zone IDs) In examples, the second SCI may indicate the positioning request message(s).

The positioning request message(s) may indicate one or more parameters for SL-PRS transmission and/or reception and/or measurement reporting. The one or more parameters for SL-PRS transmission and/or reception and/or measurement reporting may include a priority, a latency, and/or a periodicity of the SL-PRS, and/or measurement reporting.

The WTRU may measure and/or calculate one or more of the indicated parameters in the requesting message. The WTRU may determine whether to perform the associated request based on whether the measured parameter(s) are within the indicated range. If the measured and/or calculated parameter(s) are within the indicated range, the WTRU may perform resource allocation for SL-PRS transmission and/or reception and/or measurement reporting using the parameters indicated in the positioning request message. If the request requires the WTRU to perform SL-PRS reception, the WTRU may perform SL-PRS reception in the resources indicated in the request message. If the request requires the WTRU to perform SL-PRS transmission, the WTRU may perform SL-PRS transmission using selected resources. If the request requires the WTRU to perform measurement reporting, the WTRU may perform positioning measurement reporting using selected resources. The WTRU may perform SL-PRS reception and/or prioritization using the priority and/or MG indicated in the SCI 910.

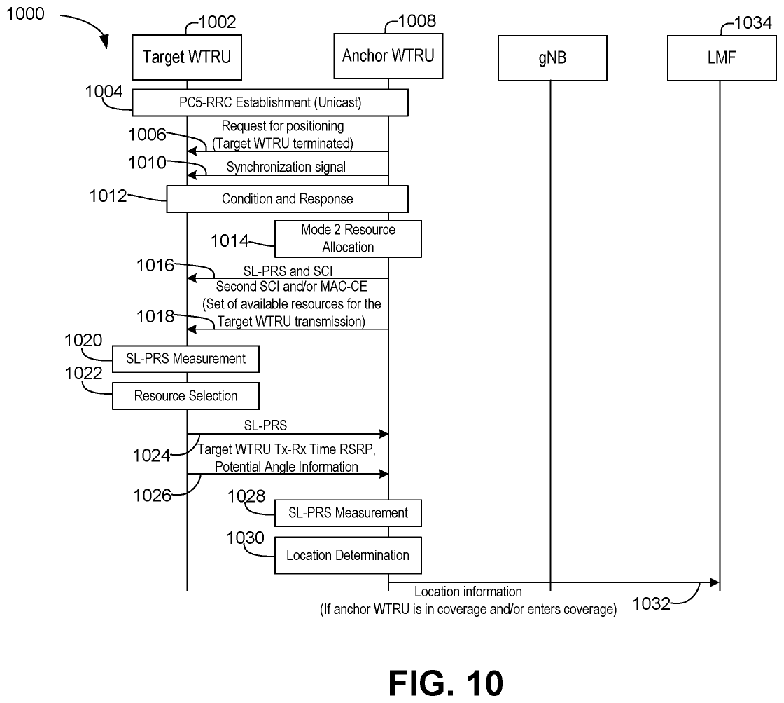

FIG. 10 depicts an example signal flow for an out-of-coverage RTT method 1000. The out-of-coverage RTT method 1000 may be based on positioning. A target WTRU 1002 may determine to establish at 1004 a PC5-RRC connection with an anchor WTRU 1008 (e.g., via unicast). The target WTRU 1002 may receive at 1006 a request for positioning from the anchor WTRU 1008. For example, the target WTRU 1002 may receive at 1006 the request for positioning via an LPP message and/or a PC5-RRC message. Additionally or alternatively, the target WTRU 1002 may send a request for positioning (e.g. via LPP or PC5-RRC) to the anchor WTRU 1008.

If the target WTRU 1002 determines to use the anchor WTRU 1008 as a synchronization source, the target WTRU 1002 may send a request to the anchor WTRU 1008 to send a synchronization signal. At 1010, the target WTRU 1002 may receive the synchronization signal from the anchor WTRU 1008.

At 1012, based on the quality of the received RS and/or synchronization signal (e.g., RSRP above the preconfigured threshold), the target WTRU 1002 may determine whether the anchor WTRU 1008 can become a transmitter of SL-PRS. At 1014, the anchor WTRU 1008 may perform the resource allocation procedure (e.g., musing Mode 2 resource selection/allocation).

At 1016, the target WTRU 1002 may receive SCI and/or an associated SL-PRS from the anchor WTRU 1008. The SCI may indicate a location of the SL-PRS. Prior to reception of the SL-PRS, the target WTRU 1002 may receive one or more SL-PRS configurations (e.g., SL-PRS density in time and/or frequency domain) from the anchor WTRU 1008, for example, in an LPP message and/or PC5-RRC message.

At 1018, the target WTRU 1002 may receive a second SCI and/or MAC-CE from the anchor WTRU 1008. The second SCI and/or MAC-CE may indicate one or more SL-PRS resources (e.g., locations of SL-PRS in time and/or frequency resources) and/or PRS configurations the target WTRU 1002 should use for transmission of its SL-PRS.

The target WTRU 1002 may receive an SL-PRS transmitted from the anchor WTRU 1008. At 1020, the target WTRU 1002 may perform one or more measurements on the SL-PRS and/or select other available resources at 1022.

At 1024, the target WTRU 1002 may transmit an SL-PRS to the anchor WTRU 1008 based on the indicated resource and/or SL-PRS configuration. In examples, the target WTRU 1002 may determine the resource and/or SL-PRS configuration based on measurements made on the SL-PRS transmitted at 1024 from the anchor WTRU (e.g., RSRP).

At 1026, the target WTRU 1002 may send the target WTRU 1102 Tx-Rx time difference to the anchor WTRU 1008. The target WTRU 1102 Tx-Rx time difference may be the difference between a transmission time of an SL-PRS (e.g., transmitted at 1024 from the target WTRU) and a reception time of the SL-PRS transmitted at 1016 from the anchor WTRU 1008.

At 1028, the anchor WTRU 1008 may perform one or more measurements on the SL-PRS transmitted at 1024 from the target WTRU 1002. At 1030, the anchor WTRU 1008 may determine a relative and/or an absolute position of the target WTRU 1002. The anchor WTRU 1008 may express the relative location of the target WTRU 1002 with respect to the anchor WTRU 1008.

At 1032, the anchor WTRU 1008 may send the location information (e.g., relative and/or absolute position of the target WTRU) to the LMF 1034. In examples, the anchor WTRU 1008 may send the location information if the anchor WTRU 1008 is in coverage of the network or enters the coverage of the network. In examples, if the target WTRU 1002 sends a request to the anchor WTRU 1008 for location information, the anchor WTRU 1008 may send the location information to the target WTRU 1002 after determination of the location of the target WTRU 1002.

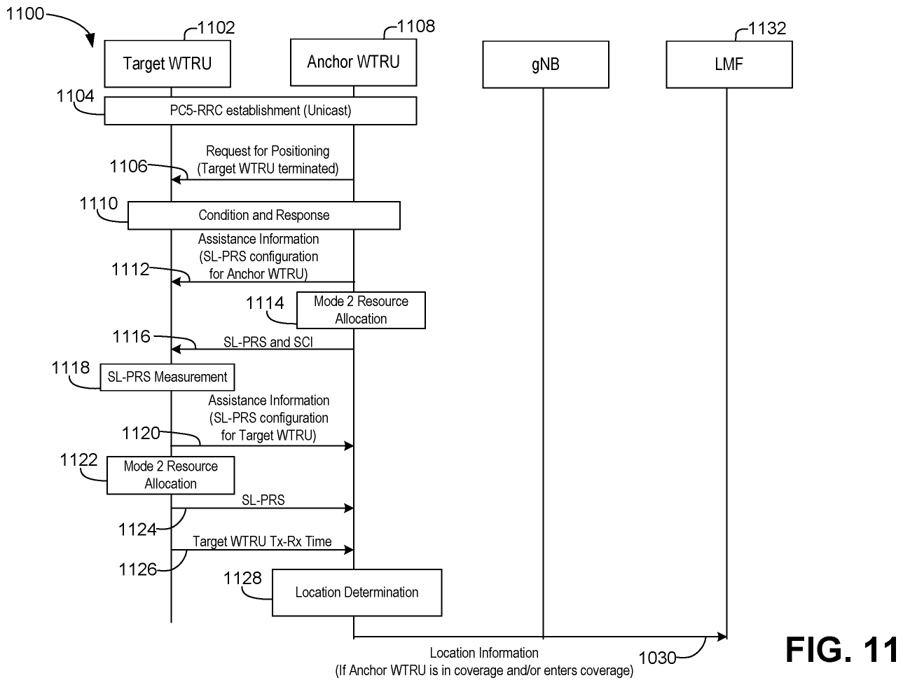

FIG. 11 depicts an example RTT positioning method 1100 for out-of-coverage status where the target WTRU 1102 performs Mode 2 resource allocation. A target WTRU 1102 may determine at 1104 to establish a PC5-RRC connection with an anchor WTRU (e.g., via unicast). The target WTRU 1102 may receive at 1106 a request for positioning from the anchor WTRU 1108. For example, the target WTRU 1102 may receive at 1106 the request for positioning via an LPP message and/or a PC5-RRC message. Additionally or alternatively, the target WTRU 1102 may send a request for positioning (e.g. via LPP or PC5-RRC) to the anchor WTRU 1108.

At 1110, based on the quality of the received RS (e.g., RSRP above the preconfigured threshold), the target WTRU 1102 may determine whether the anchor WTRU 1108 can become a transmitter of SL-PRS. At 1112, the target WTRU 1102 may receive assistance information (e.g., SL-PRS configuration information for the anchor WTRU 1108) from the anchor WTRU 1108. At 1114, the anchor WTRU 1108 may perform the resource allocation procedure (e.g. using Mode 2 resource selection/allocation).

As illustrated in FIG. 11, the target WTRU 1102 may not receive the second SCI or MAC-CE from the anchor WTRU 1108. At 1114, the target WTRU 1102 may perform the resource allocation procedure (e.g. using Mode 2 resource selection/allocation) to find available resource for transmission of an SL-PRS. When the target WTRU 1102 transmits the SL-PRS, the target WTRU 1102 may transmit SCI to the anchor WTRU 1108. For example, when the target WTRU 1102 transmits SCI, the anchor WTRU 1108 may find resources where the SL-PRS is allocated. The target WTRU 1102 may send PRS configuration information to the anchor WTRU 1108.

At 1116, the target WTRU 1102 may receive SCI and/or an associated SL-PRS from the anchor WTRU 1108. The SCI may indicate a location of the SL-PRS. Prior to reception of the SL-PRS, the target WTRU 1102 may receive one or more SL-PRS configurations (e.g., SL-PRS density in time and/or frequency domain) from the anchor WTRU 1108, for example, in an LPP message and/or PC5-RRC message.

The target WTRU 1102 may receive at 1116 an SL-PRS transmitted from the anchor WTRU 1108. At 1118, the target WTRU 1102 may perform one or more measurements on the SL-PRS. At 1120, the anchor WTRU 1108 may receive assistance information (e.g., SL-PRS configuration information for the target WTRU 1102) from the target WTRU 1102. At 1122, the anchor WTRU 1108 may perform the resource allocation procedure (e.g. using Mode 2 resource selection/allocation).

At 1124, the target WTRU 1102 may transmit an SL-PRS to the anchor WTRU 1108 based on the indicated resource and/or SL-PRS configuration. In examples, the target WTRU 1112 may determine the resource and/or SL-PRS configuration based on measurements made on the SL-PRS transmitted from the anchor WTRU 1108 (e.g., RSRP).

At 1126, the target WTRU 1102 may send the target WTRU 1102 Tx-Rx time difference to the anchor WTRU 1108. The target WTRU 1102 Tx-Rx time difference equals the difference between a transmission time of an SL-PRS (e.g., from the target WTRU) and a reception time of the SL-PRS transmitted from the anchor WTRU 1108.

At 1128, the anchor WTRU 1108 may determine a relative and/or an absolute position of the target WTRU 1102. the anchor WTRU 1108 may express the relative location of the target WTRU 1102 with respect to the anchor WTRU 1108.

At 1130, the anchor WTRU 1108 may send the location information (e.g., relative and/or absolute position of the target WTRU) to the LMF 1132. In examples, the anchor WTRU 1108 may send the location information if the anchor WTRU 1108 is in coverage of the network or enters the coverage of the network. In examples, if the target WTRU 1102 sends a request to the anchor WTRU 1108 for location information, the anchor WTRU 1108 may send the location information to the target WTRU 1102 after determination of the location of the target WTRU 1102.

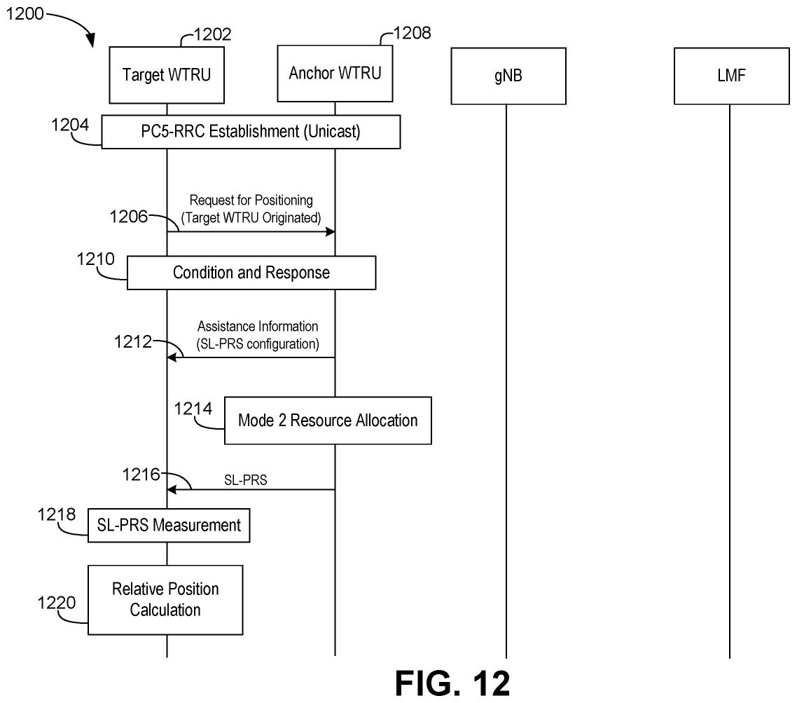

FIG. 12 depicts an example one-sided positioning method 1200 for out-of-coverage status. The target WTRU 1202 may determine at 1204 to establish a PC5-RRC connection with the anchor WTRU 1208 (e.g., via unicast). The target WTRU 1202 may send at 1206 a request for positioning to the anchor WTRU 1208 via an LPP message and/or PC5-RRC message. Additionally or alternatively, the target WTRU 1202 may receive a request for positioning (e.g. via LPP or PC5-RRC) from the anchor WTRU 1208.

If the target WTRU 1202 determines to use the anchor WTRU 1208 as a synchronization source, the target WTRU 1202 may send a request to the anchor WTRU to send a synchronization signal. The target WTRU 1202 may receive the synchronization signal from the anchor WTRU 1208.

At 1210, based on the quality of the received RS and/or synchronization signal (e.g., RSRP above the preconfigured threshold), the target WTRU 1202 may determine whether the anchor WTRU 1208 can become a transmitter of SL-PRS. The anchor WTRU 1208 may send at 1212 assistance information (e.g., SL-PRS configuration information for the anchor WTRU 1208) to the target WTRU 1202 via an LPP message and/or PC5-RRC message. Additionally or alternatively, the anchor WTRU 1208 may receive a request for positioning (e.g. via LPP or PC5-RRC) from the target WTRU 1202. The anchor WTRU 1202 may perform at 1214 a resource allocation procedure (e.g., a mode 2 resource allocation procedure).

In examples, at 1216, the target WTRU 1202 may receive SCI and an associated SL-PRS from the anchor WTRU 1208, for example, where the SCI indicates the location of the SL-PRS. Prior to reception of the SL-PRS, the target WTRU 1202 may receive one or more SL-PRS configurations (e.g., SL-PRS density in time and/or frequency domain) from the anchor WTRU 1208 in an LPP message. In examples, the target WTRU 1202 may receive a timestamp from the anchor WTRU 1208 indicating when the PRS is transmitted. The target WTRU 1202 may determine a distance between the target WTRU 1202 and the anchor WTRU 1208, for example, based on the timestamp. The target WTRU 1202 may receive the timestamp when (e.g., only when) the target WTRU 1202 uses the anchor WTRU 1208 as a synchronization signal.

The target WTRU 1202 may receive the second SCI and/or MAC-CE from the anchor WTRU 1208. The second SCI and/or MAC-CE may indicate one or more SL-PRS resource(s) (e.g., locations of SL-PRS in time and/or frequency resources) and/or one or more PRS configurations the target WTRU 1202 should use for transmission of its SL-PRS.

In examples, at 1216, the target WTRU 1202 may receive an SL-PRS transmitted from the anchor WTRU 1208. At 1218, the target WTRU 1202 may perform one or more measurements (e.g., RSRP, AoA, and/or RSTD if there are more than one anchor WTRU(s) 1208) on the SL-PRS. In examples, if the target WTRU 1202 received a request for positioning from the anchor WTRU 1208, the target WTRU 1202 may send the measurement results to the anchor WTRU 1208. In examples, at 1220, if the target WTRU 1202 received a request for positioning from the anchor WTRU 1208, the anchor WTRU 1208 may determine the relative and/or absolute location of the target WTRU 1202. At 1220, the target WTRU 1202 may determine its relative position with respect to the anchor WTRU 1208.

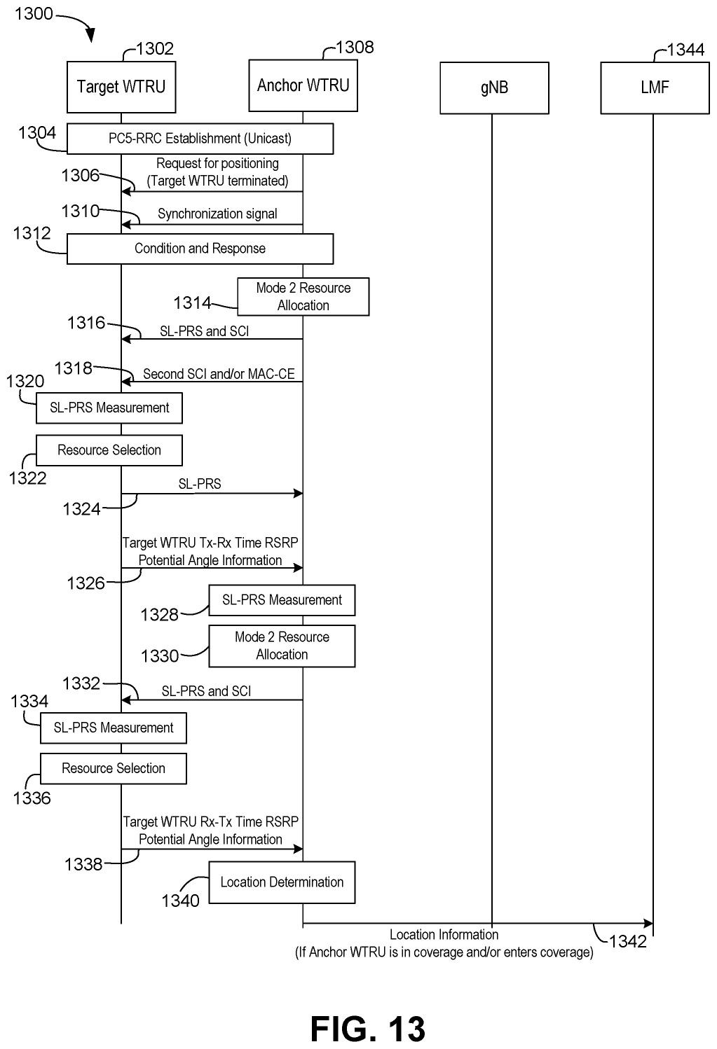

FIG. 13 depicts an example two-sided RTT positioning method 1300 for out-of-coverage status. An anchor WTRU 1308 may transmit two or more SL-PRSs to a target WTRU 1302, (e.g., a first SL-PRS and a second SL-PRS). In example, the anchor WTRU 1308 may transmit more than one SL-PRSs over different resource(s). The target WTRU 1302 may send one or more SL-PRS to the anchor WTRU 1308.

In the examples described herein, the target WTRU 1302 may receive configurations and/or indication of a time and/or frequency resource that the target WTRU 1302 uses to send measurement reports. The measurement reports may contain the target Rx-Tx time difference. The measurement reports sent by the target WTRU 1302 may include an Rx-Tx time, an RSRP per SL-PRS resource, an AoA per SL-PRS resource time-of-arrival, and/or an AoD of the SL-PRS resource.

At 1304, the target WTRU 1302 may determine to establish a PC5-RRC connection with the anchor WTRU 1308 (e.g., via unicast). The target WTRU 1302 may receive at 1306 a request for positioning from the anchor WTRU 1308 via an LPP message and/or a PC5-RRC message. Additionally or alternatively, the target WTRU 1302 may send a request for positioning to the anchor WTRU 1308.

If the target WTRU 1302 determines to use the anchor WTRU 1308 as a synchronization source, the target WTRU 1302 may send a request to the anchor WTRU 1308 to send a synchronization signal. At 1310, the target WTRU 1302 may receive the synchronization signal from the anchor WTRU 1308. At 1312, based on the quality of the received RS and/or synchronization signal (e.g., RSRP above the preconfigured threshold), the target WTRU 1302 may determine whether the anchor WTRU 1308 can become a transmitter of SL-PRS. At 1314, the anchor WTRU 1308 may perform the resource allocation procedure (e.g. using Mode 2 resource selection/allocation).

At 1316, the target WTRU 1302 may receive SCI and/or associated SL-PRS from the anchor WTRU 1308. The SCI may indicate a location of a first SL-PRS. Prior to reception of the SL-PRS, the target WTRU 1302 may receive one or more SL-PRS configurations (e.g., SL-PRS density in time/frequency domain) from the anchor WTRU 1308, for example, in an LPP message. The SCI may include a time and/or a frequency resource of a second SL-PRS.

At 1318, the target WTRU 1302 may receive a second SCI or MAC-CE from the anchor WTRU 1308 indicating one or more SL-PRS resource(s) (e.g., locations of SL-PRS in time and/or frequency resources) and/or one or more PRS configurations. The target WTRU 1302 may use the second SCI or MAC-CE for transmission of the target WTRU's 1302 SL-PRS. The second SCI or MAC-CE may include a time and/or a frequency resource of the second SL-PRS to be transmitted by the anchor WTRU 1308.

At 1320, the target WTRU 1302 may receive the first SL-PRS transmitted from the anchor WTRU 1308. The target WTRU 1302 may perform one or more measurements on the first SL-PRS. At 1322, the target WTRU 1302 may determine the resource and/or SL-PRS configuration based on measurements (e.g., such as RSRP) made on the SL-PRS transmitted from the anchor WTRU 1308. At 1324, the target WTRU 1302 may transmit an SL-PRS to the anchor WTRU 1308 based on the indicated resource and/or SL PRS configuration.

At 1326, the target WTRU 1302 may send a target WTRU 1302 Tx-Rx time difference to the anchor WTRU 1308. The target WTRU 1302 Tx-Rx time difference may be the difference between a transmission time of the SL-PRS (e.g., from the target WTRU 1302) and a reception time of the SL-PRS transmitted from the anchor WTRU 1308. At 1328, the target WTRU 1302 may perform one or more measurements on the SL-PRS and/or select other available resources. At 1330, the anchor WTRU 1308 may perform the resource allocation procedure (e.g. using Mode 2 resource selection/allocation).

In examples, at 1326, the target WTRU 1302 may receive SCI and/or associated SL-PRS from the anchor WTRU 1308. The SCI may indicate a location of the second SL-PRS. In examples, the anchor WTRU 1308 may not include an SCI if the time and/or frequency locations of the second SL-PRS has already been sent to the target WTRU, as described herein.

At 1332, the target WTRU 1302 may receive the second SL-PRS from the anchor WTRU 1308. At 1334, the target WTRU 1302 may receive the first SL-PRS transmitted from the anchor WTRU 1308. The target

WTRU 1302 may perform one or more measurements on the first SL-PRS. At 1336, the target WTRU 1302 may determine the resource and/or SL-PRS configuration based on measurements (e.g., such as RSRP) made on the SL-PRS transmitted from the anchor WTRU 1308.

At 1338, the target WTRU 1302 may send a measurement report which comprises the target WTRU 1302 Rx-Tx time difference which is the difference between the time of arrival of the second PRS and transmission time of the SL-PRS from the target WTRU 1302.

At 1340, the anchor WTRU 1308 may determine a relative position and/or an absolute position of the target WTRU 1302 based on the measurements. At 1342, the anchor WTRU 1308 may send location information (e.g., relative location and/or absolute location) related to the target WTRU 1302 to the LMF 1344 if certain factors are met. These factors include: if the anchor WTRU 1308 is in coverage of the network and/or enters the coverage of the network, and/or if the anchor WTRU 1308 received a request from the network to report the location of the target WTRU(s) 1302.

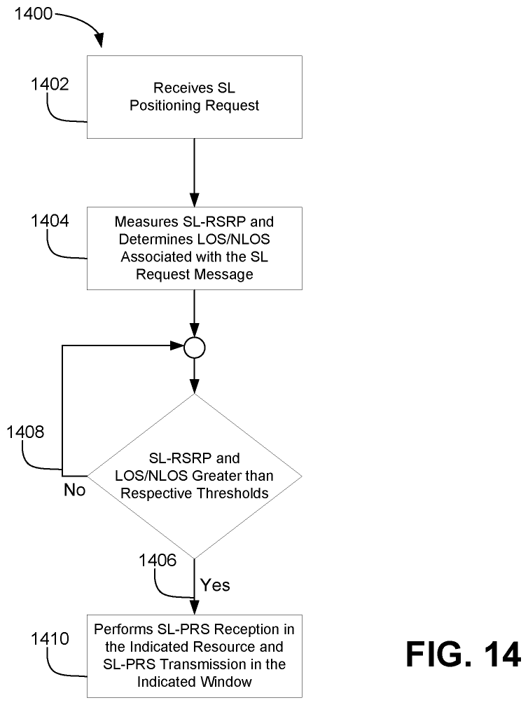

FIG. 14 depicts a flowchart 1400 that provides a describes the A-WTRU's actions upon receiving the SL-PRS. At 1402, the anchor A-WTRU (e.g., such as the anchor WTRU 306 shown in FIG. 3, the anchor WTRU 508 shown in FIG. 5, the anchor WTRU 1008 shown in FIG. 10, the anchor WTRU 1108 shown in FIG. 11, the anchor WTRU 1208 shown in FIG. 12, and/or the anchor WTRU 1308 shown in FIG. 13) may receive the SL-PRS from the T-WTRU. The SL-PRS includes a request that the A-WTRU perform SL-PRS Rx and/or Tx, parameters for SL-RSRP and/or LOS/NLOS thresholds, resources for SL-PRS Rx, and/or a window for SL-PRS Tx.

At 1404, the A-WTRU may measure the SL-RSRP. At 1404, the A-WTRU may determine LOS/NLOS associated with the sidelink request message. At 1406, if the SL-RSRP and LOS/NLOS are greater than their respective thresholds, the A-WTRU may perform SL-PRS reception. At 1408, if the SL-RSRP and LOS/NLOS are not greater than their respective thresholds, the A-WTRU may not perform SL-PRS reception, and the A-WTRU may continue to measure the SL-RSRP and LOS/NLOS.

At 1410, the A-WTRU may perform SL-PRS Rx in the indicated resource. At 1410, the A-WTRU may perform SL-PRS Tx in the indicated window.

1.-20. (canceled)

21. A wireless transmit/receive unit (WTRU), comprising:
a processor and memory configured to:
receive configuration information indicating a first resource pool, a second resource pool, and information associated with one or more sidelink positioning reference signals (SL-PRSs), wherein the information associated with the one or more SL-PRSs comprises an indication of the identifications (IDs) associated with the one or more SL-PRSs, wherein the one or more SL-PRSs are associated with the first resource pool or the second resource pool, wherein the first resource pool allows for multiplexing of SL-PRSs with sidelink data, and wherein the second resource pool does not allow for multiplexing SL-PRSs with sidelink data;
receive sidelink control information (SCI), wherein the SCI comprises an indication to receive one or more SL-PRSs via resources associated with the first resource pool or via resources associated with the second resource pool; and
wherein, the SCI comprises an indication that the transmission via the resources associated with the first resource pool comprises one or more SL-PRSs, an indication of ID associated with the one or more SL-PRSs, and a priority associated with the one or more SL-PRSs; and
wherein, the SCI comprises a cast type associated with the one or more SL-PRSs, an indication of the IDs of the one or more SL-PRSs, and a priority associated with the one or more SL-PRSs;
receive the one or more SL-PRSs indicated by the SCI via resources associated with the first resource pool or via resources associated with the second resource pool.

22. The WTRU of claim 21, wherein the information associated with the one or more SL-PRSs comprises a pattern associated with the one or more SL-PRSs.

23. The WTRU of claim 21, wherein the information associated with the one or more SL-PRSs comprises time and frequency resources associated with transmissions of the one or more SL-PRSs.

24. The WTRU of claim 21, wherein the information associated with the one or more SL-PRSs comprises a SL-PRS resource element offset, a SL-PRS symbol offset, or a number of SL-PRS symbols.

25. The WTRU of claim 21, wherein the cast type is one or unicast, groupcast, or broadcast.

26. The WTRU of claim 21, wherein the SCI further comprises a bitfield to indicate the availability of the one or more SL-PRSs.

27. The WTRU of claim 21, wherein the processor and memory are configured to:
send measurements associated with the one or more SL-PRSs.

28. The WTRU of claim 21, wherein the processor and memory are configured to:
decode transmissions associated with the first resource pool or the second resource pool in accordance with the SCI.

29. The WTRU of claim 21, wherein the processor and memory are configured to:
receive the SCI associated with the one or more SL-PRSs via the resources associated with the first resource pool; and
receive the one or more SL-PRSs via the resources associated with the first resource pool.

30. The WTRU of claim 21, wherein the processor and memory are configured to:
receive the SCI associated with the one or more SL-PRSs via the resources associated with the second resource pool; and
receive the one or more SL-PRSs via the resources associated with the second resource pool.

31. A method performed by a wireless transmit/receive unit (WTRU), the method comprising:
receiving configuration information indicating a first resource pool, a second resource pool, and information associated with one or more sidelink positioning reference signals (SL-PRSs), wherein the information associated with the one or more SL-PRSs comprises an indication of the identifications (IDs) associated with the one or more SL-PRSs, wherein the one or more SL-PRSs are associated with the first resource pool or the second resource pool, wherein the first resource pool allows for multiplexing of SL-PRSs with sidelink data, and wherein the second resource pool does not allow for multiplexing SL-PRSs with sidelink data;
receiving sidelink control information (SCI), wherein the SCI comprises an indication to receive one or more SL-PRSs via resources associated with the first resource pool or via resources associated with the second resource pool; and
wherein, the SCI comprises an indication that the transmission via the resources associated with the first resource pool comprises one or more SL-PRSs, an indication of ID associated with the one or more SL-PRSs, and a priority associated with the one or more SL-PRSs; and
wherein, the SCI comprises a cast type associated with the one or more SL-PRSs, an indication of the IDs of the one or more SL-PRSs, and a priority associated with the one or more SL-PRSs;
receiving the one or more SL-PRSs indicated by the SCI via resources associated with the first resource pool or via resources associated with the second resource pool.

32. The method of claim 31, wherein the information associated with the one or more SL-PRSs comprises a pattern associated with the one or more SL-PRSs.

33. The method of claim 31, wherein the information associated with the one or more SL-PRSs comprises time and frequency resources associated with transmissions of the one or more SL-PRSs.

34. The method of claim 31, wherein the information associated with the one or more SL-PRSs comprises a SL-PRS resource element offset, a SL-PRS symbol offset, or a number of SL-PRS symbols.

35. The method of claim 31, wherein the cast type is one or unicast, groupcast, or broadcast.

36. The method of claim 31, wherein the SCI further comprises a bitfield to indicate the availability of the one or more SL-PRSs.

37. The method of claim 31, further comprising:
sending measurements associated with the one or more SL-PRSs.

38. The method of claim 31, further comprising:
decoding transmissions associated with the first resource pool or the second resource pool in accordance with the SCI.

39. The method of claim 31, further comprising:
receiving the SCI associated with the one or more SL-PRSs via the resources associated with the first resource pool; and
receiving the one or more SL-PRSs via the resources associated with the first resource pool.

40. The method of claim 31, further comprising:
receiving the SCI associated with the one or more SL-PRSs via the resources associated with the second resource pool; and
receiving the one or more SL-PRSs via the resources associated with the second resource pool.
